(19) United States
(12) Patent Application Publication
(10) Pub. No.: US 2025/0391843 A1
(43) Pub. Date: Dec. 25, 2025

(54) Lithium-Ion Secondary Battery And Method For Forming Positive Electrode Active Material Particle

(71) Applicant: Semiconductor Energy Laboratory Co., Ltd., Kanagawa-ken (JP)

(72) Inventors: Masahiro TAKAHASHI, Atsugi (JP); Yohei MOMMA, Isehara (JP); Mayumi MIKAMI, Atsugi (JP); Jo SAITO, Atsugi (JP)

(73) Assignee: Semiconductor Energy Laboratory Co., Ltd., Kanagawa-ken (JP)

(21) Appl. No.: 19/242,066

(22) Filed: Jun. 18, 2025

(30) Foreign Application Priority Data
Jun. 24, 2024 (JP) 2024-101530
Jun. 24, 2024 (JP) 2024-101531

(51) Int. Cl. H01M 4/36; H01M 4/02; H01M 4/04; H01M 4/505; H01M 4/525; H01M 10/0525

(52) U.S. Cl. CPC H01M 4/364; H01M 4/0471; H01M 4/366; H01M 4/505; H01M 4/525; H01M 10/0525; H01M 2004/028

(57) ABSTRACT

A lithium-ion secondary battery with favorable charge and discharge cycle performance is provided. The lithium-ion secondary battery includes a positive electrode and a negative electrode. The positive electrode includes positive electrode active material particles containing magnesium, fluorine, and lithium cobalt oxide. When a surface of the positive electrode active material particle observed in a cross-sectional STEM image of a plane where lithium is inserted and extracted is a first layer, the positive electrode active material particle includes a region where magnesium is substituted for part of cobalt sites in a second layer to a sixth layer. Magnesium has a function of relieving a distortion between the layered rock-salt crystal structure and the rock-salt crystal structure, and fluorine has a function of promoting transfer of the magnesium into an inner portion of the positive electrode active material particle.

### BACKGROUND OF THE INVENTION

### 1. Field of the Invention

One embodiment of the present invention relates to an object, a method, or a manufacturing method. The present invention relates to a process, a machine, manufacture, or a composition of matter. One embodiment of the present invention relates to a power storage device, a semiconductor device, a display device, a light-emitting device, a lighting device, an electronic device each including a secondary battery, or a manufacturing method thereof.

Note that electronic devices in this specification mean all devices including power storage devices, and electro-optical devices including power storage devices, information terminal devices including power storage devices, and the like are all electronic devices.

### 2. Description of the Related Art

In recent years, a variety of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

In particular, secondary batteries for mobile electronic devices, for example, are highly demanded to have high discharge capacity per weight and excellent cycle performance. In order to meet such demands, positive electrode active materials in positive electrodes of secondary batteries have been actively improved (e.g., Patent Documents 1 and 2). Crystal structures of positive electrode active materials have also been studied (Non-Patent Documents 1 to 3).

X-ray diffraction (XRD) is one of methods used for analysis of crystal structures of positive electrode active materials. With use of the Inorganic Crystal Structure Database (ICSD) introduced in Non-Patent Document 4, XRD data can be analyzed. For example, the ICSD can be referred to for the lattice constant of the lithium cobalt oxide described in Non-Patent Document 5. For Rietveld analysis, the analysis program RIETAN-FP (Non-Patent Document 6) can be used, for example. For example, VESTA (Non-Patent Document 7) can be used as software for drawing crystal structures.

As image processing software, for example, ImageJ (Non-Patent Documents 8 to 10) is known. Using this software makes it possible to analyze the shape of a positive electrode active material, for example.

Nanobeam electron diffraction can also be effectively used to identify the crystal structure of a positive electrode active material, in particular, the crystal structure of a surface portion of the positive electrode active material. For analysis of electron diffraction patterns, an analysis program called ReciPro (Non-Patent Document 11) can be used, for example.

### REFERENCES

### Patent Documents

[Patent Document 1] Japanese Published Patent Application No. 2018-206747
[Patent Document 2] Japanese Published Patent Application No. 2022-070247

### Non-Patent Documents

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 22, 2012, pp. 17340-17348.
[Non-Patent Document 2] T. Motohashi et al., “Electronic phase diagram of the layered cobalt oxide system LiₓCoO₂ (0.0≤x≤1.0)”, Physical Review B, 80 (16); 165114.
[Non-Patent Document 3] Zhaohui Chen et al., “Staging Phase Transitions in LiₓCoO₂”, Journal of The Electrochemical Society, 2002, 149 (12), A1604-A1609.
[Non-Patent Document 4] A. Belsky, et al., “New developments in the Inorganic Crystal Structure Database (ICSD): accessibility in support of materials research and design”, Acta Cryst., (2002), B58, 364-369.
[Non-Patent Document 5] J. Akimoto, Y. Gotoh, Y. Oosawa, “Synthesis and structure refinement of LiCoO₂ single crystals”, Journal of Solid State Chemistry (1998) 141, pp. 298-302.
[Non-Patent Document 6] F. Izumi and K. Momma, “Three-Dimensional Visualization in Powder Diffraction,” Solid State Phenom., 130, 15-20 (2007).
[Non-Patent Document 7] K. Momma and F. Izumi, “VESTA 3 for three-dimensional visualization of crystal, volumetric and morphology data” J. Appl. Cryst. (2011). 44, 1272-1276.
[Non-Patent Document 8] Rasband, W. S., ImageJ, U. S. National Institutes of Health, Bethesda, Maryland, USA, http://rsb.info.nih.gov/ij/, 1997-2012.
[Non-Patent Document 9] Schneider, C. A., Rasband, W. S., Eliceiri, K. W., “NIH Image to ImageJ: 25 years of image analysis”, Nature Methods, 9, 671-675, 2012.
[Non-Patent Document 10] Abramoff, M. D., Magelhaes, P. J., Ram, S. J., “Image Processing with ImageJ”, Biophotonics International, volume 11, issue 7, pp. 36-42, 2004.
[Non-Patent Document 11] Seto, Y. & Ohtsuka, M., “ReciPro: free and open-source multipurpose crystallographic software integrating a crystal model database and viewer, diffraction and microscopy simulators, and diffraction data analysis tools” (2022) J. Appl. Cryst., 55.

### SUMMARY OF THE INVENTION

Development of lithium-ion secondary batteries has room for improvement in terms of output performance, discharge capacity, cycle performance, reliability, safety, cost, and the like.

In view of this, an object of one embodiment of the present invention is to provide a positive electrode active material particle or a composite oxide which can be used in a lithium-ion secondary battery and inhibits a decrease in discharge capacity during charge and discharge cycles. Another object of one embodiment of the present invention is to provide a positive electrode active material particle or a composite oxide having a crystal structure that is unlikely to be broken by repeated charge and discharge. Another object of one embodiment of the present invention is to provide a positive electrode active material particle or a composite oxide with high discharge capacity. Another object of one embodiment of the present invention is to provide a secondary battery or a vehicle which has a high level of safety or reliability.

Another object of one embodiment of the present invention is to provide a positive electrode active material, a composite oxide, a power storage device, or a manufacturing method thereof.

Note that the description of these objects does not preclude the existence of other objects. In one embodiment of the present invention, there is no need to achieve all of these objects. Other objects can be derived from the description of the specification, the drawings, and the claims.

One embodiment of the present invention is a lithium-ion secondary battery including a positive electrode and a negative electrode. The positive electrode includes a positive electrode active material particle containing magnesium, fluorine, and lithium cobalt oxide. When a surface of the positive electrode active material particle observed in a cross-sectional STEM image of a plane where lithium is inserted and extracted is a first layer, the positive electrode active material particle includes a region where magnesium is substituted for part of cobalt sites in a second layer, a third layer, a fourth layer, a fifth layer, and a sixth layer of the positive electrode active material particle.

In the above, the positive electrode active material particle preferably includes a region where part of the cobalt sites in the fourth layer observed in the cross-sectional STEM image of the plane where lithium is inserted and extracted is substituted with magnesium.

In the above, it is preferable that the positive electrode active material particle have a layered rock-salt crystal structure in an inner portion and a rock-salt crystal structure in a surface portion, and the magnesium have a function of relieving a distortion between the layered rock-salt crystal structure and the rock-salt crystal structure.

Another embodiment of the present invention is a lithium-ion secondary battery including a positive electrode and a negative electrode. The positive electrode includes a positive electrode active material particle containing magnesium, fluorine, and lithium cobalt oxide. When a surface of the positive electrode active material particle observed in a cross-sectional STEM image of a plane where lithium is inserted and extracted is a first layer, the positive electrode active material particle includes a region where magnesium is substituted for part of cobalt sites in a second layer, a third layer, a fourth layer, a fifth layer, and a sixth layer of the positive electrode active material particle. The fluorine exists closer to the surface than the region does.

In the above, the fluorine preferably has a function of promoting transfer of the magnesium into an inner portion of the positive electrode active material particle.

Another embodiment of the present invention is a lithium-ion secondary battery including a positive electrode and a negative electrode. The positive electrode includes a positive electrode active material particle containing magnesium, fluorine, and lithium cobalt oxide. When a surface of the positive electrode active material particle observed in a cross-sectional STEM image of a plane where lithium is inserted and extracted is a first layer, the positive electrode active material particle includes a region where magnesium is substituted for part of cobalt sites in a second layer, a third layer, a fourth layer, a fifth layer, and a sixth layer of the positive electrode active material particle. Rock-salt crystal structures dispersively exist in the first layer to the third layer observed in the cross-sectional STEM image of the plane where lithium is inserted and extracted.

Another embodiment of the present invention is a lithium-ion secondary battery including a positive electrode and a negative electrode. The positive electrode includes a positive electrode active material particle containing magnesium, fluorine, aluminum, and lithium cobalt oxide. When a surface of the positive electrode active material particle observed in a cross-sectional STEM image of a plane where lithium is inserted and extracted is a first layer, the positive electrode active material particle includes a region where magnesium is substituted for part of cobalt sites in a second layer, a third layer, a fourth layer, a fifth layer, and a sixth layer of the positive electrode active material particle. The positive electrode active material particle has a layered rock-salt crystal structure in an inner portion. The aluminum exists in the inner portion of the positive electrode active material particle.

In the above, the aluminum preferably has a function of reducing a volume change of the layered rock-salt crystal structure due to charge and discharge.

Another embodiment of the present invention is a lithium-ion secondary battery including a positive electrode and a negative electrode. The positive electrode includes a positive electrode active material particle containing magnesium, fluorine, nickel, and lithium cobalt oxide. When a surface of the positive electrode active material particle observed in a cross-sectional STEM image of a plane where lithium is inserted and extracted is a first layer, the positive electrode active material particle includes a region where magnesium is substituted for part of cobalt sites in a second layer, a third layer, a fourth layer, a fifth layer, and a sixth layer of the positive electrode active material particle. The positive electrode active material particle has a layered rock-salt crystal structure in an inner portion and has a rock-salt crystal structure in a surface portion. The nickel exists in the surface portion of the positive electrode active material particle.

In the above, the nickel preferably has a function of inhibiting a phase change from a layered rock-salt crystal structure to a spinel crystal structure by inhibiting release of oxygen.

Another embodiment of the present invention is a lithium-ion secondary battery including a positive electrode and a negative electrode. The positive electrode includes a positive electrode active material particle containing magnesium, fluorine, aluminum, nickel, and lithium cobalt oxide. The positive electrode active material particle has a layered rock-salt crystal structure in an inner portion and has a rock-salt crystal structure in a surface portion. When a surface of the positive electrode active material particle observed in a cross-sectional STEM image of a plane where lithium is inserted and extracted is a first layer, the positive electrode active material particle includes a region where magnesium is substituted for part of cobalt sites in a second layer, a third layer, a fourth layer, a fifth layer, and a sixth layer of the positive electrode active material particle. The fluorine exists closer to the surface than the region does. The aluminum exists in the inner portion of the positive electrode active material particle. The nickel exists in the surface portion of the positive electrode active material particle.

In the above, in STEM-EDX line analysis on the surface portion of the positive electrode active material particle, a position of a maximum concentration (atomic %) of magnesium is preferably closer to an inner portion than a position of a maximum concentration (atomic %) of fluorine is.

In the above, the positive electrode active material particle preferably has a layered rock-salt crystal structure belonging to a space group R-3m in a discharged state. When the positive electrode active material particle is used for the positive electrode, a lithium metal is used for a negative electrode, and a solution in which lithium hexafluorophosphate, ethylene carbonate, and diethyl carbonate are mixed with vinylene carbonate at a 2 wt % is used as an electrolyte solution, charge is performed at an environmental temperature of 25° C. under predetermined conditions, and the positive electrode in a charged state after the charge is analyzed by powder X-ray diffraction with CuKα₁ radiation, it is preferable that a diffraction pattern have a peak at 2θ of greater than or equal to 19.13° and less than or equal to 19.37° and have a peak at 2θ of greater than or equal to 45.37° and less than or equal to 45.57°. The charge under the predetermined conditions is performed by constant current charge at a current value of 0.5 C (where 1 C=137 mA/g) until a voltage of 4.60 V, followed sequentially by constant voltage charge until a current value of 0.01 C, a 30-minute pause, constant current discharge at the current value of 0.5 C until a voltage of 2.5 V, a 30-minute pause, constant current charge at the current value of 0.5 C until the voltage of 4.60 V, and constant voltage charge until the current value of 0.01 C.

In the above, an atomic ratio of magnesium to cobalt (Mg/Co) in an inner portion is preferably greater than or equal to 0.01 in EPMA of the positive electrode active material particle.

Another embodiment of the present invention is a method for forming a positive electrode active material particle containing magnesium, fluorine, and lithium cobalt oxide. A total time of heating at higher than or equal to 650° C. is longer than 100 hours.

Another embodiment of the present invention is a method for forming a positive electrode active material particle. The method includes mixing lithium cobalt oxide, a magnesium source, a fluorine source, and a lithium source to form a mixture and heating the mixture at higher than or equal to 650° C. and lower than or equal to 950° C. for longer than 100 hours.

In the above, the heating is preferably performed at higher than or equal to 826° C. and lower than or equal to 920° C. for longer than 100 hours and shorter than or equal to 150 hours.

According to one embodiment of the present invention, a positive electrode active material particle or a composite oxide which can be used in a lithium-ion secondary battery and inhibits a decrease in discharge capacity during charge and discharge cycles can be provided. Alternatively, a positive electrode active material particle or a composite oxide having a crystal structure that is unlikely to be broken by repeated charge and discharge can be provided. Alternatively, a positive electrode active material particle or a composite oxide with high discharge capacity can be provided. Alternatively, a secondary battery or a vehicle, which has a high level of safety or reliability can be provided.

According to another embodiment of the present invention, a positive electrode active material particle, a composite oxide, a power storage device, or a manufacturing method thereof can be provided.

Note that the description of these effects does not preclude the existence of other effects. One embodiment of the present invention does not necessarily have all these effects. Other effects will be apparent from and can be derived from the description of the specification, the drawings, the claims, and the like.

### BRIEF DESCRIPTION OF THE DRAWINGS

FIG. 1A is a cross-sectional view illustrating an internal structure of a secondary battery, and FIG. 1B is a cross-sectional view illustrating a positive electrode and an electrolyte of the secondary battery.

FIGS. 2A and 2B are cross-sectional views illustrating a positive electrode active material of one embodiment of the present invention.

FIGS. 3A to 3F are cross-sectional views illustrating a positive electrode active material particle of one embodiment of the present invention.

FIG. 4 illustrates crystal structures of a positive electrode active material particle of one embodiment of the present invention.

FIG. 5 illustrates crystal structures of a conventional positive electrode active material particle.

FIG. 6 shows XRD patterns calculated from crystal structures.

FIG. 7 shows XRD patterns calculated from crystal structures.

FIGS. 8A to 8C show methods for forming positive electrode active material particles.

FIG. 9 shows a method for forming positive electrode active material particles.

FIGS. 10A and 10B show a method for forming positive electrode active material particles.

FIGS. 11A to 11C illustrate a lithium-ion secondary battery of one embodiment of the present invention.

FIGS. 12A to 12C illustrate an electric vehicle of one embodiment of the present invention.

FIGS. 13A to 13E illustrate vehicles and the like of one embodiment of the present invention.

FIGS. 14A to 14D illustrate electronic devices and the like of one embodiment of the present invention.

FIGS. 15A to 15C show results of STEM-EDX analysis.

FIGS. 16A to 16C show results of STEM-EDX analysis.

FIGS. 17A to 17C show results of STEM-EDX analysis.

FIGS. 18A to 18C show results of STEM-EDX analysis.

FIGS. 19A to 19C show results of STEM-EDX analysis.

FIGS. 20A to 20C show results of STEM-EDX analysis.

FIGS. 21A and 21B show results of HAADF-STEM analysis.

FIGS. 22A and 22B show results of HAADF-STEM analysis.

FIGS. 23A and 23B show results of HAADF-STEM analysis.

FIGS. 24A and 24B show the result of HAADF-STEM analysis.

FIGS. 25A and 25B are graphs showing results of a charge and discharge cycle test.

FIG. 26 is a graph showing results of XRD analysis.

FIG. 27 is a graph showing results of XRD analysis.

FIG. 28 is a graph showing results of XRD analysis.

### DETAILED DESCRIPTION OF THE INVENTION

Hereinafter, embodiment examples for carrying out the present invention will be described with reference to the drawings and the like. Note that the present invention should not be construed as being limited to the embodiment examples given below. Embodiments for carrying out the invention can be changed unless they deviate from the spirit of the present invention.

In the drawings, sizes, layer thicknesses, or regions are sometimes exaggerated for clarity. Thus, the size, the layer thickness, or the region is not limited to the illustrated scale.

Ordinal numbers such as “first” and “second” in this specification and the like are used in order to avoid confusion among components and do not denote the order such as the order of steps or the stacking order. A term without an ordinal number in this specification and the like might be provided with an ordinal number in a claim in order to avoid confusion among components. A term with an ordinal number in this specification and the like might be provided with a different ordinal number in a claim. A term with an ordinal number in this specification and the like might not be provided with an ordinal number in a claim.

In this specification and the like, a space group is represented using the short symbol of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, space groups, crystal planes, and crystal orientations are sometimes expressed by placing “−” (a minus sign) in front of the number instead of placing a bar over the number. Furthermore, an individual direction that shows an orientation in crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”. A trigonal system represented by the space group R-3m is generally represented by a composite hexagonal lattice for easy understanding of the structure and is also represented by a composite hexagonal lattice in this specification and the like unless otherwise specified. In some cases, not only (hkl) but also (hkil) is used as the Miller index. Here, i is −(h+k).

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

The theoretical capacity of a positive electrode active material particle refers to the amount of electricity obtained when all lithium that can be inserted into and extracted from the positive electrode active material particle is extracted. For example, the theoretical capacity of LiCoO₂ is 274 mAh/g, the theoretical capacity of LiNiO₂ is 275 mAh/g, and the theoretical capacity of LiMn₂O₄ is 148 mAh/g.

The remaining amount of lithium that can be inserted into and extracted from a positive electrode active material particle is represented by x in a compositional formula, e.g., LiₓMO₂. Note that M represents a transition metal and is cobalt and/or nickel unless otherwise specified in this specification and the like. In the case of a positive electrode active material particle in a lithium-ion secondary battery, x can be represented by (theoretical capacity−charge capacity)/theoretical capacity. For example, when a lithium-ion secondary battery that includes LiMO₂ as a positive electrode active material is charged to 219.2 mAh/g, the positive electrode active material can be represented by Li_{0.2}MO₂, i.e., x=0.2. Note that “x in LiₓMO₂ is small” means, for example, 0.1<x≤0.24.

Lithium cobalt oxide to be used for a positive electrode, which has been appropriately synthesized and almost satisfies the stoichiometric proportion, is LiCoO₂ with x of 1. Also in a secondary battery after its discharging ends, it can be said that lithium cobalt oxide therein is LiCoO₂ with x of 1. Here, “state where discharging ends (discharged state)” means that the voltage becomes 3.0 V or 2.5 V or lower at a current of 100 mA/g or lower, for example.

Charge capacity and/or discharge capacity used for calculation of x in LiₓMO₂ are/is preferably measured under the conditions where there is no influence or small influence of a short circuit and/or decomposition of an electrolyte solution or the like. For example, data of a lithium-ion secondary battery that is measured while a sudden change in capacity that seems to be derived from a short circuit is caused should not be used for calculation of x.

The space group of a positive electrode active material particle or the like is identified by XRD, electron diffraction, neutron diffraction, or the like. Thus, in this specification and the like, belonging to a space group or being a space group can be rephrased as being identified as a space group.

A structure is referred to as a cubic close-packed structure when three layers of anions are shifted and stacked like “ABCABC” in the structure. Accordingly, anions do not necessarily form a cubic lattice structure. At the same time, actual crystals always have a defect and thus, analysis results are not necessarily consistent with the theory. For example, in an electron diffraction pattern or a fast Fourier transform (FFT) pattern of a transmission electron microscope (TEM) image or the like, a spot may appear in a position different from a theoretical position. For example, anions may be regarded as forming a cubic close-packed structure when a difference in orientation from a theoretical position is 5° or less or 2.5° or less.

The distribution of an element indicates the region where the element is successively detected by a successive analysis method to the extent that the detection value is no longer on the noise level. The region where the element is successively detected to the extent that the detection value is no longer on the noise level can be rephrased as, for example, the region where the element is detected every time the analysis is performed.

In this specification and the like, a positive electrode active material is sometimes referred to as a composite oxide, a positive electrode member, a positive electrode material, a secondary battery positive electrode member, a lithium-ion secondary battery positive electrode member, or the like.

In this specification and the like, description including a simple term “positive electrode active material” or “positive electrode active material particle” explains a plurality of positive electrode active material particles in some cases and explains one positive electrode active material particle in other cases, depending on an analysis method or the like. For example, when description relates to line analysis using a scanning transmission electron microscope and energy dispersive x-ray spectroscopy (STEM-EDX), STEM-electron energy-loss spectroscopy (STEM-EELS), or electron diffraction, the description is made on one positive electrode active material particle unless otherwise specified. Meanwhile, when description relates to X-ray photoelectron spectroscopy (XPS), X-ray diffraction (XRD), various types of mass spectroscopy, or the like, the description is made on a plurality of positive electrode active material particles unless otherwise specified.

In the case where the features of individual particles of a positive electrode active material are described in the following embodiment and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material particles and a secondary battery including the positive electrode active material particles is sufficiently obtained.

Note that the description is made on the assumption that materials (such as positive electrode active material particles, a negative electrode active material, an electrolyte solution, and a separator) of a secondary battery have not been degraded unless otherwise specified. A decrease in discharge capacity due to aging treatment and burn-in treatment during the manufacturing process of a secondary battery is not regarded as degradation. For example, a state where discharge capacity is higher than or equal to 97% of the rated capacity of a secondary battery composed of a cell or an assembled battery can be regarded as a non-degraded state. The rated capacity conforms to Japanese Industrial Standards (JIS C 8711:2019) in the case of a secondary battery for a portable device. The rated capacities of other secondary batteries conform to JIS described above, JIS for electric vehicle propulsion, industrial use, and the like, standards defined by the International Electrotechnical Commission (IEC), and the like.

In this specification and the like, in some cases, materials included in a secondary battery that have not been degraded are referred to as initial products or materials in an initial state, and materials that have been degraded (have discharge capacity lower than 97% of the rated capacity of the secondary battery) are referred to as products in use, materials in a used state, products that are already used, or materials in an already-used state.

In this specification and the like, the (001) plane, the (003) plane, and the like are sometimes collectively referred to as the (001) plane. In this specification and the like, the (001) plane is sometimes referred to as a C-plane, a basal plane, or the like. In lithium cobalt oxide, lithium diffuses through two-dimensional paths. In other words, the diffusion path of lithium extends along a plane. In this specification and the like, a plane where a lithium diffusion path is exposed, i.e., a plane where lithium is inserted and extracted (specifically, a plane other than the (001) plane), is sometimes referred to as an edge plane.

In this specification and the like, the phrase “A and/or B” is an example of an expression that encompasses only A, only B, and A and B.

### Embodiment 1

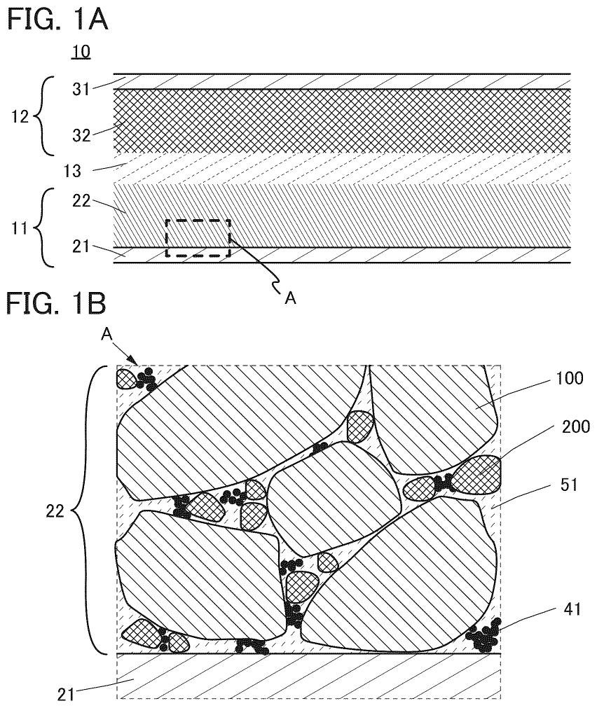

In this embodiment, a battery and a positive electrode active material particle of one embodiment of the present invention will be described with reference to FIGS. 1A and 1B, FIGS. 2A and 2B, FIGS. 3A to 3F, FIG. 4, FIG. 5, FIG. 6, and FIG. 7.

### [Battery]

A lithium-ion secondary battery of one embodiment of the present invention includes a positive electrode, a negative electrode, and an electrolyte. When the electrolyte includes an electrolyte solution, a separator is positioned between the positive electrode and the negative electrode. An exterior body covering at least part of peripheries of the positive electrode, the negative electrode, and the electrolyte may be further provided.

In this embodiment, a positive electrode and a positive electrode active material particle of a battery of one embodiment of the present invention are mainly described. Methods for forming the positive electrode active material particles of one embodiment of the present invention will be described in Embodiment 2, and the details of the other components of the lithium-ion secondary battery of one embodiment of the present invention will be described in Embodiment 3 and later embodiments.

FIG. 1A is a schematic cross-sectional view illustrating an internal structure of a lithium-ion secondary battery 10. The lithium-ion secondary battery 10 includes a positive electrode 11, a negative electrode 12, and a separator 13. The positive electrode 11 includes a positive electrode current collector 21 and a positive electrode active material layer 22 over the positive electrode current collector 21, and the negative electrode 12 includes a negative electrode current collector 31 and a negative electrode active material layer 32. As illustrated, the positive electrode active material layer 22 and the negative electrode active material layer 32 are provided to face each other with the separator 13 therebetween. Although not illustrated in FIG. 1A, electrolytes are contained in a space included in the positive electrode active material layer 22, a space included in the separator 13, and a space included in the negative electrode active material layer 32.

Note that one positive electrode 11, one negative electrode 12, and one separator 13 are illustrated in FIG. 1A; however, the structure of the lithium-ion secondary battery of one embodiment of the present invention is not limited thereto. Two positive electrodes 11, two negative electrodes 12, and two separators 13 may be provided, or more than two of each of the positive electrodes 11, the negative electrodes 12, and the separators 13 may be stacked. Not a stacked-layer structure illustrated in FIG. 1A but a wound structure may be employed.

FIG. 1B is an enlarged view illustrating a portion A surrounded by a dashed line in FIG. 1A.

The positive electrode active material layer 22 includes positive electrode active material particle 100 (also referred to as a first positive electrode active material), a second positive electrode active material 200, and a conductive material 41. Although not illustrated, the positive electrode active material layer 22 may include a binder other than the positive electrode active material particle 100, the second positive electrode active material 200, and the conductive material 41.

The space included in the positive electrode active material layer 22 is preferably filled with an electrolyte 51 as illustrated. For example, the proportion of the space included in the positive electrode active material layer 22 filled with the electrolyte 51 is preferably higher than or equal to 60%, further preferably higher than or equal to 70%, still further preferably higher than or equal to 80%, yet further preferably higher than or equal to 90%, yet still further preferably higher than or equal to 95%, most preferably higher than or equal to 99%. Note that the space included in the positive electrode active material layer 22 refers to a region other than a solid component (e.g., a positive electrode active material or a conductive material) in the positive electrode active material layer 22.

### [Positive Electrode]

The positive electrode 11 includes the positive electrode current collector 21 and the positive electrode active material layer 22. The positive electrode active material layer 22 includes the positive electrode active material particle 100, and the positive electrode active material particle 100 includes a group of particles.

### <Positive Electrode Active Material Particle 100>

The positive electrode active material particle 100 has functions of taking and releasing lithium ions in accordance with charge and discharge. For a positive electrode active material of one embodiment of the present invention, a material that is unlikely to deteriorate due to charge and discharge even at high charge voltage can be used. Specifically, a positive electrode active material particle (composite oxide) which has features described in this embodiment and a particle diameter (median diameter (D50)) greater than or equal to 10 μm and less than or equal to 50 μm, preferably greater than or equal to 9 μm and less than or equal to 25 μm can be used. This positive electrode active material particle contains any one or more of an additive element X, an additive element Y, and an additive element Z. Details of the additive elements X, Y, and Z are described in <Contained element>. Note that the additive elements X, Y, and Z are collectively referred to as an additive element A in some cases.

Note that the positive electrode active material particle 100 is a main constituent material of the positive electrode active material layer 22, and the weight of the positive electrode active material particles 100 preferably accounts for higher than or equal to 50%, further preferably higher than or equal to 60%, still further preferably higher than or equal to 70% of the weight of the solid component in the positive electrode active material layer 22. When the particle diameter of the positive electrode active material particle 100 is too small, the surface area becomes too large, which might cause an excessive reaction between a positive electrode active material surface and the electrolyte. Accordingly, the particle diameter (median diameter (D50)) of the positive electrode active material is preferably larger than or equal to 10 μm. In the case where the particle diameter of the positive electrode active material is larger than the thickness of an active material layer described later, the particle density of the active material layer cannot be increased; thus, the particle diameter of the largest particle is preferably less than or equal to 50 μm.

The second positive electrode active material 200 is a positive electrode active material having a smaller particle diameter than the positive electrode active material particle 100. For properties other than the particle diameter, the description of the positive electrode active material particle 100 can be referred to. When the positive electrode active materials with different particle diameters are mixed and used, the particle density of the active material layer can be increased.

The particle diameter can be measured with a particle size distribution analyzer (laser diffraction particle size distribution analyzer,) or the like using a laser diffraction and scattering method. D50 is a particle diameter when accumulation of particles accounts for 50% of a cumulative curve in a measurement result of the particle size distribution. The particle size may be calculated by measuring the major diameter of the cross section of the particle obtained by analysis with a scanning electron microscope (SEM), a transmission electron microscope (TEM), or the like, instead of using laser diffraction particle size distribution measurement. Note that an example of a method for measuring D50 with a SEM, TEM, or the like includes a method for measuring 20 or more particles to make a cumulative curve, and setting a particle diameter when the accumulation of particles accounts for 50% as D50.

Note that in this specification and the like, unless otherwise specified, “charge voltage” is shown with reference to the potential of a lithium metal. In this specification and the like, high charge voltage is charge voltage, for example, higher than or equal to 4.5 V, preferably higher than or equal to 4.55 V, further preferably higher than or equal to 4.6 V, higher than or equal to 4.65 V, or higher than or equal to 4.7 V.

As described above, high charge voltage in this specification and the like is the voltage higher than or equal to 4.6 V with reference to the potential when a lithium metal is used for the negative electrode; however, high charge voltage is the voltage higher than or equal to 4.5 V with reference to the potential when a carbon material (e.g., graphite) is used for the negative electrode. In short, charge voltage higher than or equal to 4.6 V is referred to as high charge voltage in the case of using a lithium metal as the negative electrode in a half cell, and charge voltage higher than or equal to 4.5 V is referred to as high charge voltage in the case of using a carbon material (e.g., graphite) for the negative electrode in a full cell.

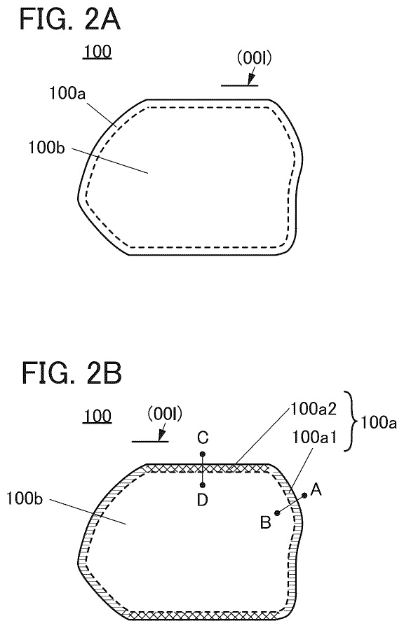

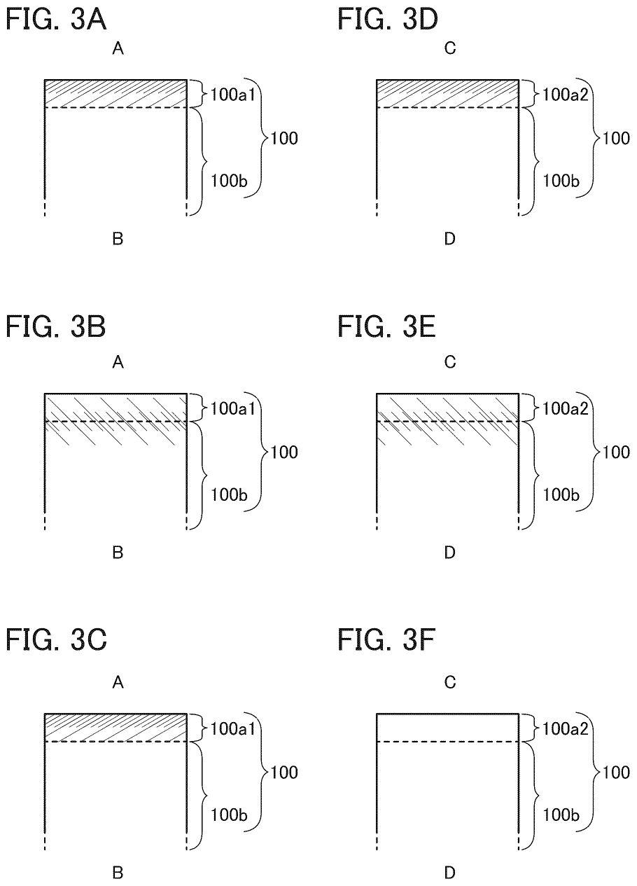

The positive electrode active material particle 100 that is unlikely to deteriorate due to repetition of charge at high charge voltage and discharge is described with reference to FIGS. 2A and 2B and FIGS. 3A to 3F.

FIGS. 2A and 2B are cross-sectional views of the positive electrode active material particle 100 of one embodiment of the present invention. FIGS. 3A to 3C illustrate enlarged views of a portion near the line A-B in FIG. 2B. FIGS. 3D to 3F illustrate enlarged views of a portion near the line C-D in FIG. 2B.

As illustrated in FIG. 2A, the positive electrode active material particle 100 includes a surface portion 100a and an inner portion 100b. In the drawings, the dashed line denotes a boundary between the surface portion 100a and the inner portion 100b.

The surface portion 100a of the positive electrode active material particle 100 refers to a region of less than or equal to 10 nm from the surface toward the inner portion in a direction perpendicular or substantially perpendicular to the surface, for example. Note that “substantially perpendicular” refers to a state where an angle is greater than or equal to 80° and less than or equal to 100°. A plane generated by a crack can be considered as a surface. The surface portion 100a can be rephrased as the vicinity of a surface, a region in the vicinity of a surface, or a shell.

The inner portion 100b refers to a region deeper than the surface portion 100a of the positive electrode active material particle 100. The inner portion 100b can be rephrased as an inner region or a core.

In the case where the positive electrode active material particle 100 has a layered rock-salt crystal structure belonging to a space group R-3m, the surface portion 100a includes a Li-insertion/extraction region 100a1 and a basal region 100a2 as illustrated in FIG. 2B. Note that in FIGS. 2A and 2B, the straight line denoted by (001) represents a (001) plane. Here, the Li-insertion/extraction region 100a1 has a surface exposed in a direction intersecting the (001) plane, and a region of less than or equal to 10 nm from the surface toward the inner portion in a direction perpendicular or substantially perpendicular to the surface is referred to as the Li-insertion/extraction region 100a1. Here, “intersect” means that an angle between a perpendicular line of a first plane (the (001) plane) and a normal of a second plane (a surface of the positive electrode active material particle 100) is greater than or equal to 10° and less than or equal to 90°, preferably greater than or equal to 30° and less than or equal to 90°.

The basal region 100a2 has a surface parallel to the (001) plane, and a region of less than or equal to 10 nm from the surface toward the inner portion in a direction perpendicular or substantially perpendicular to the surface is referred to as the basal region 100a2. Here, “parallel” means that an angle between the perpendicular line of the first plane (the (001) plane) and the normal of the second plane (the surface of the positive electrode active material particle 100) is greater than or equal to 0° and less than or equal to 5°, preferably greater than or equal to 0° and less than or equal to 2.5°.

The surface of the positive electrode active material particle 100 refers to a surface of a composite oxide that includes the surface portion 100a and the inner portion 100b, for example. The surface of the positive electrode active material particle 100 in a cross-sectional STEM (scanning transmission electron microscope) image or the like refers to a plane which is closest to the outside and in which a metal element having a larger atomic number than lithium is observed first. More specifically, the surface of the positive electrode active material particle 100 refers to a point in which an atomic nucleus of a metal element having a larger atomic number than lithium, that is, a luminance peak in the cross-sectional STEM image or the like first exists.

Thus, the positive electrode active material particle 100 does not contain either a metal oxide, such as aluminum oxide (Al₂O₃), which is attached to a surface of the positive electrode active material particle 100 and does not include a lithium site contributing to charge and discharge; or a material such as a carbonate or a hydroxy group, which is chemically adsorbed after formation of the positive electrode active material particle 100. The attached metal oxide refers to, for example, a metal oxide having a crystal orientation different from that of the inner portion 100b.

Furthermore, an electrolyte, a decomposition product of an electrolyte, an organic solvent, a binder, a conductive material, and a compound originating from any of these that are attached to the positive electrode active material particle 100 are not contained either.

Since the positive electrode active material particle 100 is a compound containing oxygen and a transition metal into and from which lithium can be inserted and extracted, an interface between a region where oxygen and a transition metal M (Co, Ni, Mn, Fe, or the like) that is oxidized or reduced due to insertion and extraction of lithium exist and a region where oxygen and the transition metal M do not exist is considered as the surface of the positive electrode active material particle 100. A plane generated by slipping and/or a crack also can be considered as the surface of the positive electrode active material particle 100. When the positive electrode active material particle 100 is analyzed, a protective film is attached on its surface in some cases; however, the protective film is not included in the positive electrode active material particle 100. As the protective film, a single-layer film or a multilayer film of carbon, a metal, an oxide, a resin, or the like is sometimes used.

### <Contained Element>

The positive electrode active material particle 100 contains lithium, cobalt, oxygen, and an additive element. Alternatively, the positive electrode active material particle 100 can contain lithium cobalt oxide (LiCoO₂) to which an additive element is added. Note that the composition of the lithium cobalt oxide is not strictly limited to Li:Co:O=1:1:2.

The positive electrode active material particle 100 of a lithium-ion secondary battery needs to contain a transition metal which can take part in an oxidation-reduction reaction in order to maintain a neutrally charged state even when lithium ions are inserted and extracted. It is preferable that the positive electrode active material particle 100 of one embodiment of the present invention mainly contain cobalt as a transition metal taking part in an oxidation-reduction reaction. In addition to cobalt, at least one or both of nickel and manganese may be contained. Using cobalt at higher than or equal to 75 atomic %, preferably higher than or equal to 90 atomic %, further preferably higher than or equal to 95 atomic % as the transition metal contained in the positive electrode active material particle 100 brings many advantages such as relatively easy synthesis, easy handling, and excellent cycle performance, which is preferable.

The positive electrode active material particle 100 contains magnesium and fluorine as the additive elements. In addition to them, one or more selected from nickel, aluminum, titanium, zirconium, vanadium, iron, manganese, chromium, niobium, arsenic, zinc, silicon, sulfur, phosphorus, boron, calcium, barium, bromine, and beryllium are preferably used. The total percentage of the transition metal among the additive elements is preferably lower than 25 atomic %, further preferably lower than 10 atomic %, still further preferably lower than 5 atomic %.

That is, as the positive electrode active material particle 100, one or more of lithium cobalt oxide containing magnesium and fluorine, lithium cobalt oxide containing magnesium, fluorine, and aluminum, lithium cobalt oxide containing magnesium, fluorine, and nickel, lithium cobalt oxide containing magnesium, fluorine, nickel, and aluminum, and the like can be used.

As the positive electrode active material particle 100, any one or more of a positive electrode active material containing cobalt, oxygen, magnesium, and fluorine, a positive electrode active material containing cobalt, oxygen, magnesium, fluorine, and aluminum, a positive electrode active material containing cobalt, oxygen, magnesium, fluorine, and nickel, a positive electrode active material containing cobalt, oxygen, magnesium, fluorine, nickel, and aluminum, and the like can be used for the lithium-ion secondary battery.

The additive element preferably forms a solid solution with the positive electrode active material particle 100. For example, in STEM-EDX line analysis performed from the outside of the positive electrode active material particle 100 toward the inner portion thereof, a position where the detection of the additive element in the depth direction begins is preferably at a deeper level than a position where the detection of the transition metal M begins, i.e., on the inner portion side of the positive electrode active material particle 100.

Such an additive element further stabilizes the crystal structure of the positive electrode active material particle 100.

Note that as the additive element, nickel, aluminum, titanium, zirconium, vanadium, iron, manganese, chromium, niobium, arsenic, zinc, silicon, sulfur, phosphorus, boron, calcium, barium, bromine, or beryllium is not necessarily contained.

When the positive electrode active material particle 100 is substantially free from titanium, for example, the above advantage such as excellent cycle performance is enhanced. The weight of titanium contained in the positive electrode active material particle 100 is preferably less than or equal to 600 ppm, further preferably less than or equal to 100 ppm, for example. When the positive electrode active material particle 100 is subjected to STEM-EDX analysis, a characteristic X-ray attributed to titanium is not observed, that is, the characteristic X-ray attributed to titanium is preferably lower than the lower detection limit (e.g., lower than 0.3 atomic %).

When the positive electrode active material particle 100 is substantially free from manganese, for example, the above advantages such as relatively easy synthesis, easy handling, and excellent cycle performance are enhanced. The weight of manganese contained in the positive electrode active material particle 100 is preferably less than or equal to 600 ppm, further preferably less than or equal to 100 ppm, for example.

The surface portion 100a is a region from which lithium ions are extracted first in charging, and tends to have a lower lithium concentration than the inner portion 100b. It can be said that bonds between atoms are partly cut on the surface of the surface portion 100a. Thus, the surface portion 100a is regarded as a region which is likely to be unstable and in which degradation of the crystal structure is likely to begin. Meanwhile, if the surface portion 100a can have sufficient stability, the layered structure, which is formed of octahedrons of cobalt and oxygen, of the inner portion 100b is difficult to break even when x in LiₓCoO₂ is small, e.g., 0.24 or less. Furthermore, a shift in layers, which are formed of octahedrons of cobalt and oxygen, of the inner portion 100b can be inhibited.

To obtain a stable composition and a stable crystal structure in the surface portion 100a, the surface portion 100a preferably contains an additive element, further preferably a plurality of additive elements. The surface portion 100a preferably contains one or more selected from the additive elements at higher concentrations than those in the inner portion 100b. The one or more selected from the additive elements contained in the positive electrode active material particle 100 preferably have concentration gradients. In addition, it is further preferable that the additive elements contained in the positive electrode active material particle 100 be differently distributed. For example, it is preferable that the additive elements exhibit concentration peaks at different depths from a surface. The concentration peak here refers to the local maximum value of the concentration in the surface portion 100a or a region of less than or equal to 50 nm from the surface.

### [Distribution]

Distribution of the additive elements is described. FIGS. 3A to 3C illustrate enlarged views of the portion near the line A-B in FIG. 2B and describe the Li-insertion/extraction region 100a1 of the positive electrode active material particle 100. FIGS. 3D to 3F illustrate enlarged views of the portion near the line C-D in FIG. 2B and describe the basal region 100a2 of the positive electrode active material particle 100.

For example, some of the additive elements such as magnesium, fluorine, silicon, phosphorus, boron, and calcium preferably have a concentration gradient as illustrated in FIGS. 3A and 3D by gradation, in which the concentration increases from the inner portion 100b toward the surface. An additive element which has such a concentration gradient is referred to as the additive element X.

Another additive element such as aluminum or manganese preferably has a concentration gradient as represented by hatching in FIGS. 3B and 3E and exhibits a concentration peak in a deeper region than a concentration peak of the additive element X shown in FIGS. 3A and 3D. The concentration peak is preferably located in the inner portion 100b. For example, the peak is preferably located in a region of greater than 10 nm and less than or equal to 30 nm toward the inner portion from the surface. An additive element which has such a concentration gradient is referred to as the additive element Y.

Another additive element such as nickel or barium clearly exists in the Li-insertion/extraction region 100a1 but does not substantially exist in the basal region 100a2, in some cases, as represented by the presence or absence of hatching and the density of the hatching in FIGS. 3C and 3F. Note that here, “clearly exist” means a case where the energy spectrum of characteristic X-ray of the element is detected in cross-sectional STEM-EDX analysis of the positive electrode active material particle 100. Note that here, “not substantially exist” means a case where the energy spectrum of characteristic X-ray of the element is not detected in cross-sectional STEM-EDX analysis of the positive electrode active material particle 100. This phenomenon is also expressed that the amount of the element is below the lower detection limit in STEM-EDX analysis. An additive element which has such distribution is referred to as the additive element Z.

The effect, preferable concentration, and the like of each additive element are described in detail below.

### [Magnesium]

The positive electrode active material particle 100 of one embodiment of the present invention has a layered rock-salt crystal structure in the inner portion and a rock-salt crystal structure in the surface portion 100a. As described later, although crystal orientations of these structures are substantially aligned with each other, distortion derived from lattice mismatch (which may also be referred to as a difference in interionic distance) exists between them. Magnesium, which is an example of the additive element X, has a function of relieving the distortion.

For example, in the case where the rock-salt crystal structure of the surface portion 100a is formed of only cobalt oxide CoO, the degree of lattice mismatch (a difference in interionic distance) between lithium cobalt oxide of the inner portion 100b and the cobalt oxide CoO is greater than or equal to 5.9%. However, when magnesium forms a solid solution with the surface portion 100a which includes a first layer, the degree of lattice mismatch between lithium cobalt oxide of the inner portion 100b and the surface portion 100a can be made smaller than the above. This is because the distance between a metal and an oxygen in the magnesium oxide MgO is closer to the average distance between a metal and an oxygen in the lithium cobalt oxide than the distance between a metal and an oxygen in the cobalt oxide CoO is.

To efficiently relieve distortion, magnesium is preferably substituted for part of the cobalt sites or lithium sites in a second layer to a sixth layer in the surface portion 100a. In particular, magnesium is preferably substituted for part of the cobalt sites in the fourth layer.

When magnesium is substituted for part of the cobalt sites, lithium vacancies are induced around the sites to maintain cation balance in some cases. The positive electrode active material particle 100 including lithium vacancies can have reduced lithium diffusion resistance because lithium vacancies hasten the diffusion of lithium. Furthermore, when magnesium is substituted for part of the cobalt sites, the layered rock-salt crystal structure or the rock-salt crystal structure is easily maintained even after charging and discharging. Thus, the lithium diffusion path can be maintained even after charging and discharging, and the positive electrode active material particle 100 whose lithium diffusion resistance is less likely to increase even after charging and discharging can be obtained.

However, when magnesium exists on the inner portion side from the seventh layer or deeper, a disadvantage of a lithium diffusion path being blocked by magnesium might be larger than the above advantage. Thus, magnesium is preferably substituted for part of cobalt sites in a region outer than the seventh layer of the positive electrode active material particle.

Note that in this specification and the like, the surface observed in a cross-sectional STEM image or the like of the positive electrode active material particle 100, i.e., a line of atoms of a metal element that is closest to the outside and has a larger atomic number than lithium, is referred to as a first layer. A line of atoms of a metal element having a larger atomic number than lithium which is observed in the second closest position to the outside is referred to as a second layer. The same applies to the third layer and the subsequent layers. In a HAADF-STEM image, a contrast corresponding to the atomic number is obtained, and an element having a larger atomic number is observed to be brighter. In addition, the STEM-energy dispersive X-ray spectroscopy (EDX) can perform element analysis. Thus, with combination of these analyses, in the surface portion 100a, when cobalt and magnesium are detected but no other metal elements whose atomic numbers are close to that of magnesium are detected in STEM-EDX analysis and when an element whose luminance is lower than that of cobalt is observed in cobalt sites in a HAADF-STEM image, it can be judged that magnesium is substituted for the cobalt sites.

Magnesium may be at a position of a dangling bond.

Magnesium is divalent, and a magnesium ion is more stable in a lithium site than in a cobalt site in a layered rock-salt crystal structure; thus, magnesium is likely to enter the lithium sites. An appropriate concentration of magnesium at the lithium sites of the surface portion 100a facilitates maintenance of the layered rock-salt crystal structure. This is because magnesium at the lithium sites serves as a column supporting the CoO₂ layers. Moreover, magnesium can inhibit extraction of oxygen therearound in a state where x in LiₓCoO₂ is, for example, 0.24 or less. When magnesium dispersively exists in the surface portion 100a in a net-like manner, release of oxygen can be inhibited without adversely affecting insertion and extraction of lithium, which is more effective. The deterioration of the positive electrode active material particle 100 is considered to start from release of oxygen from the surface portion 100a and subsequently proceed to dissolution of cobalt; thus, it is important to inhibit release of oxygen to inhibit deterioration. Note that “magnesium dispersively exists” means that magnesium is distributed at an appropriate concentration.

To obtain the above effect sufficiently, magnesium preferably exists at a sufficient concentration in the surface portion 100a. For example, the maximum concentration of magnesium in the surface portion 100a in STEM-EDX line analysis is preferably higher than or equal to 7 atomic %, further preferably higher than or equal to 10 atomic %.

However, excess magnesium might adversely affect insertion and extraction of lithium. Thus, the positive electrode active material particle 100 preferably contains an appropriate amount of magnesium. For example, the maximum concentration of magnesium in the surface portion 100a in STEM-EDX line analysis is preferably lower than or equal to 25 atomic %. That is, the maximum concentration of magnesium in the surface portion 100a in STEM-EDX line analysis is preferably higher than or equal to 7 atomic % and lower than or equal to 25 atomic %, further preferably higher than or equal to 10 atomic % and lower than or equal to 25 atomic %. In addition, in the EPMA, the atomic ratio of magnesium to cobalt (Mg/Co) in the inner portion is preferably greater than 0 and less than or equal to 0.02, further preferably greater than or equal to 0.005 and less than or equal to 0.015.

### [Fluorine]

Fluorine has a function of promoting transfer of the additive element to the inner portion 100b of the positive electrode active material particle 100.

More specifically, in the case where a fluoride such as lithium fluoride has a lower melting point than other additive element sources, the fluoride serves as a fusing agent (also referred to as a flux) for lowering the melting points of the other additive element sources. This enables a liquid containing a fluoride and the other additive elements to spread over the surface of the lithium cobalt oxide in the heating step. Accordingly, the additive elements are easily distributed uniformly in the surface portion 100a. When the additive elements are uniformly distributed in the surface portion 100a, the additive elements move rapidly from the surface portion 100a to the inner portion. Furthermore, fluorine also functions as an aid for diffusion of magnesium from the surface portion 100a into the inner portion.

Fluorine preferably exists on the outermost surface side (which may also referred to as a region near the outside of the particle, the outermost surface, or the like). For example, in terms of the position where the concentration of each element has the maximum value in the surface portion 100a in STEM-EDX line analysis, the position where the concentration of fluorine has the maximum value (atomic %) is preferably closer to the surface side than the positions where the concentrations of the other additive elements have the maximum values (atomic %) is. In other words, the positions where the concentrations of the other additive elements such as magnesium have the maximum values (atomic %) are preferably closer to the inner portion side than the position where the concentration of fluorine has the maximum value (atomic %) is.

When fluorine exists at the surface portion 100a including the surface that is in contact with an electrolyte solution, or when a fluoride is attached to the surface, an overreaction between the positive electrode active material particle 100 and the electrolyte solution can be inhibited. In addition, the corrosion resistance to hydrofluoric acid can be effectively increased.

### [Nickel]

Since nickel has a higher bonding strength with oxygen than cobalt, nickel has a function of inhibiting release of oxygen from the positive electrode active material particle 100 and a phase change from a layered rock-salt crystal structure to a spinel crystal structure. Thus, nickel preferably exists at a high concentration in the surface portion 100a, which is a region where a phase change to the spinel crystal structure is likely to occur. In particular, nickel is preferably substituted for lithium sites in layers up to the fourth layer of the Li-insertion/extraction region 100a1.

Furthermore, in nickel, Ni²⁺ is more stable than Ni³⁺ and Ni⁴⁺, and nickel has higher trivalent ionization energy than cobalt. Thus, it is known that a spinel crystal structure does not appear only with nickel and oxygen. In this respect, nickel is considered to have an effect of inhibiting a phase change from a layered rock-salt crystal structure to a spinel crystal structure.

In addition, when nickel exists at a lithium site, a shift in the layered structure formed of octahedrons of cobalt and oxygen can be inhibited. Moreover, a change in volume in charge and discharge is inhibited. This is presumably because nickel at the lithium sites also serves as a column supporting the MO₂ layers. Thus, in particular, the crystal structure is expected to be more stable in a charged state at high temperatures, e.g., 45° C. or higher, which is preferable. Nickel preferably exists not only in the surface portion 100a but also in the inner portion 100b in order to achieve the above-described effect.

Meanwhile, excess nickel increases the influence of distortion due to the Jahn-Teller effect, which is not preferable. Moreover, excess nickel might adversely affect insertion and extraction of lithium.

Thus, the positive electrode active material particle 100 preferably contains an appropriate amount of nickel. For example, in the EPMA, the atomic ratio of nickel to cobalt (Ni/Co) in the inner portion is preferably greater than 0 and less than or equal to 0.05, further preferably greater than or equal to 0.001 and less than or equal to 0.01, still further preferably greater than or equal to 0.004 and less than or equal to 0.008.

### [Aluminum]

Aluminum has a function of reducing a volume change of a layered rock-salt crystal structure due to charge and discharge. Aluminum can be present at a cobalt site in a layered rock-salt crystal structure. Since aluminum is a trivalent representative element and its valence does not change, lithium around aluminum is less likely to move even in charge and discharge. Thus, aluminum and lithium therearound serve as columns to inhibit a change in the crystal structure and a volume change due to charge and discharge. Accordingly, even when force of expansion and contraction in the c-axis direction acts on the positive electrode active material particle 100 owing to insertion and extraction of lithium ions as described later, deterioration of the positive electrode active material particle 100 can be inhibited.

Furthermore, aluminum has an effect of inhibiting dissolution of cobalt therearound and improving continuous charging tolerance. Moreover, an Al—O bond is stronger than a Co—O bond and thus extraction of oxygen around aluminum can be inhibited. These effects improve thermal stability. Thus, a secondary battery that includes the positive electrode active material particle 100 containing aluminum as the additive element can have higher level of safety. In addition, the positive electrode active material particle 100 having a crystal structure that is unlikely to be broken by repeated charge and discharge can be provided.

Meanwhile, excess aluminum might cause an adverse effect such as a reduction in capacity and/or an increase in lithium diffusion resistance.

Thus, the positive electrode active material particle 100 preferably contains an appropriate amount of aluminum. For example, in the entire positive electrode active material particle 100, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, the number of aluminum atoms is preferably higher than or equal to 0.05% and lower than or equal to 2% of the number of cobalt atoms. Alternatively, the number of aluminum atoms is preferably higher than or equal to 0.1% and lower than or equal to 4% of the number of cobalt atoms. Here, the amount of aluminum contained in the entire positive electrode active material particle 100 may be a value obtained by element analysis on the entirety of the positive electrode active material particles 100 with GD-MS, ICP-MS, or the like or may be a value based on the ratio of the raw materials mixed in the process of forming the positive electrode active material particles 100, for example.

### [Substantially the Same Crystal Orientation]

It is preferable that the crystal structure continuously change from the inner portion 100b toward the surface owing to the above-described concentration gradients of such additive elements. Alternatively, it is preferable that the orientations of a crystal in the surface portion 100a and a crystal in the inner portion 100b be substantially aligned with each other.

For example, a crystal structure preferably changes continuously from the inner portion 100b that has a layered rock-salt crystal structure toward the surface and the surface portion 100a that have a feature of a rock-salt crystal structure or features of both a rock-salt crystal structure and a layered rock-salt crystal structure. Alternatively, the orientations of a crystal in the surface portion 100a that has the feature of a rock-salt crystal structure or the features of both a rock-salt crystal structure and a layered rock-salt crystal structure and a crystal in the layered rock-salt the inner portion 100b are preferably substantially aligned with each other.

Note that in this specification and the like, a layered rock-salt crystal structure, which belongs to the space group R-3m, of a composite oxide containing lithium and a transition metal such as cobalt refers to a crystal structure in which a rock-salt ion arrangement where cations and anions are alternately arranged is included and the transition metal and lithium are regularly arranged to form a two-dimensional plane, so that lithium can diffuse two-dimensionally. Note that a defect such as a cation or anion vacancy may exist. In the layered rock-salt crystal structure, strictly, a lattice of a rock-salt crystal is distorted in some cases.

A rock-salt crystal structure refers to a structure in which a cubic crystal structure such as a space group Fm-3m is included and cations and anions are alternately arranged. Note that a cation or anion vacancy may exist.

Having features of both a layered rock-salt crystal structure and a rock-salt crystal structure can be determined by electron diffraction, a TEM image, a cross-sectional STEM image, or the like. Having features of both a layered rock-salt crystal structure and a rock-salt crystal structure can be expressed as “rock-salt crystal structures dispersively exist in a layered rock-salt crystal structure”. A region where the rock-salt crystal structures dispersively exist in a layered rock-salt crystal structure preferably exists on the surface side of the surface portion 100a, for example, in the first layer to the third layer of the Li-insertion/extraction region 100a1.

There is no distinction among cation sites in a rock-salt crystal structure. Meanwhile, a layered rock-salt crystal structure has two types of cation sites: one type is mostly occupied by lithium, and the other is mostly occupied by the transition metal. A stacked-layer structure where two-dimensional planes of cations and two-dimensional planes of anions are alternately arranged is the same in a rock-salt crystal structure and a layered rock-salt crystal structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt crystal structure, for instance, and on the (003) plane in a layered rock-salt crystal structure, for instance. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, when two phases of rock-salt MgO and layered rock-salt LiCoO₂ are included in a region to be analyzed, a plane orientation in which bright spots with high luminance and bright spots with low luminance are alternately arranged is seen in an electron diffraction pattern. A bright spot common between the rock-salt and layered rock-salt crystal structures has high luminance, whereas a bright spot caused only in the layered rock-salt crystal structure has low luminance.

When a layered rock-salt crystal structure is observed from a direction perpendicular to the c-axis in a cross-sectional HAADF-STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a larger atomic number than lithium exists in part of the layers with low luminance, i.e., the lithium layers.

Anions of a layered rock-salt crystal and anions of a rock-salt crystal form a cubic close-packed structure (face-centered cubic lattice structure). When a layered rock-salt crystal and a rock-salt crystal are in contact with each other, there is a crystal plane at which orientations of cubic close-packed structures formed of anions are aligned with each other.

Note that a space group of the layered rock-salt crystal and the O3′ type crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ type crystal is different from that in the rock-salt crystal. In this specification, in the layered rock-salt crystal, the O3′ crystal, and the rock-salt crystal, a state where the orientations of the cubic close-packed structures formed of anions are aligned with each other may be referred to as a state where crystal orientations are substantially aligned with each other. In addition, a state where three-dimensional structures have similarity, e.g., crystal orientations are substantially aligned with each other, or orientations are crystallographically the same is referred to as topotaxy.

The crystal orientations in two regions being substantially aligned with each other can be judged, for example, from a TEM image, a STEM image, a high-angle annular dark field scanning TEM (HAADF-STEM) image, an annular bright-field scanning transmission electron microscope (ABF-STEM) image, an electron diffraction pattern, or the like. It can be determined also from an FFT pattern of a TEM image or an FFT pattern of a STEM image or the like. XRD, neutron diffraction, and the like can also be used for judging.

<Crystal Structure in the State where x in LiₓCO₂ is Small>

The crystal structure in a state where x in LiₓCoO₂ is small of the positive electrode active material particle 100 of one embodiment of the present invention is preferably different from that of a conventional positive electrode active material because the positive electrode active material particle 100 has the above-described distribution of the additive element A and/or crystal structure in a discharged state. Here, “x is small” means 0.1<x≤0.24.

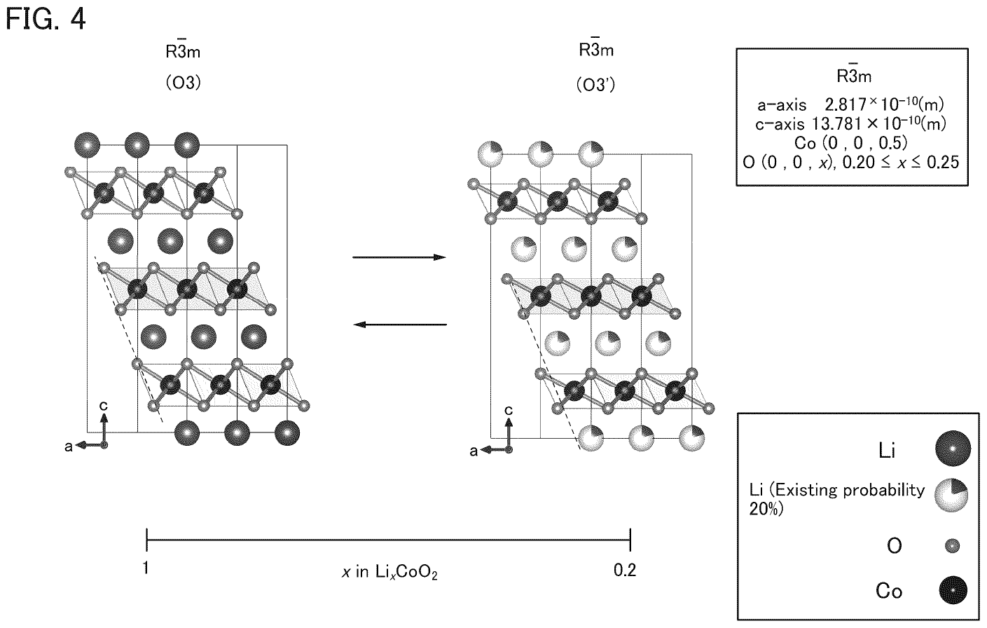

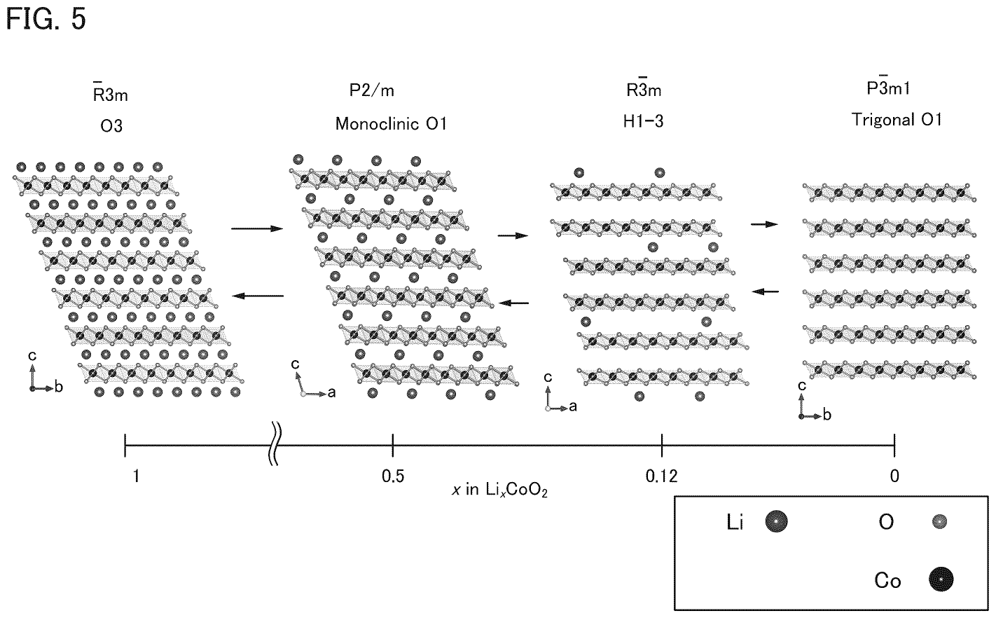

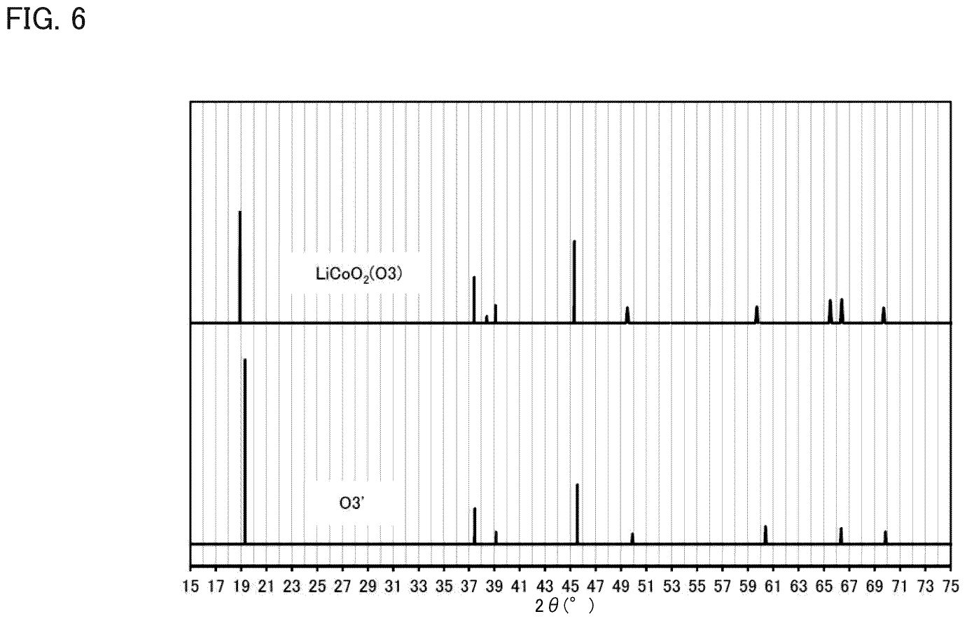

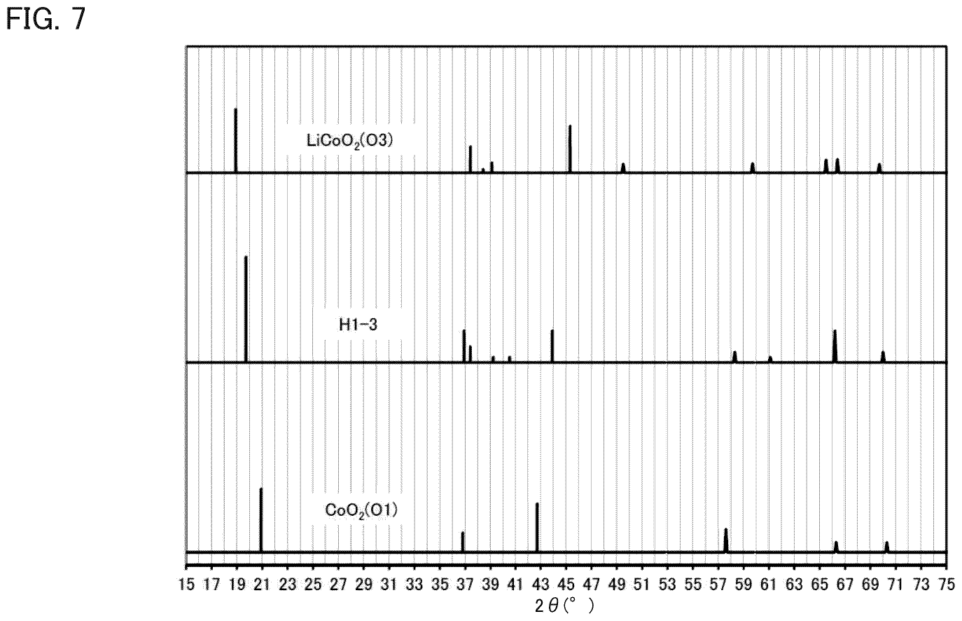

A conventional positive electrode active material and the positive electrode active material particle 100 of one embodiment of the present invention are compared, and changes in the crystal structures owing to a change in x in LiₓCoO₂ will be described with reference to FIG. 4, FIG. 5, FIG. 6, and FIG. 7.

A change in the crystal structure of the conventional positive electrode active material is illustrated in FIG. 5. The conventional positive electrode active material illustrated in FIG. 5 is lithium cobalt oxide (LiCoO₂) containing no additive element A. In FIG. 5, the crystal structure of lithium cobalt oxide with x in LiₓCoO₂ being 1 is denoted by R-3m O3.

Conventional lithium cobalt oxide with x of approximately 0.12 has the crystal structure belonging to the space group R-3m. This structure can also be regarded as a structure in which CoO₂ structures such as a trigonal O1 type structure and LiCoO₂ structures such as an R-3m O3 type structure are alternately stacked. Thus, this crystal structure is sometimes referred to as an H1-3 type structure. Note that the number of cobalt atoms per unit cell in the actual H1-3 type structure is twice that in other structures. However, in this specification including FIG. 5, the c-axis of the H1-3 type structure is half that of the unit cell for easy comparison with the other crystal structures.

For the H1-3 type structure, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). Note that O1 and O2 are each an oxygen atom. A preferred unit cell for representing a crystal structure in a positive electrode active material can be selected by Rietveld analysis of XRD patterns, for example. In this case, a unit cell is selected such that the value of goodness of fit (GOF) is small.

When charging that makes x in LiₓCoO₂ be 0.24 or less and discharging are repeated, the crystal structure of conventional lithium cobalt oxide repeatedly changes between the R-3m O3 type structure in a discharged state and the H1-3 type structure (i.e., an unbalanced phase change).

However, there is a large shift in the CoO₂ layers between these two crystal structures. As denoted by the dotted lines and the arrows in FIG. 5, the CoO₂ layer in the H1-3 type structure largely shifts from that in the structure belonging to R-3m O3 in a discharged state. Such a dynamic structural change can adversely affect the stability of the crystal structure.

A difference in volume between the two crystal structures is also large. When the R-3m O3 type structure in a discharged state and the H1-3 type structure contain the same number of cobalt atoms, these structures have a difference in volume of greater than 3.5%, typically greater than or equal to 3.9%.

In addition, a structure in which CoO₂ layers are arranged continuously, as in the trigonal O1 type structure, included in the H1-3 type structure is highly likely to be unstable.

Accordingly, when charging that makes x be 0.24 or less and discharging are repeated, the crystal structure of conventional lithium cobalt oxide is gradually broken. The broken crystal structure triggers degradation of the cycle performance. This is because the broken crystal structure has a smaller number of sites which lithium can occupy stably and makes it difficult to insert and extract lithium.

Meanwhile, in the positive electrode active material particle 100 of one embodiment of the present invention illustrated in FIG. 4, a change in the crystal structure between a discharged state with x in LiₓCoO₂ of 1 and a state with x of 0.24 or less is smaller than that in the conventional positive electrode active material. Specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material particle 100 of one embodiment of the present invention can have a crystal structure that is difficult to break even when charging that makes x be 0.24 or less and discharging are repeated, and obtain excellent cycle performance. In addition, the positive electrode active material particle 100 of one embodiment of the present invention with x in LiₓCoO₂ of 0.24 or less can have a more stable crystal structure than the conventional positive electrode active material. Thus, the positive electrode active material particle 100 of one embodiment of the present invention with x in LiₓCoO₂ being kept at 0.24 or less inhibits a short circuit. This is preferable because the safety of a secondary battery is further improved.

FIG. 4 illustrates crystal structures of the inner portion 100b of the positive electrode active material particle 100 in a state where x in LiₓCoO₂ is 1 and approximately 0.2. The inner portion 100b, accounting for the majority of the volume of the positive electrode active material particle 100, largely contributes to charge and discharge and is accordingly a portion where a shift in CoO₂ layers and a volume change matter most.

The positive electrode active material particle 100 with x of 1 has a crystal structure belonging to R-3m O3, which is the same as that of conventional lithium cobalt oxide.

However, in a state where x is 0.24 or less, e.g., approximately 0.2 or approximately 0.12, the positive electrode active material particle 100 has a crystal structure different from the H1-3 type structure of conventional lithium cobalt oxide.

The positive electrode active material particle 100 of one embodiment of the present invention with x of approximately 0.2 has a trigonal crystal structure belonging to the space group R-3m. The symmetry of the CoO₂ layers of this structure is the same as that of the O3 type structure. Thus, this crystal structure is referred to as an O3′ type structure. In FIG. 4, this crystal structure is denoted by R-3m O3′.

Note that in the unit cell of the O3′ type structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (×10⁻¹ nm), further preferably 2.807≤a≤2.827 (×10⁻¹ nm), typically a=2.817 (×10⁻¹ nm). The lattice constant of the c-axis is preferably 13.681≤c≤13.881 (×10⁻¹ nm), further preferably 13.751≤c≤13.811 (×10⁻¹ nm), typically, c=13.781 (×10⁻¹ nm).

In the O3′ type structure, an ion of cobalt, nickel, magnesium, or the like occupies a site coordinated to six oxygen atoms. Note that a light element such as lithium sometimes occupies a site coordinated to four oxygen atoms.

As denoted by the dotted lines in FIG. 4, the CoO₂ layers hardly shift between the R-3m (O3) type structure in a discharged state and the O3′ type structure.

The R-3m (O3) type structure in a discharged state and the O3′ type structure that contain the same number of cobalt atoms have a difference in volume of 2.5% or less, specifically 2.2% or less, typically 1.8%.

As described above, in the positive electrode active material particle 100 of one embodiment of the present invention, a change in the crystal structure caused when x in LiₓCoO₂ is small, i.e., when a large amount of lithium is extracted, is smaller than that in the conventional positive electrode active material. In addition, a change in the volume in the case where the positive electrode active materials having the same number of cobalt atoms are compared is reduced. Thus, the crystal structure of the positive electrode active material particle 100 is less likely to break even when charging that makes x be 0.24 or less and discharging are repeated. Accordingly, the positive electrode active material particle 100 inhibits a decrease in charge and discharge capacity in charge and discharge cycles. Furthermore, the positive electrode active material particle 100 can stably use a larger amount of lithium than the conventional positive electrode active material and thus enables high discharge capacity per weight and per volume. Thus, with use of the positive electrode active material particle 100, a secondary battery with large discharge capacity per weight and per volume can be manufactured.

Note that the positive electrode active material particle 100 actually has the O3′ type structure in some cases when x in LiₓCoO₂ is greater than or equal to 0.15 and less than or equal to 0.24, and is assumed to have the O3′ type structure even when x is greater than 0.24 and less than or equal to 0.27. However, the crystal structure is influenced by not only x in LiₓCoO₂ but also the number of charge-discharge cycles, a charge current and a discharge current, temperature, an electrolyte, and the like, so that the range of x is not limited to the above.

Hence, when x in LiₓCoO₂ in the positive electrode active material particle 100 is greater than 0.1 and less than or equal to 0.24, not all of the inner portion 100b of the positive electrode active material particle 100 necessarily has the O3′ type crystal structure. Some of the particles may have another crystal structure or be amorphous.

The additive element A does not necessarily have similar concentration gradients throughout the surface portion 100a of the positive electrode active material particle 100. For example, the distribution of the additive element A at the surface having a (001) orientation may be different from that at other surfaces. For example, concentration peaks of one or more selected from the additive element X and the additive element Y may be distributed shallower from the surface having a (001) orientation and the surface portion 100a thereof than from a surface having an orientation other than a (001) orientation. Alternatively, the surface having a (001) orientation and the surface portion 100a thereof may have a lower concentration of one or more selected from the additive element X and the additive element Y than a surface having an orientation other than a (001) orientation. Further alternatively, at the surface having a (001) orientation and the surface portion 100a thereof, the concentration of one or more selected from the additive element X and the additive element Y may be below the lower detection limit.

### <Analysis Method>

Whether or not a positive electrode active material has the O3′ type structure when x in LiₓCoO₂ is small can be determined by analyzing a positive electrode including the positive electrode active material particles with small x in LiₓCoO₂ by XRD, electron diffraction, neutron diffraction, electron spin resonance (ESR), nuclear magnetic resonance (NMR), or the like.

### <Charge Method>

Whether or not a composite oxide has the O3′ type structure when x in LiₓCoO₂ is small can be determined by charging a CR2032 coin cell (with a diameter of 20 mm and a height of 3.2 mm) that is formed using the composite oxide for a positive electrode and a lithium metal for a counter electrode, for example. The coin cell includes an electrolyte solution, a separator, a positive electrode can, and a negative electrode can.

More specifically, a positive electrode can be formed by application of a slurry in which the positive electrode active material particles, a conductive material, and a binder are mixed to a positive electrode current collector made of aluminum foil.

A lithium metal can be used for a counter electrode. Note that when the counter electrode is formed using a material other than the lithium metal, the value of the voltage of a secondary battery differs from the value of the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) at a volume ratio of 3:7 and vinylene carbonate (VC) at 2 wt % are mixed can be used.

As a separator, a 25-μm-thick polypropylene porous film can be used.

Stainless steel (SUS) can be used for a positive electrode can and a negative electrode can.

The coin cell formed under the above conditions is charged at a given voltage (e.g., 4.60 V). The charging method is not particularly limited as long as charging with a given voltage can be performed for sufficient time. In the case of CCCV charge, for example, CC charge can be performed with a current higher than or equal to 20 mA/g and lower than or equal to 100 mA/g, and CV charge can be ended with a current higher than or equal to 2 mA/g and lower than or equal to 10 mA/g. To observe a phase change of the positive electrode active material particles, charging with such a small current value is preferably performed. The temperature is set to 25° C. or 45° C. After the charging is performed in this manner, the coin cell is disassembled in a glove box with an argon atmosphere to take out the positive electrode, whereby the positive electrode active material particles with predetermined charge capacity can be obtained. In order to inhibit a reaction with components in the external environment, the taken positive electrode active material particle is preferably enclosed in an argon atmosphere for various analyses to be performed later. For example, XRD can be performed on the positive electrode active material particle enclosed in an airtight container with an argon atmosphere. After the charging is completed, the positive electrode is preferably taken out immediately and analyzed. Specifically, the positive electrode is preferably analyzed within an hour after the completion of the charging, further preferably 30 minutes after the completion of the charging.

In the case where the crystal structure in a charged state after multiple-time charge and discharge is analyzed, the charge and discharge can be performed in the following manner. As charge, constant current charge is performed with a current value greater than or equal to 20 mA/g and less than or equal to 100 mA/g until the voltage reaches a given value (e.g., 4.60 V), and then constant voltage charge is performed until the current value becomes greater than or equal to 2 mA/g and less than or equal to 10 mA/g; as discharge, constant current discharge is performed with a current value greater than or equal to 20 mA/g and less than or equal to 100 mA/g until the voltage reaches 2.5 V. Alternatively, as discharge, constant current discharging can be performed with a current value greater than or equal to 20 mA/g and less than or equal to 200 mA/until the voltages reaches 3.0 V.

Also in the case where the crystal structure in a discharged state after multiple-time charge and discharge is analyzed, constant current discharge can be performed with a current value greater than or equal to 20 mA/g and less than or equal to 200 mA/g until the voltage reaches 2.5 V, for example. Alternatively, constant current discharge can be performed with a current value greater than or equal to 20 mA/g and less than or equal to 200 mA/g until the voltage reaches 3.0 V.

### <XRD>

The apparatus and conditions adopted in the XRD measurement are not particularly limited. The measurement can be performed with the apparatus and conditions as described below, for example.
XRD apparatus: D8 ADVANCE by Bruker AXS
X-ray: Cu Kα₁ radiation
Output: 40 kV, 40 mA
Slit width: Div. Slit, 0.5°
Detector: LynxEye
Scanning method: 2θ/θ continuous scan
Measurement range (2θ): from 15° to 90°
Step width (2θ): 0.01°
Counting time: one sec/step
Rotation of sample stage: 15 rpm

In the case where the measurement sample is a powder, the sample can be set by, for example, being put in a glass sample holder or being sprinkled on a reflection-free silicon plate to which grease is applied. In the case where the measurement sample is a positive electrode, the positive electrode can be set by being bonded to a substrate with a double-sided adhesive tape such that the position of the positive electrode active material layer and the measurement plane required by the apparatus are aligned.

FIG. 6 and FIG. 7 show ideal powder XRD patterns with CuKα₁ radiation that are calculated from models of the O3′ type structure and the H1-3 type structure. For comparison, ideal XRD patterns calculated from the crystal structure of LiCoO₂ (O3) with x in LiₓCoO₂ of 1 and the trigonal O1 type structure with x of 0 are also shown. Note that the patterns of LiCoO₂ (O3) and CoO₂ (O1) are made from crystal structure data obtained from ICSD with Reflex Powder Diffraction, which is a module of Materials Studio (BIOVIA). The 2θ range is from 15° to 75°, the step size is 0.01, the wavelength λ1 is 1.540562×10⁻¹⁰ m, the wavelength λ2 is not set, and a single monochromator is used. XRD patterns of the H1-3 type structure are made from crystal structure data of the H1-3 type structure shown in FIG. 5 in a manner similar to the above-described method. The O3′ type structure was estimated from the XRD pattern of the positive electrode active material particles of one embodiment of the present invention, the crystal structure was fitted with TOPAS Version 3 (crystal structure analysis software produced by Bruker Corporation), and the XRD pattern of the O3′ type structure was made in a similar manner to other structures.

As shown in FIG. 6, the O3′ type structure exhibits diffraction peaks at 2θ of 19.25±0.12° (greater than or equal to 19.13° and less than or equal to 19.37°) and 2θ of 45.47±0.10° (greater than or equal to 45.37° and less than or equal to 45.57°).

However, as shown in FIG. 7, the H1-3 type structure and the trigonal O1 type structure do not exhibit peaks at these positions. Thus, the diffraction peaks at 2θ of 19.25±0.12° (greater than or equal to 19.13° and less than or equal to 19.37° and 2θ of 45.47±0.10° (greater than or equal to 45.37° and less than or equal to 45.57°) in a state where x in LiₓCoO₂ is small can be the features of the positive electrode active material particle 100 of one embodiment of the present invention.

It can be said that, the position of an XRD diffraction peak exhibited by the crystal structure with x of 1 is close to that of an XRD diffraction peak exhibited by the crystal structure with x of 0.24 or less. More specifically, it can be said that in the 2θ range of 42° to 46°, a difference in 2θ between the main diffraction peak exhibited by the crystal structure with x of 1 and the main diffraction peak exhibited by the crystal structure with x of 0.24 or less is 0.7° or less, preferably 0.5° or less.

Although the positive electrode active material particle 100 of one embodiment of the present invention preferably has the O3′ type structure when x in LiₓCoO₂ is small, not all the particles necessarily have the O3′ type structure. Some of the particles may have another crystal structure or be amorphous. For example, when the XRD patterns are subjected to the Rietveld analysis, the O3′ type structure preferably accounts for higher than or equal to 5%, further preferably higher than or equal to 10%.

### <XPS>

In an inorganic oxide, a region to a depth of approximately 2 nm to 8 nm (normally, 5 nm or less) from the surface can be analyzed by X-ray photoelectron spectroscopy (XPS) using monochromatic aluminum Kα radiation as an X-ray; thus, the concentrations of elements in approximately half the depth of the surface portion 100a can be quantitatively analyzed by XPS. The bonding states of the elements can be analyzed by narrow scanning. The quantitative accuracy of XPS is about ±1 atomic % in many cases. The lower detection limit is approximately 1 atomic % but depends on the element.

It is preferable that the concentration of one or more additive elements selected from the surface portion 100a, which is measured by XPS or the like, be higher than the average concentration of the additive elements in the entirety of positive electrode active material particles 100, which is measured by inductively coupled plasma mass spectrometry (ICP-MS), glow discharge mass spectrometry (GD-MS), or the like.

Note that the surface and the surface portion 100a of the positive electrode active material particle 100 of one embodiment of the present invention do not contain a carbonate, a hydroxy group, or the like which is chemically adsorbed after formation of the positive electrode active material particle 100. Furthermore, an electrolyte solution, a binder, a conductive material, and a compound originating from any of these that are attached to the surface of the positive electrode active material particle 100 are not contained either. Thus, in quantitative analysis of the elements contained in the positive electrode active material particles 100, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample such as the positive electrode active material particles 100 and a positive electrode active material layer may be washed, for example, to eliminate an electrolyte solution, a binder, a conductive material, and a compound originating from any of these that are attached to the surfaces of the positive electrode active material particles 100. Although lithium might be dissolved into a solvent or the like used in the washing at this time, the additive element is not easily dissolved even in that case; thus, the atomic ratio of the additive element is not affected.

The concentration of the additive element may be compared using the ratio of the additive element to cobalt. The use of the ratio of the additive element to cobalt is preferable because it enables comparison while reducing the influence of a carbonate or the like which is chemically adsorbed after formation of the positive electrode active material particle 100. For example, the atomic ratio of magnesium to cobalt (Mg/Co) in the XPS analysis is preferably greater than or equal to 0.400 and less than or equal to 1.20, further preferably greater than or equal to 0.400 and less than or equal to 1.00, still further preferably greater than or equal to 0.400 and less than or equal to 1.00, yet still further preferably greater than or equal to 0.400 and less than or equal to 0.900, yet still further preferably greater than or equal to 0.400 and less than or equal to 0.700.

For example, the atomic ratio of nickel to cobalt (Ni/Co) in the XPS analysis is preferably greater than or equal to 0.050 and less than or equal to 0.200, further preferably greater than or equal to 0.050 and less than or equal to 0.150, still further preferably greater than or equal to 0.050 and less than or equal to 0.100, yet still further preferably greater than or equal to 0.500 and less than or equal to 0.070.

For example, the atomic ratio of fluorine to magnesium (F/Mg) in the XPS analysis is preferably greater than or equal to 0.100 and less than or equal to 1.00, further preferably greater than or equal to 0.100 and less than or equal to 0.800, still further preferably greater than or equal to 0.100 and less than or equal to 0.500, yet still further preferably greater than or equal to 0.100 and less than or equal to 0.300, yet still further preferably greater than or equal to 0.100 and less than or equal to 0.200.

When the ratio is within the above range, it can be said that the additive element is not attached to the surface of the positive electrode active material particle 100 in a narrow range but widely distributed at a preferable concentration in the surface portion 100a of the positive electrode active material particle 100. That is, when the ratios are within the above ranges in the XPS analysis results of the positive electrode active material particles 100, the crystal structure is less likely to be broken even when charging that makes x be 0.24 or less and discharging are repeated, so that excellent cycle performance can be achieved. In addition, lithium can be inserted and extracted favorably in/from the positive electrode active material particle 100, and excellent rate characteristics can be achieved.

In the XPS analysis, monochromatic aluminum Ko radiation can be used as an X-ray, for example. Furthermore, an XPS apparatus enabling energy resolution such that the half width of Ag3d5/2 peak (112 eV) is 1.0 eV±0.1 eV in an XPS spectrum of an Ag sample may be used. An extraction angle is, for example, 45°. For example, the measurement can be performed using the following XPS apparatus and conditions.
Measurement apparatus: Quantera II by PHI, Inc.
X-ray: monochromatic Al Kα (1486.6 eV)
Energy resolution: 1.0 eV±0.1 eV as the half width of the Ag3d5/2 peak
Detection area: 100 μmϕ
Detection depth: approximately 4 nm to 5 nm (extraction angle 45°), approximately 2 nm (extraction angle 15°)
Measurement spectrum: wide scan, narrow scan of each detected element

Furthermore, when the positive electrode active material particles 100 of one embodiment of the present invention is analyzed by XPS, a peak indicating the binding energy of magnesium with another element (Mg1s peak) is preferably at higher than or equal to 1303.0 eV and lower than 1305.0 eV, further preferably approximately 1304.0 eV. This value is different from the binding energy of magnesium fluoride (1306.0 eV) and is close to that of magnesium oxide.

In the XPS analysis of the positive electrode active material particles 100 of one embodiment of the present invention, the measured XPS spectrum is preferably corrected such that the C1s peak is aligned with the reference value (284.8 eV), i.e., the whole XPS spectrum is preferably shifted. Thus, the influence of a mechanical difference, a difference in measurement conditions, or the like of the XPS apparatus on XPS measurement can be reduced.

When the Mg1s peak is analyzed in the XPS analysis of the positive electrode active material particles 100 of one embodiment of the present invention for analysis of the proportions of peak components derived from an O—Mg—O bond, an O—Mg—F bond, and a F—Mg—F bond, the peak component derived from the O—Mg—F bond is preferably lower than the detection limit. Note that the peak component derived from the O—Mg—O bond may be contained. Furthermore, the peak component derived from the F—Mg—F bond may also be contained, but the proportion thereof is preferably lower than or equal to 10% of that of the total peak components, further preferably lower than the detection limit thereof.

Thus, when the proportions of the peak components derived from the O—Mg—O bond, the O—Mg—F bond, and the F—Mg—F bond is analyzed in the XPS analysis of the positive electrode active material particles 100 of one embodiment of the present invention, the proportion of the peak component derived from the O—Mg—O bond is preferably higher than or equal to 70%, further preferably higher than or equal to 80%, still further preferably higher than or equal to 90%, particularly preferably 100%.

An analysis method of the Mg1s peak on an XPS spectrum in XPS analysis is described. Assuming that the peak component derived from the O—Mg—O bond is a fit peak 1, that from the O—Mg—F bond is a fit peak 2, and that from the F—Mg—F bond is a fit peak 3 in the analysis of the Mg1s peak, it is preferable to calculate a ratio of these three fit peaks synthesized so that a difference from the Mg1s peak on the XPS spectrum obtained by the XPS analysis is the smallest. The analysis results can be output on the assumption that the area ratio of the fit peak 1, the fit peak 2, and the fit peak 3 in this calculation is the existence ratio of the O—Mg—O bond, the O—Mg—F bond, and the F—Mg—F bond.

Note that in the analysis method of the XPS spectrum, for an energy value (Ep1) at the maximum value (also referred to as a peak top) of the fit peak 1, the energy value at the maximum value of the Mg1s peak separately measured using a standard sample of LiCoO₂ coated with MgO can be referred to. For an energy value (Ep3) at the maximum value of the fit peak 3, the energy value at the maximum value of the Mg1s peak separately measured using a standard sample of magnesium fluoride (MgF₂) (e.g., MGH18XB with purity of 99.9% (3N) up produced by Kojundo Chemical Laboratory Co., Ltd.) can be referred to. An energy value (Ep2) at the maximum value of the fit peak 2 can be an intermediate value between Ep1 and Ep3. Moreover, Ep1 is positioned on the lower energy side than Ep3. Note that the energy value at the maximum peak value is also referred to as a peak position.

In the XPS analysis of the positive electrode active material particles 100 of one embodiment of the present invention, it can be found from the peak position and the half width of the peak that the analysis results of the Mg1s peak is within the above preferable range. For example, the half width of the Mg1s peak is preferably greater than or equal to 1.0 CV and less than or equal to 3.0 eV, further preferably greater than or equal to 1.0 eV and less than or equal to 2.8 cV, and particularly preferably greater than or equal to 1.0 eV and less than or equal to 2.6 cV. In the above, the peak position of the Mg1s peak is on the lower energy side than the energy value at the maximum value of the Mg1s peak measured separately using the standard sample of magnesium fluoride.

### <EDX>

One or more selected from the additive elements contained in the positive electrode active material particle 100 preferably have a concentration gradient. It is further preferable that the additive elements contained in the positive electrode active material particle 100 exhibit concentration peaks at different depths from the surface. The concentration gradient of the additive element can be evaluated by exposing a cross section of the positive electrode active material particle 100 using a focus ion beam (FIB) or the like and analyzing the cross section using EDX, electron probe microanalysis (EPMA), or the like.

EDX measurement for evaluating an area two-dimensionally while the area is being scanned is referred to as EDX area analysis. The measurement by line scan, which is performed to evaluate the atomic concentration distribution in the positive electrode active material particle 100, is referred to as line analysis. Furthermore, extracting data of a linear region from EDX area analysis is referred to as EDX line analysis in some cases. The measurement of a region without scanning is referred to as point analysis.

By EDX area analysis (e.g., element mapping), the concentrations of the additive element in the surface portion 100a, the inner portion 100b, the vicinity of the crystal grain boundary, and the like of the positive electrode active material particle 100 can be quantitatively analyzed. By EDX line analysis, the concentration distribution and the highest concentration of the additive element can be analyzed. An analysis method in which a thinned sample is used, such as STEM-EDX, is preferable because the method makes it possible to analyze the concentration distribution in the depth direction from the surface toward the center in a specific region of the positive electrode active material particle 100 regardless of the distribution in the front-back direction.

Since the positive electrode active material particle 100 is a compound containing oxygen and a transition metal into and from which lithium can be inserted and extracted, an interface between a region where oxygen and the transition metal M (Co, Ni, Mn, Fe, or the like) that is oxidized or reduced due to insertion and extraction of lithium exist and a region where oxygen and the transition metal M do not exist is considered as the surface of the positive electrode active material particle 100.

In STEM-EDX line analysis or the like, it is sometimes difficult to precisely determine the surface because a steep change in the detected amount of the characteristic X-ray of an element is not seen in principle or due to a measurement error. Accordingly, when STEM-EDX line analysis or the like in the depth direction is described, the reference point is a point where the detected amount of the characteristic X-ray of the transition metal M is equal to 50% of the sum of the average value M_{AVE} of the detected amounts of the characteristic X-ray of the transition metal M in the inner portion and the average value M_{BG} of the detected amounts of the characteristic X-ray of the transition metal M of the background or a point where the detected amount of the characteristic X-ray of oxygen is equal to 50% of the sum of the average value O_{AVE} of the detected amounts of the characteristic X-ray of oxygen in the inner portion and the average value O_{BG} of the detected amounts of the characteristic X-ray of oxygen of the background. Note that when the position of the point where the detected amount of the characteristic X-ray of the transition metal M is equal to 50% of the sum of the average value of the detected amounts of the characteristic X-ray of the transition metal M in the inner portion and the average value of the detected amounts of the characteristic X-ray of the transition metal M of the background is different from the position of the point where the detected amount of the characteristic X-ray of oxygen is equal to 50% of the sum of the average value of the detected amounts of the characteristic X-ray of oxygen in the inner portion and the average value of the detected amounts of the characteristic X-ray of oxygen of the background, the difference is probably due to the influence of a carbonate, a metal oxide containing oxygen, or the like, which is attached to the surface. Thus, in such a case, the point where the detected amount of the characteristic X-ray of the transition metal M is equal to 50% of the sum of the average value M_{AVE} of the detected amounts of the characteristic X-ray of the transition metal M in the inner portion and the average value M_{BG} of the detected amounts of the characteristic X-ray of the transition metal M of the background can be employed as the reference point. In the case of the positive electrode active material particle 100 containing a plurality of the transition metals M, the reference point can be determined using M_{AVE} and M_{BG} of the transition metal element whose detected amount of the characteristic X-ray in the inner portion is larger than that of any other element.

The average value M_{BG} of the detected amounts of the characteristic X-ray of the transition metal M of the background can be calculated by averaging the detected amounts in the range outside a portion of the positive electrode active material particle 100 in the vicinity of the portion at which the detected amount of the characteristic X-ray of the transition metal M begins to increase, for example. Note that the detected range is greater than or equal to 2 nm, preferably greater than or equal to 3 nm. The average value M_{AVE} of the detected amounts of the characteristic X-ray of the transition metal M in the inner portion can be calculated by averaging the detected amounts in the range greater than or equal to 2 nm, preferably greater than or equal to 3 nm at the depth at which the detected amounts of the characteristic X-ray of the transition metal M and oxygen are saturated and stabilized, e.g., at a depth larger than, by greater than or equal to 30 nm, preferably greater than 50 nm, the depth at which the detected amount of the characteristic X-ray of the transition metal M begins to increase. The average value O_{BG} of the detected amounts of the characteristic X-ray of oxygen of the background and the average value O_{AVE} of the detected amounts of the characteristic X-ray of oxygen in the inner portion can be calculated in a similar manner.

The surface of the positive electrode active material particle 100 in, for example, a cross-sectional STEM image is a boundary between a region where an image derived from the crystal structure of the positive electrode active material particle 100 is observed and a region where the image is not observed. The surface of the positive electrode active material particle 100 is also determined as the outermost surface of a region where an atomic column derived from an atomic nucleus of, among metal elements which constitute the positive electrode active material particle 100, a metal element that has a larger atomic number than lithium is observed in the cross-sectional STEM image.

A peak in STEM-EDX line analysis refers to the local maximum value of a projecting shape appearing in the graph of the characteristic X-ray intensity of each element or the maximum value of the characteristic X-ray of each element. As a noise in STEM-EDX line analysis, a measured value having a half width smaller than or equal to spatial resolution (R), for example, smaller than or equal to R/2 can be given.

The adverse effect of a noise can be reduced by scanning the same portion a plurality of times under the same conditions. For example, an integrated value obtained by performing scanning two times can be used as the detected value of each element. The number of scanning is not limited to two and an average of integrated values obtained by performing scanning three or more times can be used as the detected value of each element.

STEM-EDX line analysis can be performed as follows, for example. First, a protective film is deposited by evaporation over the surface of the positive electrode active material particle 100. For example, carbon can be deposited by evaporation with an ion sputtering apparatus (MC1000, produced by Hitachi High-Tech Corporation).

Next, the positive electrode active material particle 100 is thinned to fabricate a cross-section sample to be subjected to STEM analysis. For example, the positive electrode active material particle can be thinned with an FIB-SEM apparatus (XVision 200TBS, produced by Hitachi High-Tech Corporation). Here, picking up can be performed by a micro probing system (MPS), and the acceleration voltage at final processing can be, for example, 10 kV.

The STEM-EDX line analysis can be performed using, for example, a STEM apparatus (HD-2700, Hitachi High-Tech Corporation) and Octane T Ultra W (EDAX Inc) as an EDX detector. As one example of conditions for the EDX line analysis using HD-2700 by Hitachi High-Tech Corporation, the emission current of the STEM apparatus is set to be within the range of 6 μA to 10 μA, and a portion of the thinned sample, which is not positioned at a deep level and has little unevenness, is measured. The magnification is approximately 150,000 times, for example. The EDX line analysis can be performed under conditions where drift correction is performed, the line width is 42 nm, the pitch is 0.2 nm, and the number of frames is 6 or more.

To increase the spatial resolution in STEM-EDX line analysis, the beam diameter of an electron beam (also referred to as a beam diameter or a probe diameter) is preferably small. The beam diameter in STEM-EDX line analysis is preferably less than or equal to 0.3 nm, further preferably less than or equal to 0.2 nm, still further preferably less than or equal to 0.1 nm. To increase the analysis sensitivity in STEM-EDX line analysis, a beam current of an electron beam (also referred to as a probe current) is preferably increased. That is, the apparatus used for STEM-EDX line analysis preferably includes a spherical aberration corrector (Cs collector) that can make a beam diameter small and increase a beam current.

When the positive electrode active material particle 100 contains magnesium and fluorine as the additive elements, the distribution of fluorine preferably includes a region that overlaps with the distribution of magnesium. For example, a difference in the depth direction between a peak of the concentration or detected amount of fluorine and a peak of the concentration or detected amount of magnesium is preferably within 10 nm, further preferably within 3 nm, still further preferably within 1 nm, yet still further preferably within 0.5 nm.

In the positive electrode active material particle 100 containing nickel as the additive element, a peak of the concentration or detected amount of nickel in the surface portion 100a is preferably present in a region to a depth of less than 3 nm from the surface of the positive electrode active material particle 100 or a reference point toward the center, further preferably present in a region to a depth of less than 1 nm from the surface of the positive electrode active material particle 100 or a reference point toward the center. When the positive electrode active material particle 100 contains magnesium and nickel, the distribution of nickel preferably includes a region that overlaps with the distribution of magnesium. For example, a difference in the depth direction between a peak of the concentration or detected amount of nickel and a peak of the concentration or detected amount of magnesium is preferably within 3 nm, further preferably within 1 nm.

In the case where the positive electrode active material particle 100 contains aluminum as the additive element, in the EDX line analysis, the peak of the concentration or detected amount of magnesium, nickel, or fluorine is preferably located closer to the surface than the peak of the concentration or detected amount of aluminum in the surface portion 100a. In other words, the peak of the concentration or detected amount of aluminum in the surface portion 100a is preferably located closer to the inner portion side than the peak of the concentration or detected amount of magnesium, nickel, or fluorine. For example, the peak of the concentration or detected amount of aluminum is preferably present at a depth of greater than or equal to 0.5 nm and less than or equal to 50 nm, further preferably greater than or equal to 5 nm and less than or equal to 50 nm, toward the center from the surface of the positive electrode active material particle 100 or a reference point.

In this specification and the like, unless otherwise specified, the concentration of an element in the EDX analysis is calculated using the sum of carbon, oxygen, fluorine, magnesium, aluminum, silicon, phosphorus, sulfur, calcium, titanium, iron, cobalt, nickel, and gallium as a denominator.

### <EPMA>

The concentration of the additive element contained in the positive electrode active material particle 100 can be analyzed using EPMA as well as using EDX. EPMA has higher detection capability (in other words, the lower detection limit is lower) in the analysis element a slight amount of which exists in a sample than EDX. Thus, EPMA is preferably used when a region containing a slight amount of the additive element is analyzed.

In the EPMA analysis, a cross section of the positive electrode active material particle 100 is exposed by mechanical polishing, ion polishing, FIB, or the like, and its cross section is analyzed. As an apparatus for the EPMA, an electron probe microanalyzer, JXA-iHP200F (by JEOL Ltd.), can be used, for example. For example, the measurement conditions can be an acceleration voltage of 10 kV, a beam diameter of approximately 3 μmϕ, and an incident beam current of 50 nA, and the kinds of analyzing crystals can be C (LDE2H), O (LDE1L), Mg (TAPL), Co (LiFH), Ni (TAPL), F (TAPL), Al (TAPL), and Ti (LiFH).

Using a wavelength-dispersive detector, EPMA has higher capability of detecting a slight quantity of elements than EDX using an energy-dispersive detector. In contrast, the spatial resolution in the EPMA analysis is inferior to that in EDX (in particular, STEM-EDX). Thus, STEM-EDX is suitable for analysis focusing on the detailed distribution of the additive elements in the surface portion 100a of the positive electrode active material particle 100, and EPMA is suitable for analysis of a slight amount of the additive elements in the inner portion 100b. Note that since EPMA and EDX have a difference in analyzing ways, the values of the concentrations obtained by the respective methods even when the region analyzed is the same in the both methods are not the same in some cases.

### <LA-ICP-MS>

The concentration of the additive element contained in the positive electrode active material particles 100 can also be analyzed by LA-ICP-MS (laser ablation ICP mass spectrometry). The LA-ICP-MS is capable of local analysis and thus is suitable for analysis of the concentration of the additive element only in the inner portion, not including the surface portion.

The contents in this embodiment can be freely combined with the contents in any of the other embodiments.

### Embodiment 2

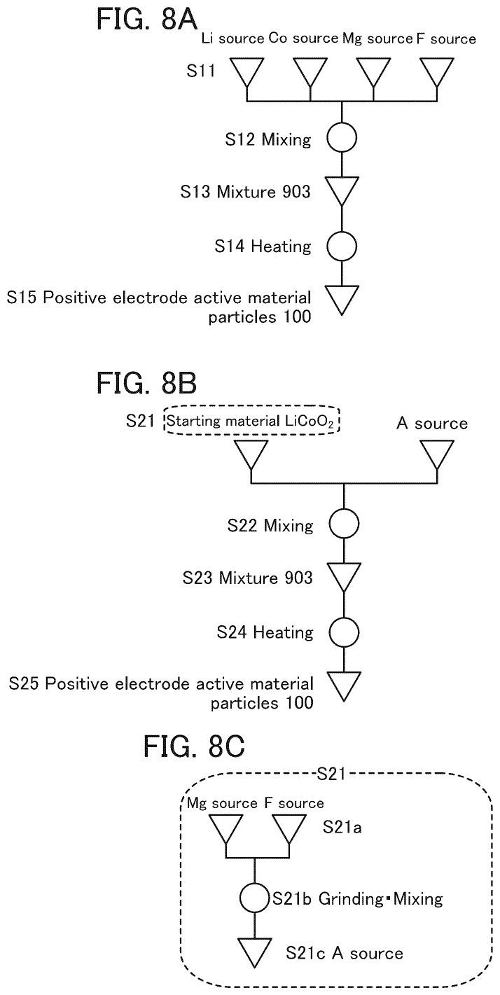

In this embodiment, methods for forming the positive electrode active material particles 100 of one embodiment of the present invention will be described with reference to FIGS. 8A to 8C, FIG. 9, and FIGS. 10A and 10B.

Heating conditions are important in forming the positive electrode active material particles 100. The lower limit of the heating temperature is a temperature at which reaction of starting materials occurs. The temperature at which reaction of starting materials occurs is the temperature at which interdiffusion of elements contained in the starting materials occurs, and may be lower than the melting temperatures of the starting materials. It is known that in the case of an oxide as an example, solid phase diffusion occurs at the Tamman temperature T_{d} that is 0.757 times the melting temperature Tₘ. Thus, the heating temperature is preferably higher than or equal to 650° C., for example.

It is preferable that a sufficient heating time be provided in order to obtain the above-described distribution of the additive element. The heating time is preferably longer than 100 hours, further preferably longer than 100 hours and shorter than or equal to 150 hours, for example. The heating may be performed in a plurality of steps; in this case, the total time of heating at 650° C. is preferably within the above range. For example, the total time of heating during which the heating temperature of the furnace is set to higher than or equal to 650° C. is preferably within the above range. Note that the time for lowering the temperature after the heating is preferably longer than or equal to 10 hours and shorter than or equal to 50 hours, for example.

### <<Formation Method 1 of Positive Electrode Active Material Particles 100>>

Formation method 1 of the positive electrode active material particles 100 is described with reference to FIG. 8A. Here, magnesium and fluorine are used as the additive elements.

### <Step S11>

In Step S11 shown in FIG. 8A, a lithium source (Li source), a cobalt source (Co source), a magnesium source (Mg source), and a fluorine source (F source) are prepared as starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used, and for example, tricobalt tetraoxide or cobalt hydroxide can be used.

As the magnesium source, magnesium fluoride, magnesium oxide, magnesium hydroxide, magnesium carbonate, or the like can be used. Two or more of these magnesium sources may be used.

As the fluorine source, for example, lithium fluoride (LiF), magnesium fluoride (MgF₂), aluminum fluoride (AlF₃), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C.

### <Step S12 and Step S13>

Next, the lithium source, the cobalt source, the magnesium source, and the fluorine source are ground and mixed (Step S12), whereby a mixture 903 is formed (Step S13). The grinding and mixing can be performed by a dry method or a wet method. A wet method enables finer grinding and mixing of particles. In the case of a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the cobalt source be mixed into dehydrated acetone whose moisture content is less than or equal to 10 ppm and which has a purity higher than or equal to 99.5% for the grinding and mixing. With use of dehydrated acetone with the above-described purity, impurities that might be mixed can be reduced.

A ball mill, a bead mill, or the like can be used for the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the grinding and mixing are performed at a peripheral speed of 838 mm/s (the number of rotations: 400 rpm, the ball mill diameter: 40 mm).

### <Step S14>

Next, as Step S14, the mixture 903 is heated. As described above, the total time of heating at higher than or equal to 650° C. is preferably longer than 100 hours.

### <Step S15>

Next, the material heated is collected in Step S15 to obtain the positive electrode active material particles 100. At this time, the collected particles can be crushed by being made to pass through a sieve as needed. Through the above process, the positive electrode active material particles 100 of one embodiment of the present invention can be formed.

### <<Formation Method 2 of Positive Electrode Active Material Particles 100>>

Formation method 2 of the positive electrode active material particles 100 is described with reference to FIG. 8B. Here, unlike in Formation method 1, lithium cobalt oxide functioning as both of a lithium source and a cobalt source is used as a starting material.

### <Step S21>

In Step S21 shown in FIG. 8B, lithium cobalt oxide, a magnesium source, and a fluorine source are prepared. The magnesium source and the fluorine source are collectively referred to as an A source. For the magnesium source and the fluorine source, the description of Step S11 can be referred to.

The magnesium source and the fluorine source may be added to lithium cobalt oxide separately. Alternatively, as shown in Step S21a to Step S21c in FIG. 8C, the magnesium source and the fluorine source may be mixed first and then added to the lithium cobalt oxide.

### <Step S22 and Step S23>

Next, the lithium cobalt oxide, the magnesium source, and the fluorine source are ground and mixed (Step S22), whereby the mixture 903 is formed (Step S23). For the grinding and mixing, the description of Step S12 can be referred to.

### <Step S24>

Next, as Step S24, the mixture 903 is heated. As described above, the total time of heating at higher than or equal to 650° C. is preferably longer than 100 hours.

In addition, the reaction more easily proceeds at a temperature higher than or equal to the temperature at which one or more selected from the materials contained in the mixture 903 are melted. For example, in the case where LiF and MgF₂ are used as the additive element sources, the lower limit of the heating temperature in Step S33 is preferably higher than or equal to 742° C. because the eutectic point of LiF and MgF₂ is around 742° C.

The mixture obtained by mixing LiCoO₂, LiF, and MgF₂ in a molar ratio of LiCoO₂:LiF:MgF₂=100:0.33:1 has an initial melting temperature Tᵢₘ at 779° C., a melting peak temperature Tₚₘ at 815° C., and a melting end temperature Tₑₘ at 826° C. in differential scanning calorimetry (DSC measurement). Thus, the lower limit of the heating temperature is further preferably higher than or equal to 826° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of the lithium cobalt oxide might be decomposed. In addition, at the time of heating the mixture 903, the partial pressure of fluorine or a fluoride originating from the fluorine source or the like is preferably controlled to be within an appropriate range. When the temperature is too high, the fluoride is reduced by evaporation. For example, the vapor pressure of the lithium fluoride increases rapidly from 900° C. Thus, the heating temperature is preferably lower than or equal to 1000° C., further preferably lower than or equal to 950° C., still further preferably lower than or equal to 900° C.

In view of the above, the heating temperature in Step S24 is preferably higher than or equal to 650° C. and lower than or equal to 1130° C., further preferably higher than or equal to 650° C. and lower than or equal to 1000° C., still further preferably higher than or equal to 650° C. and lower than or equal to 950° C., yet still further preferably higher than or equal to 650° C. and lower than or equal to 900° C. Furthermore, the heating temperature in Step S24 is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature in Step S24 is preferably higher than or equal to 826° C. and lower than or equal to 1100° C., further preferably higher than or equal to 826° C. and lower than or equal to 1130° C., still further preferably higher than or equal to 826° C. and lower than or equal to 1000° C., yet still further preferably higher than or equal to 826° C. and lower than or equal to 950° C., yet still further preferably higher than or equal to 826° C. and lower than or equal to 920° C.

### <Step S25>

Next, the material heated is collected in Step S25 to obtain the positive electrode active material particles 100. At this time, the collected particles can be crushed by being made to pass through a sieve as needed. Through the above process, the positive electrode active material particles 100 of one embodiment of the present invention can be formed.

### <<Formation Method 3 of Positive Electrode Active Material Particles 100>>

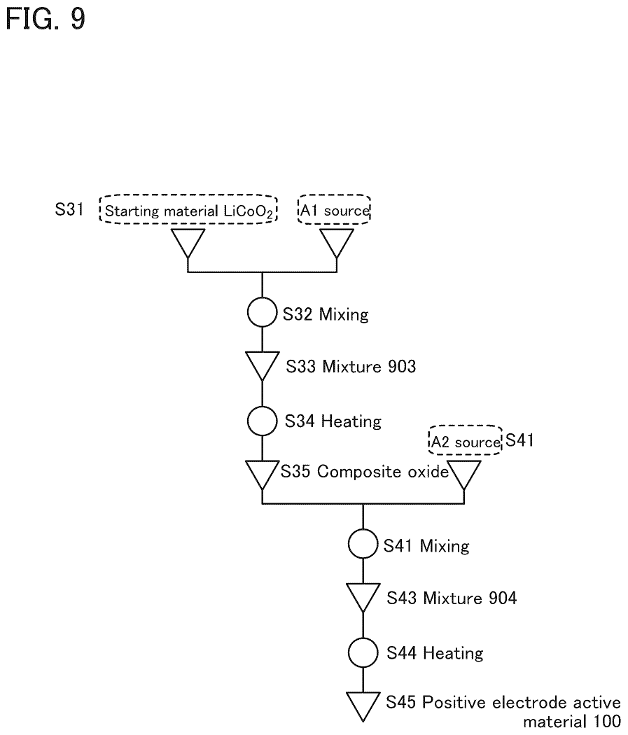

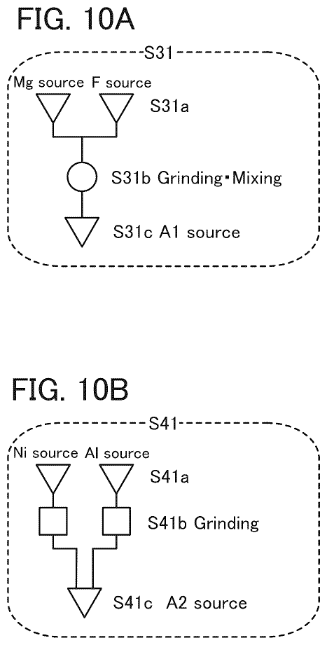

Formation method 3 of the positive electrode active material particles 100 is described with reference to FIG. 9 and FIGS. 10A and 10B. Unlike in Formation method 2, nickel and aluminum are used as the additive elements in addition to magnesium and fluorine, the additive elements are added in a plurality of steps and heating is performed a plurality of times.

### <Step S31>

In Step S31 shown in FIG. 9, lithium cobalt oxide functioning as both of a lithium source and a cobalt source is prepared, and an A1 source is prepared as the additive element source.

As an additive element A1, the additive element described in the above embodiment, e.g., one or more selected from magnesium, fluorine, nickel, aluminum, zirconium, vanadium, iron, manganese, chromium, niobium, arsenic, zinc, silicon, sulfur, phosphorus, boron, and calcium can be used. Furthermore, one or both of bromine and beryllium can be used.

A method for forming the A1 source in the case where magnesium and fluorine are used as the additive elements A1 is described with reference to FIG. 10A.

### <Step S31a>

In Step S31a shown in FIG. 10A, first, a magnesium source and a fluorine source are prepared. For the magnesium source and the fluorine source, the description of Step S11 can be referred to.

### <Step S31b>

Next, in Step S31b, the magnesium source and the fluorine source are ground and mixed. Any of the conditions for the grinding and mixing that are described for Step S12 can be selected to perform Step S31b.

### <Step S31b>

Next, in Step S31b, the materials ground and mixed in the above step are collected to obtain the additive element A1 source (A1 source).

### <Step S32 to Step S35>

Next, mixing and heating are performed in a manner similar to that in Step S22 to Step S25, whereby a composite oxide is obtained.

### <Step S41>

Next, in Step S41, an A2 source is prepared as the additive element source. As an additive element A2, the additive element described in the above embodiment, e.g., one or more selected from magnesium, fluorine, nickel, aluminum, zirconium, vanadium, iron, manganese, chromium, niobium, arsenic, zinc, silicon, sulfur, phosphorus, boron, and calcium can be used. Furthermore, one or both of bromine and beryllium can be used. Note that the additive element A2 is preferably an element that is not used as the additive element A1.

A method for forming the A2 source in the case where nickel and aluminum are used as the additive elements A2 is described with reference to FIG. 10B.

As the nickel source, nickel hydroxide, nickel fluoride, or the like can be used. As the aluminum source, aluminum hydroxide, aluminum fluoride, or the like can be used.

The number of nickel atoms contained in the second additive element source (the A2 source) is preferably greater than or equal to 0.05% and less than or equal to 4.0%, further preferably greater than or equal to 0.20% and less than or equal to 2.0%, still further preferably greater than or equal to 0.20% and less than or equal to 1.0% with respect to the number of cobalt atoms contained in the lithium cobalt oxide. For example, in the case of using nickel hydroxide as the nickel source, the number of moles of nickel hydroxide contained in the second additive element source is preferably greater than or equal to 0.05 and less than or equal to 4.0 (higher than or equal to 0.05 mol % and lower than or equal to 4.0 mol %), further preferably greater than or equal to 0.20 and less than or equal to 2.0 (higher than or equal to 0.20 mol % and lower than or equal to 2.0 mol %), still further preferably greater than or equal to 0.20 and less than or equal to 1.0 (higher than or equal to 0.20 mol % and lower than or equal to 1.0 mol %) with the number of moles of the lithium cobalt oxide in Step S10 assumed as 100.

The number of aluminum atoms contained in the second additive element source (the A2 source) is preferably greater than or equal to 0.05% and less than or equal to 4.0%, further preferably greater than or equal to 0.20% and less than or equal to 2.0%, still further preferably greater than or equal to 0.20% and less than or equal to 1.0% with respect to the number of cobalt atoms contained in the lithium cobalt oxide. For example, in the case of using aluminum hydroxide as the aluminum source, the number of moles of aluminum hydroxide contained in the second additive element source is preferably greater than or equal to 0.05 and less than or equal to 4.0 (higher than or equal to 0.05 mol % and lower than or equal to 4.0 mol %), further preferably greater than or equal to 0.20 and less than or equal to 2.0 (higher than or equal to 0.20 mol % and lower than or equal to 2.0 mol %), still further preferably greater than or equal to 0.20 and less than or equal to 1.0 (higher than or equal to 0.20 mol % and lower than or equal to 1.0 mol %) with the number of moles of the lithium cobalt oxide in Step S10 assumed as 100.

As illustrated in FIG. 10B, it is preferable that a nickel source (Ni source) and an aluminum source (A1 source) be prepared in Step S41b and ground in Step S42a. As a result, the additive element source (the A2 source) can be obtained in Step S43. The description of Step S31b can be referred to for the conditions of grinding.

### <Step S41 to Step S54>

Next, mixing and heating are performed in a manner similar to that in Step S22 to Step S25, whereby the positive electrode active material particles 100 are obtained.

In Formation method 3 of the positive electrode active material particles 100, the sum of the heating time in Step S34 and the heating time in Step S44 is preferably longer than 100 hours, further preferably longer than 100 hours and shorter than or equal to 150 hours. For the heating temperature, the description of Formation method 2 of the positive electrode active material particles 100 can be referred to.

The contents in this embodiment can be freely combined with the contents in any of the other embodiments.

### Embodiment 3

In this embodiment, structures of a lithium-ion secondary battery are described.

### [Positive Electrode]

A positive electrode includes a positive electrode active material layer and a positive electrode current collector. The positive electrode active material layer includes positive electrode active material particles and may further include at least one of a conductive additive and a binder. The positive electrode active material particles described in the above embodiments can be used.

### <Positive Electrode Active Material>

As the positive electrode active material, the positive electrode active material particles 100 described in above embodiments and a different positive electrode active material may be mixed and used.

Examples of the different positive electrode active material mentioned above include a composite oxide with an olivine crystal structure, a composite oxide with a layered rock-salt crystal structure, and a composite oxide with a spinel crystal structure. For example, a compound such as LiFePO₄, LiFeO₂, LiCoO₂, LiNiO₂, LiMn₂O₂, LiNiₐMn_{b}Co_{c}O₂ (a+b+c=1), LiMn₂O₄, V₂O₅, Cr₂O₅, or MnO₂ can be given.

### <Conductive Additive>

A conductive additive is also referred to as a conductivity-imparting agent or a conductive material, and a carbon material can be used as the conductive additive. A conductive additive is attached between a plurality of active materials, whereby the plurality of active materials are electrically connected to each other, and the conductivity increases. Note that in this specification and the like, the term “attach” refers not only to a state where an active material and a conductive additive are physically in close contact with each other, and includes, for example, the following concepts: the case where covalent bonding occurs, the case where bonding with the Van der Waals force occurs, the case where a conductive additive covers part of the surface of an active material, the case where a conductive additive is embedded in surface roughness of an active material, and the case where an active material and a conductive additive are electrically connected to each other without being in contact with each other.

Specific examples of carbon materials that can be used as the conductive additive include carbon black (e.g., furnace black, acetylene black, or graphite). Graphene, multi graphene, graphene oxide, and/or reduced graphene oxide can also be used.

In addition, the use of a mixture of graphene and acetylene black enables fast charging, which is preferable. The use of such a mixed conductive additive for lithium-ion secondary batteries for vehicles is particularly effective.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer can be used, for example. Alternatively, fluorine rubber can be used.

As the binder, for example, water-soluble polymers are preferably used. As the water-soluble polymer, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Graphene, multi graphene, graphene oxide, and/or reduced graphene oxide can function not only as a conductive additive but also as a binder.

Two or more of the above materials may be used in combination for the binder.

### <Positive Electrode Current Collector>

For the current collector, a material that has high conductivity, such as a metal like iron, gold, platinum, aluminum, or titanium, or an alloy containing any of these metals, such as stainless steel, can be used. It is preferable that a material used for the positive electrode current collector not be dissolved at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer includes a negative electrode active material and may further include a conductive additive and a binder.

### <Negative Electrode Active Material>

As the negative electrode active material, for example, an alloy-based material and/or a carbon material can be used.

As the carbon material used as the negative electrode active material, one or more selected from graphite, graphitizing carbon (soft carbon), non-graphitizing carbon (hard carbon), carbon fiber (carbon nanotube), graphene, a graphene compound carbon black, and the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into the graphite (while a lithium-graphite intercalation compound is generated). For this reason, a lithium-ion secondary battery using graphite can have a high operating voltage. In addition, graphite is preferable because of its advantages such as a relatively high capacity per unit volume, relatively small volume expansion, low cost, and a higher level of safety than that of lithium metal.

As the negative electrode active material, an element that enables charge and discharge reactions by alloying and dealloying reactions with lithium can be used. For example, one or more materials selected from silicon, tin, gallium, aluminum, germanium, lead, antimony, bismuth, silver, zinc, cadmium, indium, and the like can be used. Such elements have higher capacity than carbon, and especially, silicon has a high theoretical capacity of 4200 mAh/g. Alternatively, a compound containing any of the above elements may be used. Examples of the compound include titanium silicide, titanium silicon oxide, SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium and a compound containing the element, for example, are referred to as alloy-based materials in some cases. An alloy-based material such as silicon is preferable as the negative electrode active material of a secondary battery for low-temperature use because a decrease in charge and discharge capacity at low temperatures is sometimes inhibited as compared with graphite.

In this specification and the like, “SiO” refers, for example, to silicon monoxide. SiO can alternatively be expressed as SiOₓ. Here, it is preferable that x be 1 or have an approximate value of 1. For example, x is preferably greater than or equal to 0.2 and less than or equal to 1.5, further preferably greater than or equal to 0.3 and less than or equal to 1.2.

A material used in formation of the graphene compound may be mixed with the graphene compound to be used for an active material layer. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The median diameter (D50) of the particles is preferably less than or equal to 1 μm, further preferably less than or equal to 100 nm.

A silicon particle covered with a graphene compound may be used as the negative electrode active material. In that case, it is preferable that a space for relieving a structural change be provided between the graphene compound and the silicon particle.

Alternatively, as the negative electrode active material, one or more oxides selected from titanium dioxide (TiO₂), lithium titanium oxide (Li₄Ti₅O₁₂), a lithium-graphite intercalation compound (LiₓC₆), niobium pentoxide (Nb₂O₅), tungsten dioxide (WO₂), and molybdenum dioxide (MoO₂) can be used.

Still alternatively, as the negative electrode active material, Li₃₋ₓMₓN (M=Co, Ni, or Cu) with a Li₃N structure, which is nitride of lithium and a transition metal, can be used. For example, Li_{2.6}Co_{0.4}N is preferable because of its high discharge capacity (900 mAh/g and 1890 mAh/cm³).

A nitride of lithium and a transition metal is preferably used, in which case lithium ions are contained in the negative electrode active material and thus the negative electrode active material can be used in combination with a material for the positive electrode active material which does not contain lithium ions, such as V₂O₅ or Cr₃O₈. Note that in the case of using a material containing lithium ions as the positive electrode active material, the nitride of lithium and a transition metal can be used as the negative electrode active material by extracting the lithium ions contained in the positive electrode active material in advance.

A material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

A combination of two or more of the above negative electrode active materials may be used; for example, a negative electrode active material in which graphite and silicon particles are mixed may be used. The silicon particles refer to silicon powders that are the negative electrode active material of the lithium-ion secondary battery, and the average diameter of the particle size distribution, i.e., the average particle diameter is around 100 nm; the silicon particles are referred to as nanosilicon particles in some cases. In order to obtain silicon particles to be used, it is preferable that a silicon source be ground and particle diameters be adjusted to be uniform. The silicon particles may contain at least one of silicon, silicon oxide, and silicon alloy. The silicon particles can contain at least one of silicon, silicon oxide, and silicon alloy. Although laser diffraction particle size distribution measurement can be typically used for measurement of a particle size, the measurement is not limited thereto. A major diameter of a particle cross section may be measured by analysis using a scanning electron microscope (SEM), a transmission electron microscope (TEM), or the like.

For the conductive additive and the binder that can be contained in the negative electrode active material layer, materials similar to those for the conductive additive and the binder that can be contained in the positive electrode active material layer can be used.

### <Negative Electrode Current Collector>

For the negative electrode current collector, copper or the like can be used in addition to a material similar to that of the positive electrode current collector. Note that a material that does not alloy with carrier ions of lithium or the like is preferably used for the negative electrode current collector.

### [Electrolyte Solution]

The electrolyte solution contains an organic solvent; the organic solvent of the electrolyte of one embodiment of the present invention is not limited to a liquid at 25° C. and may be a solid at 25° C. or a semi-solid at normal temperature. Note that the organic solvent of the electrolyte of one embodiment of the present invention is preferably a liquid in a wide temperature range from temperatures below freezing to high temperatures; however, the present invention is not limited thereto. The organic solvent may be a liquid, a solid, or a semi-solid in a wide temperature range from temperatures below freezing to high temperatures.

As an organic solvent, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), 1,3-propanesultone (PS), fluoroethylene carbonate (FEC), methyl 3,3,3-trifluoropropionate (MTFP), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

PS has a HOMO level and a LUMO level equivalent to those of EC and DEC; thus, PS is less likely to be oxidized and reduced even at a high cut-off voltage, and is likely to be a high molecule when decomposed on the surface of the positive electrode active material particle. Accordingly, PS is advantageous in that it is unlikely to be gasified by becoming a decomposition product with a small molecular weight. Thus, the electrolyte solution preferably contains PS at higher than or equal to 0.1 wt % and lower than or equal to 10 wt %, further preferably higher than or equal to 0.25 wt % and lower than or equal to 7.5 wt %.

FEC, which is one of cyclic carbonates, has a high dielectric constant and thus has an effect of promoting dissociation of a lithium salt when used in an organic solvent. Meanwhile, because FEC includes a substituent with an electron-withdrawing property, a lithium ion is desolvated with FEC more easily than with EC. Specifically, the solvation energy of a lithium ion is lower in FEC than in EC not including a substituent with an electron-withdrawing property. Thus, lithium ions are likely to be extracted from surfaces of a positive electrode active material particle and a negative electrode active material, which can reduce an internal resistance of a secondary battery. In addition, FEC has a deep highest occupied molecular orbital (HOMO) level and is thus not easily oxidized, meaning high oxidation resistance. On the other hand, FEC disadvantageously has high viscosity. In view of this, a mixed organic solvent containing not only FEC but also MTFP is preferably used for the electrolyte solution. MTFP, which is one of linear carbonates, can have an effect of reducing the viscosity of an electrolyte solution or maintaining the viscosity at room temperature (typically, 25° C.) even at low temperatures (typically, 0° C.). Furthermore, while the solvation energy is lower in MTFP than in methyl propionate (abbreviation: MP) not including a substituent with an electron-withdrawing property, MTFP may solvate a lithium ion when used for the electrolyte solution. In the case of using a mixed organic solvent containing both FEC and MTFP, y in the volume ratio FEC:MTFP=1:y is preferably greater than or equal to 2 and less than or equal to 20, further preferably greater than or equal to 4 and less than or equal to 9.

Alternatively, the use of one or more kinds of ionic liquids (room temperature molten salts) that are unlikely to burn and volatize as the solvent of the electrolyte solution can prevent a power storage device from exploding and catching fire even when the power storage device internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate)borate (LiB(C₂O₄)₂, LiBOB) can be used, or two or more of these lithium salts can be used in an appropriate combination in an appropriate ratio.

The electrolyte solution can contain an additive agent. An additive agent can inhibit a decomposition reaction of an electrolyte which might occur on a positive electrode surface or a negative electrode surface when a secondary battery operates at a high voltage and/or high temperatures. As the additive agent, for example, propane sultone (PS), vinylene carbonate (VC), tert-butylbenzene (TBB), lithium bis(oxalate)borate (LiBOB), 1,3,6-hexanetricarbonitrile, ethyl 2-methylbutyrate, ethyl 2-methylvalerate, or propyl 2-methylbutyrate is preferably used. As the additive agent, PS is particularly preferable because it improves the cycle performance.

As the additive agent, one or more, or two or more kinds of dinitrile compounds can be used. Specific examples of the dinitrile compound include succinonitrile, glutaronitrile, adiponitrile (ADN), and ethylene glycol bis(propionitrile) ether (EGBE).

Furthermore, fluorobenzene may be added to the above organic solvent. The concentration of the additive agent in the whole electrolyte solution is, for example, higher than or equal to 0.1 wt % and lower than or equal to 5 wt %. PS or EGBE is preferable because it forms a favorable coating film on a positive electrode at the time of charge and discharge, which improves the cycle performance. Fluorobenzene (FB) is preferable because it improves the wettability of the organic solvent with respect to the positive electrode and the negative electrode. The dinitrile compound is preferable because its nitrile groups are oriented to the positive electrode and the negative electrode and oxidative decomposition of the organic solvent is hindered, whereby resistance against a high voltage can be increased. Furthermore, the dinitrile compound is preferable because it can prevent dissolution of copper used in the current collector of the negative electrode at the time of overdischarging. Considering the usage of the secondary battery at a high voltage, a nitrile compound is preferably added.

The electrolyte solution used for the power storage device is preferably a highly-purified electrolyte solution with only a small amount of dust particles and elements other than the constituent elements of the electrolyte solution (hereinafter also simply referred to as impurities). Specifically, the weight ratio of impurities to the electrolyte solution is preferably less than or equal to 1%, further preferably less than or equal to 0.1%, still further preferably less than or equal to 0.01%.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. For example, a polymer having a polyalkylene oxide structure, such as polyethylene oxide (PEO), PVDF, polyacrylonitrile, or a copolymer containing any of them can be used. For example, PVDF-HFP, which is a copolymer of PVDF and hexafluoropropylene (HFP), can be used. The formed polymer may be porous.

In addition, as the electrolyte solution, a solid electrolyte containing an inorganic material such as a sulfide-based or oxide-based inorganic material, or a solid electrolyte containing a high molecular material such as a polyethylene oxide (PEO)-based polymer material can be used. When the solid electrolyte is used, a separator or a spacer is not necessary. Furthermore, the battery can be entirely solidified; thus, there is no risk of liquid leakage and thus the safety of the battery is dramatically improved.

### [Separator]

When the electrolyte (also referred to as electrolyte solution) includes a liquid electrolyte, a separator is placed between the positive electrode and the negative electrode. As a separator, for example, a fiber containing cellulose such as paper; nonwoven fabric; a glass fiber; ceramics; a synthetic fiber using nylon (polyamide), vinylon (polyvinyl alcohol-based fiber), polypropylene (referred to as PP), polyimide (referred to as PI), polyester, acrylic, polyolefin, or polyurethane; or the like can be used. The separator can have a porosity in thickness higher than or equal to 35% and lower than or equal to 90%, preferably higher than or equal to 60% and lower than or equal to 85%. A separator using polypropylene can have a porosity higher than or equal to 35% and lower than or equal to 45%. A separator using polyimide can have a porosity higher than or equal to 75% and lower than or equal to 85%. The thickness of the separator is preferably greater than or equal to 10 μm and less than or equal to 80 μm, further preferably greater than or equal to 20 μm and less than or equal to 60 μm. The separator using polyimide is preferable because it can have a high porosity and can have a large thickness (typically, a thickness greater than or equal to 50 μm and less than or equal to 60 μm).

The separator is preferably processed into a bag-like shape to wrap one of the positive electrode and the negative electrode.

The separator may have a multilayer structure. For example, an organic material film of polypropylene, polyethylene, or the like can be coated with a ceramics-based material, a fluorine-based material, a polyamide-based material, a mixture thereof, or the like. Examples of the ceramics-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

The use of a separator having a multilayer structure makes it possible to maintain the safety of the lithium-ion battery even when the total thickness of the separator is small, so that the discharge capacity per volume of the lithium-ion battery can be increased.

### [Exterior Body]

For an exterior body included in the lithium-ion battery, a metal material such as aluminum or a resin material can be used, for example. A film-like exterior body can also be used. As a film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

This embodiment can be implemented in appropriate combination with any of the other embodiments.

### Embodiment 4

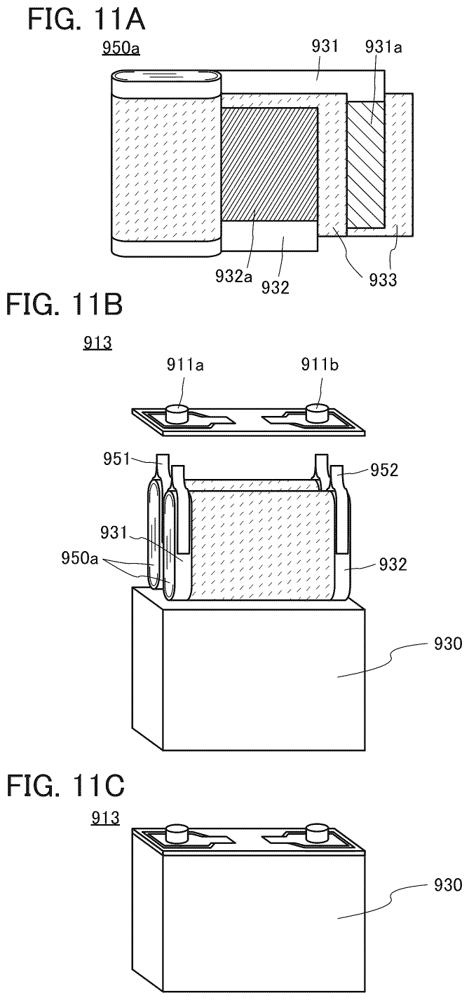

In this embodiment, embodiment examples of a lithium-ion secondary battery will be described with reference to FIGS. 11A to 11C.

FIG. 11A illustrates a wound body 950a included in a lithium-ion secondary battery 913, FIG. 11B is an exploded perspective view of the lithium-ion secondary battery 913, and FIG. 11C is an external view of the lithium-ion secondary battery 913. The lithium-ion secondary battery 913 includes a positive electrode 932 including the positive electrode active material described in the above embodiments, a negative electrode 931, an electrolyte layer, and a separator 933, and the negative electrode 931 includes a negative electrode active material layer 931a. The positive electrode 932 includes a positive electrode active material layer 932a. They are wound as illustrated in FIG. 11A.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 11B, the negative electrode 931 is electrically connected to a terminal 951. The terminal 951 is electrically connected to a terminal 911a. The positive electrode 932 is electrically connected to a terminal 952. The terminal 952 is electrically connected to a terminal 911b.

As illustrated in FIG. 11C, the wound body 950a is covered with a housing 930, whereby the lithium-ion secondary battery 913 is completed. The housing 930 is preferably provided with a safety valve, an overcurrent protection element, and the like. A safety valve is a valve to be released by a predetermined internal pressure of the housing 930 in order to prevent the battery from exploding.

As illustrated in FIG. 11B, the lithium-ion secondary battery 913 may include a plurality of the wound bodies 950a. The use of the plurality of wound bodies 950a enables the lithium-ion secondary battery 913 to have higher charge and discharge capacities.

By including the positive electrode active material particles of one embodiment of the present invention, the lithium-ion secondary battery 913 including a wound body can have high charge and discharge capacity and excellent cycle performance.

The contents in this embodiment can be combined with any of the contents in the other embodiments as appropriate.

### Embodiment 5

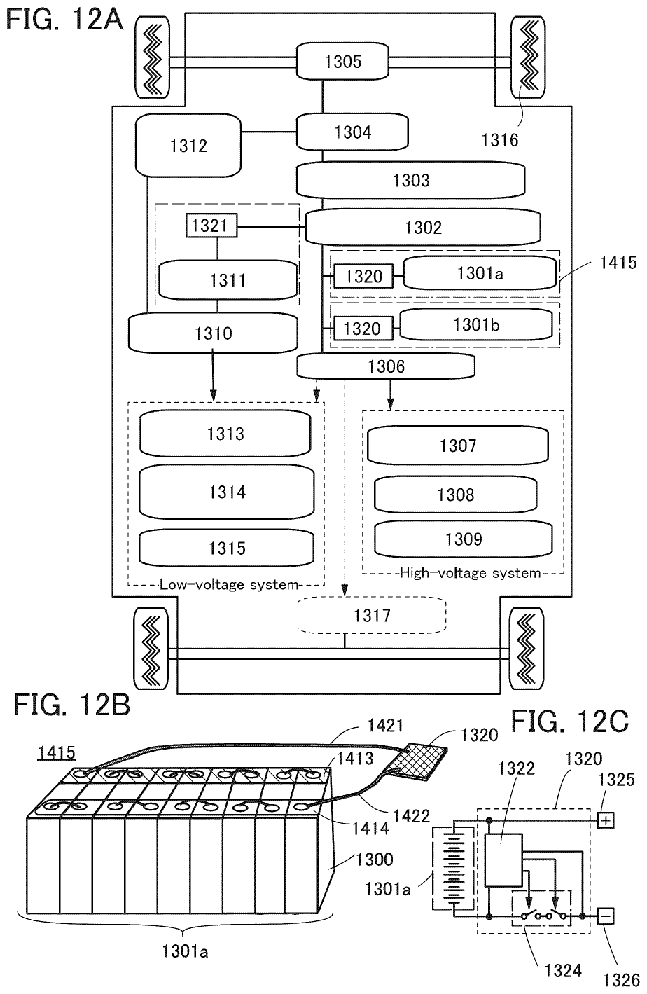

In this embodiment, an example of application to an electric vehicle (EV) will be described with reference to FIGS. 12A to 12C.

As illustrated in FIG. 12A, the electric vehicle is provided with first batteries 1301a and 1301b as main lithium-ion secondary batteries for driving and a second battery 1311 that supplies electric power to an inverter 1312 for starting a motor 1304. By including the positive electrode active material particles of one embodiment of the present invention, the first batteries 1301a and 1301b can each be a lithium-ion secondary battery with high charge and discharge capacity and excellent cycle performance.

The second battery 1311 is also referred to as a cranking battery (also referred to as a starter battery). The second battery 1311 only needs high output and does not necessarily have high capacity, and the capacity of the second battery 1311 is lower than that of the first batteries 1301a and 1301b.

The internal structure of the first battery 1301a may be a wound structure or a stacked-layer structure. A lithium-ion secondary battery including the positive electrode active material particles of one embodiment of the present invention may be used as the first battery 1301a. When a lithium-ion secondary battery including the positive electrode active material particles of one embodiment of the present invention is used as the first battery 1301a, a high-mileage electric vehicle capable of being used in a wide environmental temperature range can be obtained.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of lithium-ion secondary batteries, large electric power can be extracted. The plurality of lithium-ion secondary batteries may be connected in parallel, connected in series, or connected in series after being connected in parallel. The plurality of lithium-ion secondary batteries are also referred to as an assembled battery.

In order to cut off electric power from the plurality of lithium-ion secondary batteries, the lithium-ion secondary batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DCDC circuit 1310.

The first battery 1301a is described with reference to FIG. 12B.

FIG. 12B illustrates an example in which nine rectangular lithium-ion secondary batteries 1300 form one battery pack 1415. The nine rectangular lithium-ion secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the lithium-ion secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of lithium-ion secondary batteries are preferably fixed by the fixing portions 1413 and 1414 and a battery container box, for example. Furthermore, the one electrode each battery is electrically connected to a control circuit portion 1320 through a wiring 1421. The other electrode of each battery is electrically connected to the control circuit portion 1320 through a wiring 1422.

FIG. 12C illustrates an example of a block diagram of the battery pack 1415 illustrated in FIG. 12B.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the lithium-ion secondary battery to be used, and imposes the upper limit of current from the outside, the upper limit of output current to the outside, and the like. The range from the lower limit voltage to the upper limit voltage of the lithium-ion secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 senses a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The first batteries 1301a and 1301b mainly supply electric power to in-vehicle parts for 42 V (for a high-voltage system), and the second battery 1311 supplies electric power to in-vehicle parts for 14 V (for a low-voltage system). Lead storage batteries are usually used for the second battery 1311 due to cost advantage. There is an advantage that the second battery 1311 can be maintenance-free when a lithium-ion secondary battery is used; however, in the case of long-term use, for example three years or more, anomaly that cannot be determined at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

Although this embodiment describes an example in which lithium-ion secondary batteries are used as both the first battery 1301a and the second battery 1311, a lead storage battery, an all-solid-state battery, or an electric double layer capacitor may be used as the second battery 1311. By including the positive electrode active material particles of one embodiment of the present invention, the above-described lithium-ion secondary battery can have high charge and discharge capacity and excellent cycle performance.

Regenerative energy generated by rolling of tires 1316 is transmitted to the motor 1304 through a gear 1305, and is stored in the second battery 1311 through a motor controller 1303, a battery controller 1302, and a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge performance of a lithium-ion secondary battery used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or the connection cable of the charger is sometimes provided with a control circuit. The control circuit portion 1320 is also referred to as an electronic control unit (ECU). The ECU is connected to a controller area network (CAN) provided in the electric vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, or a three-phase 200V outlet (50 kW), for example. Furthermore, charging can be performed with electric power supplied from external charging equipment by a contactless power feeding method or the like.

Next, examples in which the lithium-ion secondary battery of one embodiment of the present invention is mounted on a vehicle, typically a transport vehicle, will be described.

Mounting the lithium-ion secondary battery on vehicles can achieve next-generation clean energy vehicles such as hybrid vehicles (HVs), electric vehicles (EVs), and plug-in hybrid vehicles (PHVs). The lithium-ion secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft.

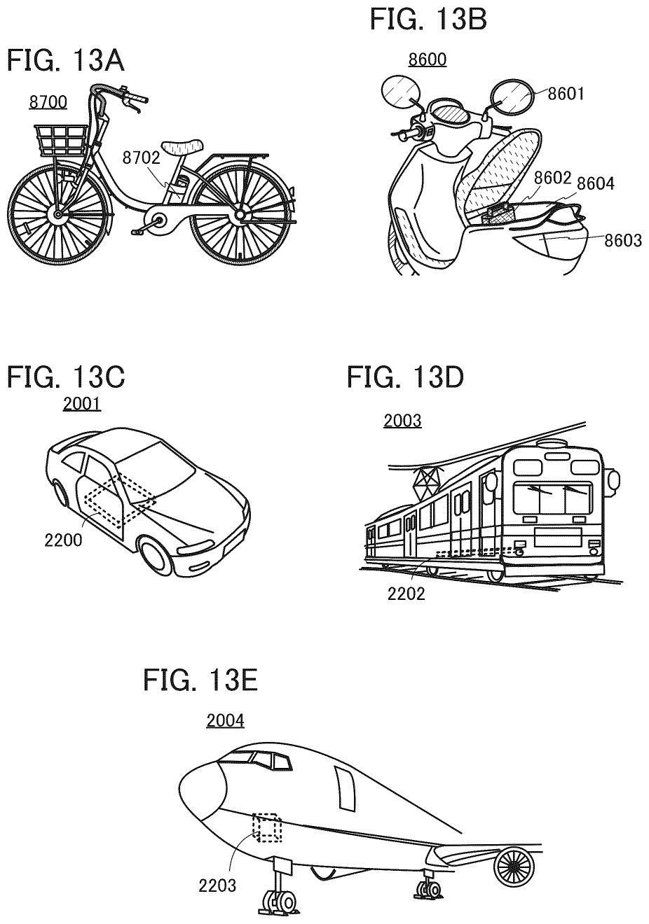

FIGS. 13A to 13E illustrate examples of vehicles and the like each including the lithium-ion secondary battery of one embodiment of the present invention.

FIG. 13A illustrates an example of an electric bicycle using the lithium-ion secondary battery of one embodiment of the present invention. The lithium-ion secondary battery of one embodiment of the present invention can be used for an electric bicycle 8700 illustrated in FIG. 13A. The lithium-ion secondary battery of one embodiment of the present invention may include a protection circuit.

The electric bicycle 8700 includes a power storage device 8702. The power storage device 8702 can supply electricity to a motor that assists a rider. The power storage device 8702 can be taken off from the electric bicycle 8700 and carried. A plurality of lithium-ion secondary batteries of one embodiment of the present invention are incorporated in the power storage device 8702, and the remaining battery capacity and the like can be displayed on a display portion. By including the positive electrode active material particles of one embodiment of the present invention, the secondary batteries can have high charge and discharge capacity and excellent cycle performance.

FIG. 13B illustrates an example of a motorcycle including the lithium-ion secondary battery of one embodiment of the present invention. A motor scooter 8600 illustrated in FIG. 13B includes a power storage device 8602, side mirrors 8601, and indicator lights 8603. In the motor scooter 8600, the power storage device 8602 can be held in a storage unit under seat 8604. The power storage device 8602 can supply electricity to the indicator lights 8603. In the case where the motor is included in the motor scooter, the power storage device 8602 can also supply electricity to the motor. By including the positive electrode active material particles of one embodiment of the present invention, the secondary battery included in the power storage device 8602 can have high charge and discharge capacity and excellent cycle performance.

An automobile 2001 illustrated in FIG. 13C is an electric vehicle that runs on the power of an electric motor. Alternatively, the automobile 2001 is a hybrid vehicle capable of driving using either an electric motor or an engine as appropriate. In the case where the lithium-ion secondary battery is mounted on the vehicle, an example of the lithium-ion secondary battery described in the above embodiments is provided at one position or several positions. By including the positive electrode active material particles of one embodiment of the present invention, the secondary battery mounted on the vehicle can have high charge and discharge capacity and excellent cycle performance.

The automobile 2001 illustrated in FIG. 13C includes a battery pack 2200, and the battery pack includes a battery module in which a plurality of lithium-ion secondary batteries are connected to each other. The battery pack 2200 preferably further includes a charge control device that is electrically connected to the battery module.

The automobile 2001 can be charged when the lithium-ion secondary battery included in the automobile 2001 is supplied with electric power from external charge equipment by a plug-in system, a contactless charge system, or the like. In charging, a given method such as CHAdeMO (registered trademark) or Combined Charging System can be employed as a charge method, the standard of a connector, or the like as appropriate. As the external charging equipment, a charging station provided in a commerce facility, a power source in a house, and the like can be given. For example, with use of the plug-in technique, the power storage device mounted on the automobile 2001 can be charged by being supplied with electric power from the outside. Charging can be performed by converting AC power into DC power through a converter such as an ACDC converter.

Although not illustrated, the vehicle may be provided with a power receiving device so that it can be charged by being supplied with electric power from an above-ground power transmitting device in a contactless manner. In the case of the contactless power feeding system, by fitting a power transmitting device in a road or an exterior wall, charging can be performed not only when the electric vehicle is stopped but also when driven. In addition, the contactless power feeding system may be utilized to perform transmission and reception of electric power between two vehicles. Furthermore, a solar cell may be provided in the exterior of the vehicle to charge the lithium-ion secondary battery while the vehicle is stopped or while the vehicle is moving. To supply electric power in such a contactless manner, an electromagnetic induction method or a magnetic resonance method can be used.

FIG. 13D illustrates a large transport vehicle 2003 having a motor controlled by electricity as an example. A battery module of the transport vehicle 2003 has 100 or more lithium-ion secondary batteries with a nominal voltage of 3.0 V or higher and 5.0 V or lower connected in series to have a maximum voltage of 600 V. A battery pack 2202 has the same function as that in FIG. 13C except, for example, the number of lithium-ion secondary batteries configuring the battery module; thus, the description is omitted. By including the positive electrode active material particles of one embodiment of the present invention, the secondary batteries included in the module can have high charge and discharge capacity and excellent cycle performance.

FIG. 13E illustrates an aircraft 2004 having a combustion engine as an example. The aircraft 2004 can also be regarded as a kind of transport vehicle because it has wheels for takeoff and landing, and includes a battery pack 2203 that includes a charge control device and a battery module configured by connecting a plurality of lithium-ion secondary batteries.

The battery module of the aircraft 2004 includes, for example, eight 4-V lithium-ion secondary batteries that are connected in series to have a maximum voltage of 32 V. The battery pack 2203 has the same function as that in FIG. 13C except, for example, the number of lithium-ion secondary batteries configuring the battery module; thus, the description is omitted.

The contents in this embodiment can be combined with any of the contents in the other embodiments as appropriate.

### Embodiment 6

In this embodiment, examples of electronic devices each including the lithium-ion secondary battery of one embodiment of the present invention will be described. Examples of electronic devices including the lithium-ion secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

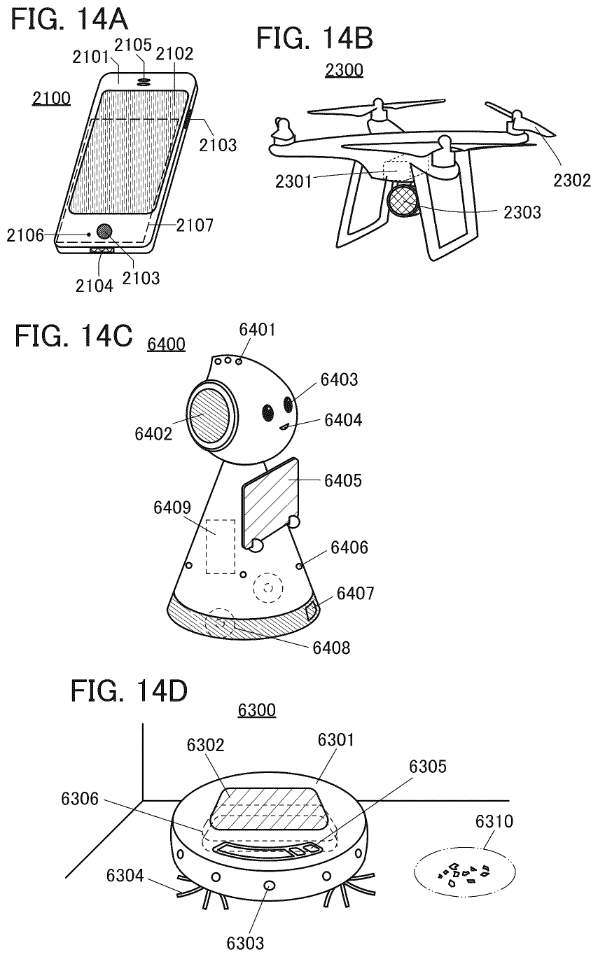

FIG. 14A illustrates an example of a mobile phone. A mobile phone 2100 includes a display portion 2102 set in a housing 2101, operation buttons 2103, an external connection port 2104, a speaker 2105, a microphone 2106, and the like. The mobile phone 2100 includes a lithium-ion secondary battery 2107. By including the positive electrode active material particles of one embodiment of the present invention, the secondary battery can have high charge and discharge capacity and excellent cycle performance.

The mobile phone 2100 is capable of executing a variety of applications such as mobile phone calls, e-mailing, text viewing and editing, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication between the mobile phone 2100 and a headset capable of wireless communication enables hands-free calling.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor; a touch sensor; a pressure sensitive sensor; or an acceleration sensor is preferably mounted, for example.

FIG. 14B illustrates an unmanned aircraft 2300 including a plurality of rotors 2302. The unmanned aircraft 2300 is sometimes also referred to as a drone. The unmanned aircraft 2300 includes a lithium-ion secondary battery 2301 of one embodiment of the present invention, a camera 2303, and an antenna (not illustrated). The unmanned aircraft 2300 can be remotely controlled through the antenna. By including the positive electrode active material particles of one embodiment of the present invention, the secondary battery can have high charge and discharge capacity and excellent cycle performance.

FIG. 14C illustrates an example of a robot. A robot 6400 illustrated in FIG. 14C includes a lithium-ion secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of sensing a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect the presence of an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the lithium-ion secondary battery 6409 of one embodiment of the present invention and a semiconductor device or an electronic component. By including the positive electrode active material particles of one embodiment of the present invention, the secondary battery can have high charge and discharge capacity and excellent cycle performance.

FIG. 14D illustrates an example of a cleaning robot. A cleaning robot 6300 includes a display portion 6302 placed on a top surface of a housing 6301, a plurality of cameras 6303 placed on a side surface of the housing 6301, a brush 6304, operation buttons 6305, a lithium-ion secondary battery 6306, a variety of sensors, and the like. Although not illustrated, the cleaning robot 6300 is provided with a tire, an inlet, and the like. The cleaning robot 6300 is self-propelled, senses dust 6310, and sucks up the dust through the inlet provided on a bottom surface.

For example, the cleaning robot 6300 can determine whether there is an obstacle such as a wall, furniture, or a step by analyzing images taken by the cameras 6303. In the case where the cleaning robot 6300 senses an object, such as a wire, that is likely to be caught in the brush 6304 by image analysis, the rotation of the brush 6304 can be stopped. The cleaning robot 6300 includes, in its inner region, the lithium-ion secondary battery 6306 of one embodiment of the present invention and a semiconductor device or an electronic component. By including the positive electrode active material particles of one embodiment of the present invention, the secondary battery can have high charge and discharge capacity and excellent cycle performance.

This embodiment can be implemented in appropriate combination with any of the other embodiments.

### Example

In this example, the positive electrode active material of one embodiment of the present invention was formed and subjected to powder analysis and evaluation of charge and discharge characteristics.

### <Formation of Positive Electrode Active Material>

Samples of a positive electrode active material formed in this example is described with reference to the formation method in FIGS. 8B and 8C. Sample 1 and Sample 2 were formed as positive electrode active material samples under different manufacturing conditions.

### [Sample 1]

As the LiCoO₂ in Step S21 in FIG. 8B, commercially available lithium cobalt oxide (Cellseed C-10N produced by NIPPON CHEMICAL INDUSTRIAL CO., LTD.) not containing any additive element was prepared.

In this example, the A source containing Mg and F serving as the additive elements was formed in accordance with Step S21a to Step S21c shown in FIG. 8C. First, in accordance with Step S21a shown in FIG. 8C, lithium fluoride (LiF) was prepared as the F source, and magnesium fluoride (MgF₂) was prepared as the Mg source. The LiF and MgF₂ were weighed so that LiF:MgF₂=1:3 (molar ratio). Then, the lithium fluoride and magnesium fluoride were mixed into dehydrated acetone and the mixture was stirred at a rotational speed of 500 rpm for 20 hours. In the mixing, a ball mill was used and a grinding medium was zirconium oxide balls. After the mixing, the mixture was made to pass through a sieve with an aperture of 300 μm, whereby the A1 source was obtained.

Next, as Step S22, the lithium cobalt oxide and the A source were weighed such that the number of moles of magnesium fluoride contained in the A source was 1 (1 mol %) with respect to the number of moles of lithium cobalt oxide assumed as 100 and mixed in a ball mill. Stirring was performed at a rotational speed of 150 rpm for an hour. These conditions were milder than those of the stirring in the production of the A source. Finally, the mixture was made to pass through a sieve with an aperture of 300 μm, whereby the mixture 903 having a uniform particle diameter was obtained (Step S23).

Next, as Step S24, the mixture 903 was heated. The mixture 903 was spread over a sagger to have a thickness of approximately 5 mm uniformly and heated with a lid on the sagger. A muffle furnace was used for the heating. The atmosphere in the muffle furnace and the sagger was purged and an oxygen atmosphere was introduced therein, and then entry and exit of a gas into and from the muffle furnace were blocked. The heating temperature was 900° C. and the heating time was 10 hours. By the heating, the positive electrode active material that is a composite oxide containing Mg and F was obtained (Step S25). The positive electrode active material obtained through the above steps was used as Sample 1.

### [Sample 2]

Sample 2 was formed in a manner similar to that of Sample 1 except that the heating temperature was 900° C. and the heating time was 120 hours in Step S24.

### <XPS Analysis Results>

XPS analysis was performed on the particle surfaces of Sample 1 and Sample 2 prepared in the above manner.

The apparatus and conditions used in the XPS measurement were as follows.
Measurement apparatus: Quantera II by ULVAC-PHI, Inc.
X-ray source: monochromatic Al Kα (1486.6 eV)
Detection area: 100 μmϕ
Detection depth (Condition 1): in the range from the surface to a depth of approximately 5 nm (the detector angle 45°)
Detection depth (Condition 2): in the range from the surface to a depth of approximately 2 nm (the detector angle 15°)
Measurement spectrum: wide scan, narrow scan of each detected element

The XPS analysis results are shown in Table 1 and Table 2. Note that in this specification and the like, atomic % is sometimes abbreviated as at %.

TABLE 1

| | Li | Co | O | C | F | S |
|---|---|---|---|---|---|---|
| Sample 1 | 11.3 at % | 14.8 at % | 44.0 at % | 9.3 at % | 7.9 at % | 0.9 at % |
| 45° | | | | | | |
| Sample 1 | 10.2 at % | 12.9 at % | 46.0 at % | 11.1 at % | 7.5 at % | 0.8 at % |
| 15° | | | | | | |
| Sample 2 | 11.1 at % | 16.1 at % | 51.0 at % | 11.0 at % | 1.3 at % | 0.7 at % |
| 45° | | | | | | |
| Sample 2 | 11.5 at % | 14.7 at % | 51.5 at % | 10.0 at % | 1.1 at % | 0.7 at % |
| 15° | | | | | | |
| | Ca | Mg | Na | Zr | Mg/Co | F/Mg |
| Sample 1 | 0.4 at % | 10.8 at % | 0.6 at % | — | 0.73 | 0.73 |
| 45° | | | | | | |
| Sample 1 | 0.4 at % | 10.6 at % | 0.5 at % | — | 0.82 | 0.71 |
| 15° | | | | | | |
| Sample 2 | 0.5 at % | 7.8 at % | 0.6 at % | — | 0.48 | 0.17 |
| 45° | | | | | | |
| Sample 2 | 0.6 at % | 9.4 at % | 0.5 at % | — | 0.64 | 0.12 |
| 15° | | | | | | |

TABLE 2

| | Li | Co | O | C | F | S |
|---|---|---|---|---|---|---|
| Sample 1 | | 16.7 at % | 49.6 at % | 10.5 at % | 8.9 at % | 1.0 at % |
| 45° | | | | | | |
| Sample 1 | | 14.4 at % | 51.2 at % | 12.4 at % | 8.4 at % | 0.9 at % |
| 15° | | | | | | |
| Sample 2 | | 18.1 at % | 57.4 at % | 12.4 at % | 1.5 at % | 0.8 at % |
| 45° | | | | | | |
| Sample 2 | | 16.6 at % | 58.2 at % | 11.3 at % | 1.2 at % | 0.8 at % |
| 15° | | | | | | |
| | Ca | Mg | Na | Zr | Mg/Co | F/Mg |
| Sample 1 | 0.5 at % | 12.2 at % | 0.7 at % | — | 0.73 | 0.73 |
| 45° | | | | | | |
| Sample 1 | 0.4 at % | 11.8 at % | 0.6 at % | — | 0.82 | 0.71 |
| 15° | | | | | | |
| Sample 2 | 0.6 at % | 8.8 at % | 0.7 at % | — | 0.48 | 0.17 |
| 45° | | | | | | |
| Sample 2 | 0.7 at % | 10.6 at % | 0.6 at % | — | 0.64 | 0.12 |
| 15° | | | | | | |

As shown in Table 1 and Table 2, in both Sample 1 and Sample 2, there was no significant difference between the concentration of each element analyzed under Condition 1 with a detector angle of 45° and that analyzed under Condition 2 with a detector angle of 15°.

Table 1 shows the concentrations (at %: atomic concentration, sometimes referred to as atomic %) of lithium (Li), cobalt (Co), oxygen (O), carbon (C), fluorine (F), sulfur(S), calcium (Ca), magnesium (Mg), sodium (Na), and zirconium (Zr) assuming that the total concentration of the elements is 100 at %. Table 1 also shows the ratio of the concentration of magnesium to the concentration of cobalt (Mg/Co) and the ratio of the concentration of fluorine to the concentration of magnesium (F/Mg). Note that “-” in the table indicates that the value was lower than the lower detection limit.

In addition, the concentration of lithium in a positive electrode active material of a lithium-ion secondary battery changes through charge and discharge. Thus, Table 2 shows the concentrations of cobalt (Co), oxygen (O), carbon (C), fluorine (F), sulfur(S), calcium (Ca), magnesium (Mg), sodium (Na), and zirconium (Zr) assuming that the total concentration of the elements is 100 at %, which is calculated by eliminating the values of lithium from the results in Table 1.

As shown in Table 1 and Table 2, the ratio of the number of magnesium atoms to the number of cobalt atoms (Mg/Co) was 0.73 at 45° and 0.82 at 15° in Sample 1. In Sample 2, the ratio of the number of magnesium atoms to the number of cobalt atoms (Mg/Co) was 0.48 at 45° and 0.64 at 15°, which are within the range of greater than or equal to 0.400 and less than or equal to 0.700.

As shown in Table 1 and Table 2, the ratio of the number of fluorine atoms to the number of magnesium atoms (F/Mg) was 0.73 at 45° and 0.71 at 15° in Sample 1. In Sample 2, the ratio of the number of fluorine atoms to the number of magnesium atoms (F/Mg) was 0.17 at 45° and 0.12 at 15°, which are within the range of greater than or equal to 0.100 and less than or equal to 0.200.

Next, in the XPS analysis, the Mg1s peak on the XPS spectrum was focused. Assuming that the peak component derived from the O—Mg—O bond is a fit peak 1, that from the O—Mg—F bond is a fit peak 2, and that from the F—Mg—F bond is a fit peak 3 in the analysis of the Mg1s peak, a ratio of these three fit peaks synthesized was calculated so that a difference from the Mg1s peak on the XPS spectrum obtained by the XPS analysis is the smallest. Table 3 shows the analysis results on the assumption that the area ratio of the fit peak 1, the fit peak 2, and the fit peak 3 is equal to the existence ratio of the O—Mg—O bond, the O—Mg—F bond, and the F—Mg—F bond.

Note that in the analysis method of the XPS spectrum, for an energy value (Ep1) at the maximum value (also referred to as a peak top) of the fit peak 1, the energy value at the maximum value of the Mg1s peak separately measured using a standard sample of LiCoO₂ coated with MgO was referred to. For an energy value (Ep3) at the maximum value of the fit peak 3, the energy value at the maximum value of the Mg1s peak separately measured using a standard sample of magnesium fluoride (MgF₂) (MGH18XB with purity of 99.9% (3N) up by Kojundo Chemical Laboratory Co., Ltd.) was referred to. An energy value (Ep2) at the maximum value of the fit peak 2 was an intermediate value between Ep1 and Ep3. Note that the energy value at the maximum peak value is also referred to as a peak position.

On the XPS spectrum in the XPS analysis, the energy axis was corrected so that the maximum value of C1s peak was to be 284.8 eV.

TABLE 3

| | Heating | Mg1s analysis result | | |
|---|---|---|---|---|
| | time (h) | O—Mg—O | O—Mg—F | F—Mg—F |
| Sample 1 | 10 | 77.4% | 22.6% | 0.0% |
| Sample 2 | 120 | 100.0% | 0.0% | 0.0% |

As shown in Table 3, the XPS spectrum of Sample 1 was found to contain the peak component derived from an O—Mg—O bond and the peak component derived from an O—Mg—F bond. It was found that the XPS spectrum of Sample 2 contains the peak component derived from the O—Mg—O bond, but the peak component derived from the O—Mg—F bond is lower than the lower detection limit. Note that even an analysis result of 0.0% in the table does not indicates that corresponding bonds do not exist at all. That is, the bond whose analysis result is represented as 0.0% may exist although it is lower than the lower detection limit.

### <EPMA Analysis Results>

Next, quantification of additive elements in Sample 1 and Sample 2 was performed by EPMA. The measurement apparatus and conditions used in the EPMA were as follows.
Apparatus: JXA-iHP200F produced by JEOL Ltd.
Acceleration voltage: 10 kV
Beam diameter: approximately 3 μmϕ

The sample was embedded in a resin and processed to expose a cross section of the particle by an ion polishing method. In EPMA, the measurement region was set to the inner portion of the positive electrode active material, i.e., the center portion of the cross section of the particle. The cross section was analyzed by EPMA using the characteristic X-ray obtained from a region to a depth of approximately 1 μm from the surface of the analysis sample.

Table 4 shows the EPMA results.

TABLE 4

| | Heating | EPMA | | | | |
|---|---|---|---|---|---|---|
| | time (h) | C | O | Mg | Co | Mg/Co |
| Sample 1 | 10 | 2.7 at % | 65.1 at % | 0.4 at % | 31.8 at % | 0.01 |
| Sample 2 | 120 | 5.2 at % | 63.1 at % | 0.3 at % | 31.4 at % | 0.01 |

Table 4 shows the concentrations (atomic concentration: at %) of carbon (C), oxygen (O), magnesium (Mg), cobalt (Co), assuming that the total concentration of the elements is 100 at % and the ratio of the number of magnesium atoms to the number of cobalt atoms (Mg/Co). It was found that Mg/Co in each of Sample 1 and Sample 2 was 0.01 and magnesium formed a solid solution also in the inner portion of the positive electrode active material particle. There was no significant difference between Sample 1 and Sample 2 in EPMA.

### <STEM Analysis>

Cross-sectional STEM analysis was performed on Sample 1 and Sample 2.

As pretreatment before analysis, Sample 2 was sliced by an FIB method (μ-sampling method).

STEM and EDX were performed with the following apparatuses under the following conditions.

### <<STEM Observation>>

Transmission electron microscope: JEM-ARM200F NEOARM by JEOL Ltd.
Observation condition, acceleration voltage: 200 kV
Magnification accuracy: ±10%

### <<EDX>>

Analysis method: energy dispersive X-ray spectroscopy (EDX)
Transmission electron microscope: JEM-ARM200F NEOARM by JEOL Ltd.
Acceleration voltage: 200 kV
Measurement mode: STEM mode
Element analysis apparatus: JED-2300T
X-ray detector: Si drift detector
Energy resolution: approximately 140 eV
X-ray extraction angle: approximately 30.5°
Solid angle: 2.2 sr
Number of captured pixels: 256×256

### [STEM-EDX]

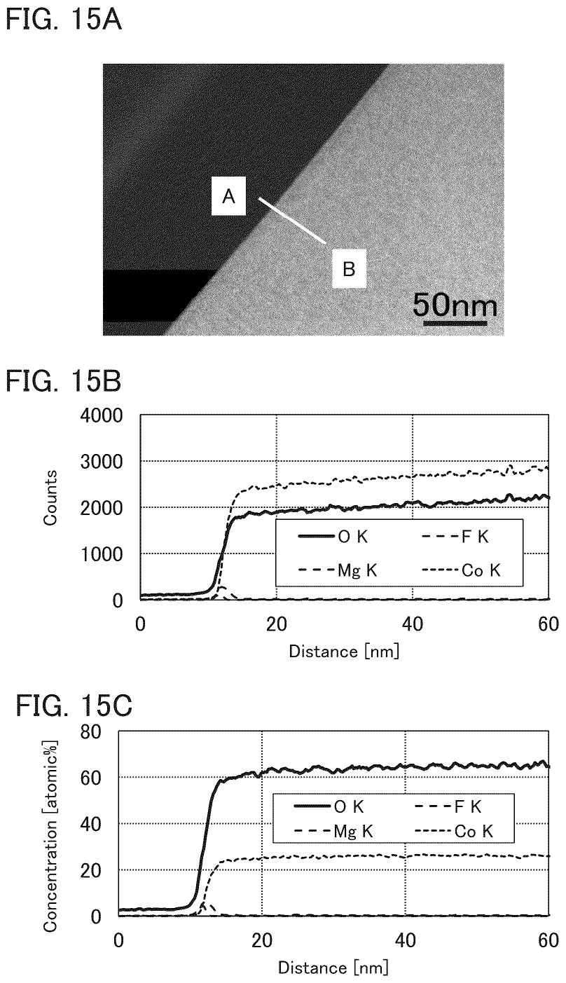

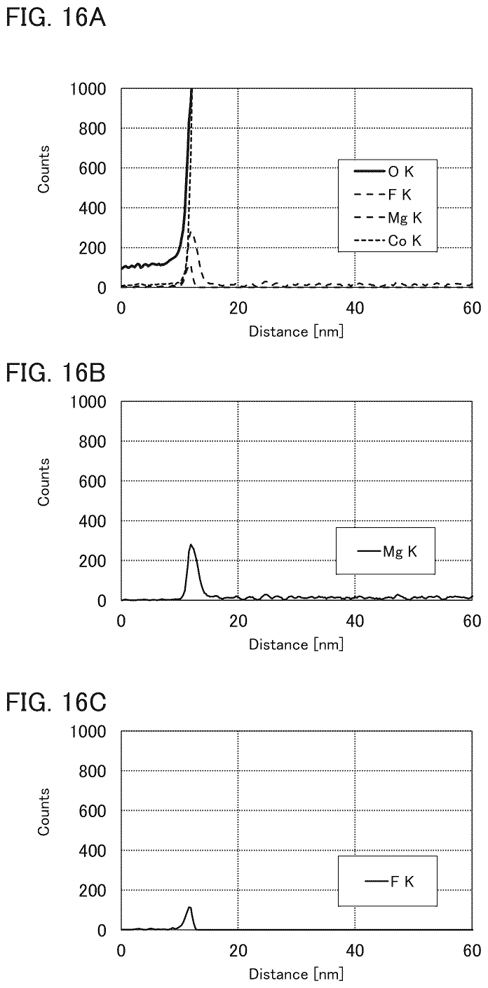

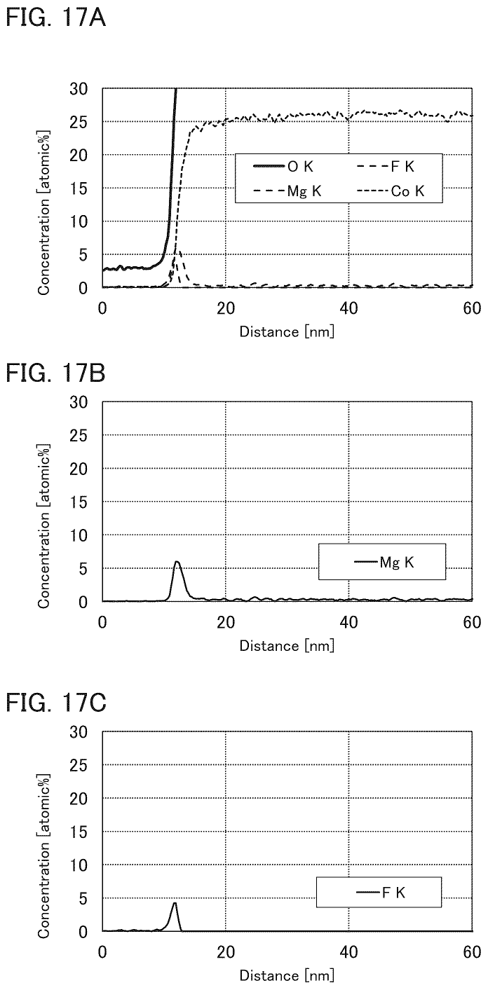

FIGS. 15A to 15C, FIGS. 16A to 16C. FIGS. 17A to 17C, FIGS. 18A to 18C, FIGS. 19A to 19C, FIGS. 20A to 20C show cross-sectional HAADF-STEM analysis results of Sample 1 and Sample 2.

FIG. 15A is a cross-sectional STEM image of Sample 1. FIG. 15B is a graph showing the STEM-EDX line analysis results along A-B in FIG. 15A with the vertical axis representing the count value of the characteristic X-ray. FIG. 15C is a graph with a vertical axis representing quantitative values as atomic % instead of the vertical axis in FIG. 15B. Note that the calculation of quantitative values as atomic % in STEM-EDX analysis are made assuming that the sum of the detected amounts of carbon, oxygen, fluorine, magnesium, aluminum, silicon, phosphorus, sulfur, calcium, titanium, iron, cobalt, nickel, and gallium is 100%.

FIG. 16A is a graph obtained by enlarging part of the vertical axis in FIG. 15B. FIG. 16B is a graph of magnesium (Mg K) extracted from FIG. 16A. FIG. 16C is a graph of fluorine (F K) extracted from FIG. 16A.

FIG. 17A is a graph obtained by enlarging part of the vertical axis in FIG. 15C. FIG. 17B is a graph of magnesium (Mg K) extracted from FIG. 17A. FIG. 17C is a graph of fluorine (F K) extracted from FIG. 17A.

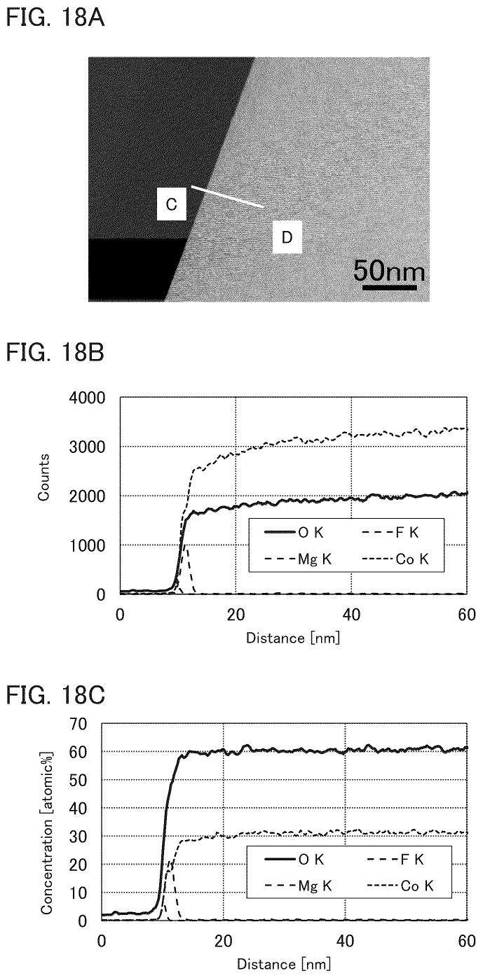

FIG. 18A is a cross-sectional STEM image of Sample 2. FIG. 18B is a graph showing the STEM-EDX line analysis results along C-D in FIG. 18A with the vertical axis representing the count value of the characteristic X-ray. FIG. 18C is a graph showing FIG. 18B with the vertical axis of the graph with the quantitative value of atomic %.

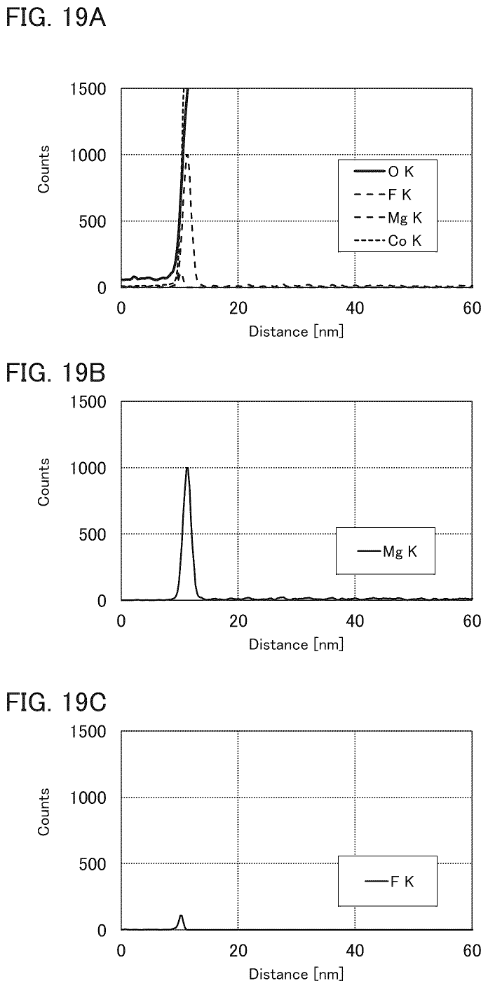

FIG. 19A is a graph obtained by enlarging part of the vertical axis in FIG. 18B. FIG. 19B is a graph of magnesium (Mg K) extracted from FIG. 19A, and FIG. 19C is a graph of fluorine (F K) extracted from FIG. 19A.

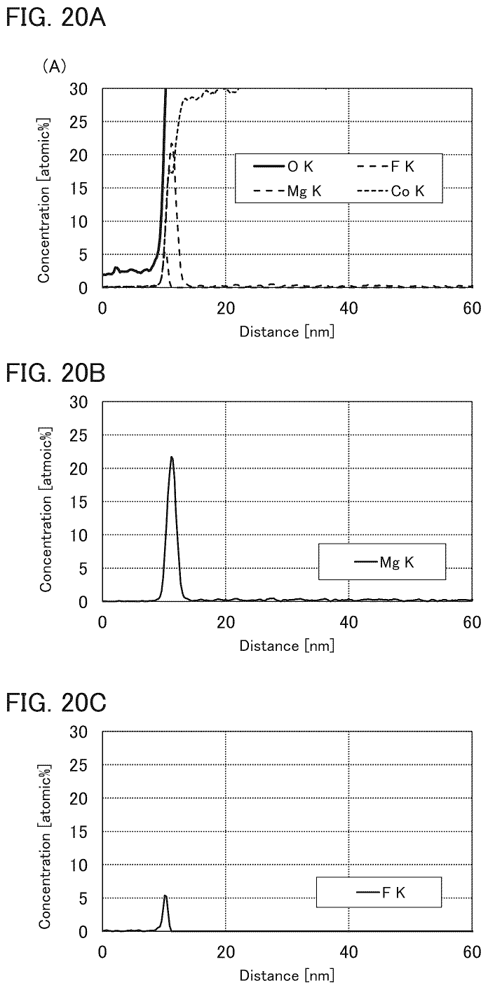

FIG. 20A is a graph obtained by enlarging part of the vertical axis in FIG. 18C. FIG. 20B is a graph of magnesium (Mg K) extracted from FIG. 20A. FIG. 20C is a graph of fluorine (F K) extracted from FIG. 20A.

As shown in FIGS. 19A to 19C and FIGS. 20A to 20C, the position of the maximum concentration and the peak position of the count value of fluorine were closer to the surface side than the position of the maximum concentration and the peak position of the count value of magnesium. In other words, the position of the maximum concentration and the peak position of the count value of magnesium were closer to the inner portion side than the position of the maximum concentration and the peak position of the count value of fluorine. Magnesium is a divalent cation and can be substituted for cobalt sites. It can also be said that fluorine exists closer to the surface side than a region where magnesium is substituted for part of the cobalt sites.

### [HAADF-STEM]

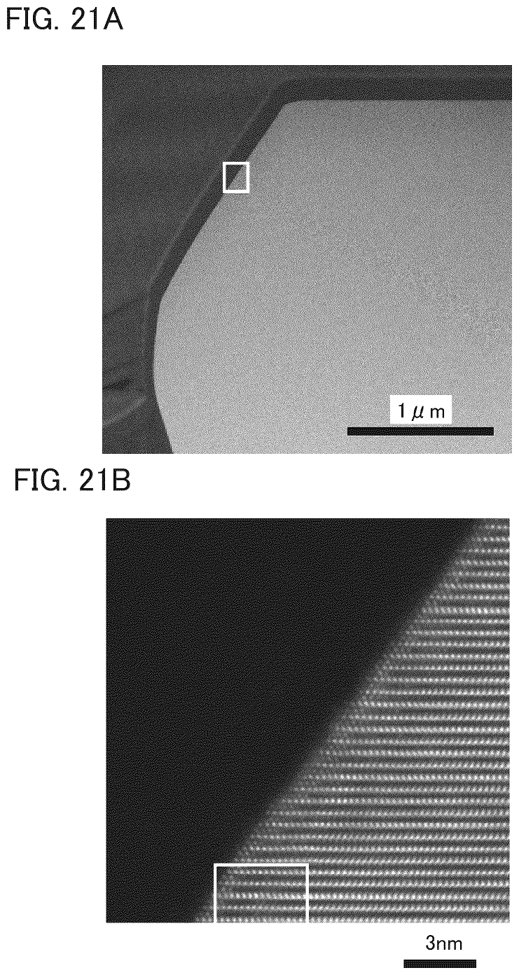

FIGS. 21A and 21B, FIGS. 22A and 22B, FIGS. 23A and 23B, and FIGS. 24A and 24B show the HAADF-STEM analysis results of Sample 1 and Sample 2.

FIG. 21A is a cross-sectional STEM image of Sample 1. FIG. 21B is a HAADF-STEM image of a region surrounded by a square in FIG. 21A. Note that the above-described region surrounded by the square includes the edge plane of Sample 1.

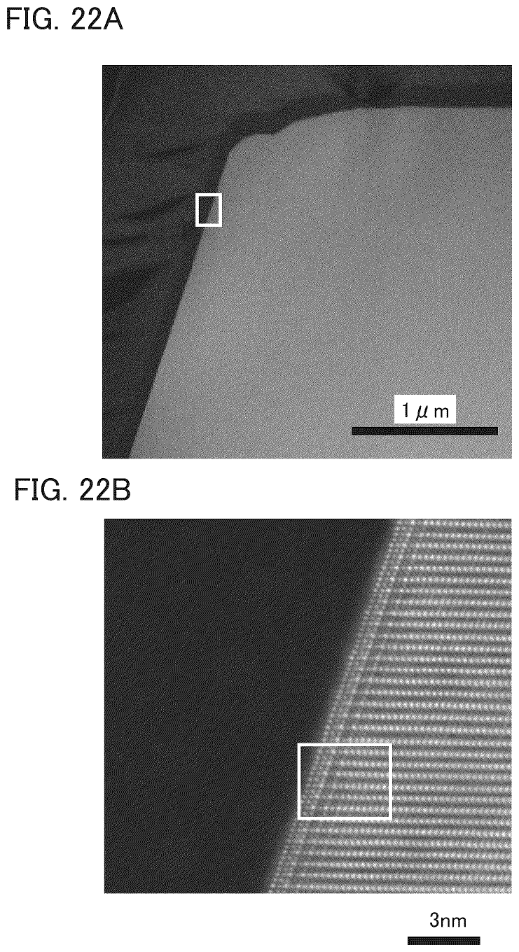

FIG. 22A is a cross-sectional STEM image of Sample 2. FIG. 22B is a HAADF-STEM image of a region surrounded by a square in FIG. 22A. Note that the above-described region surrounded by the square includes the edge plane of Sample 2.

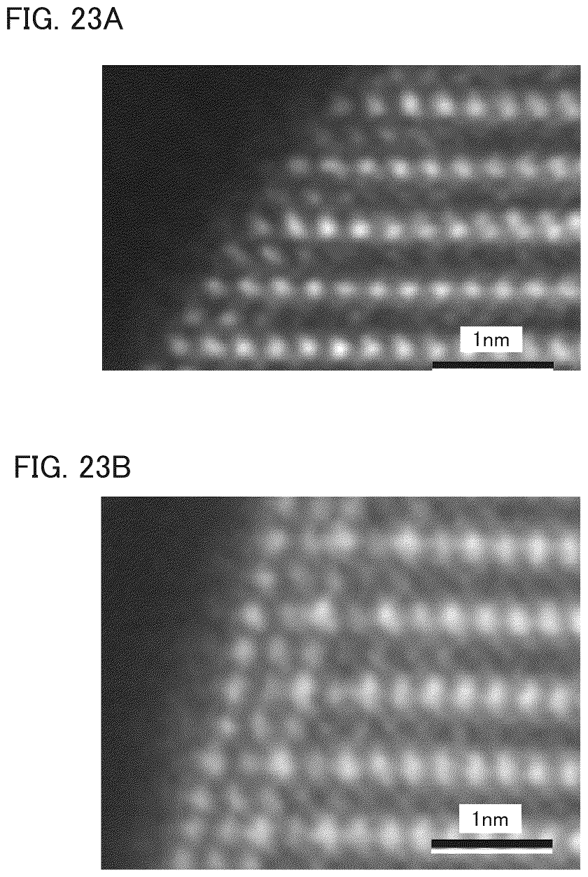

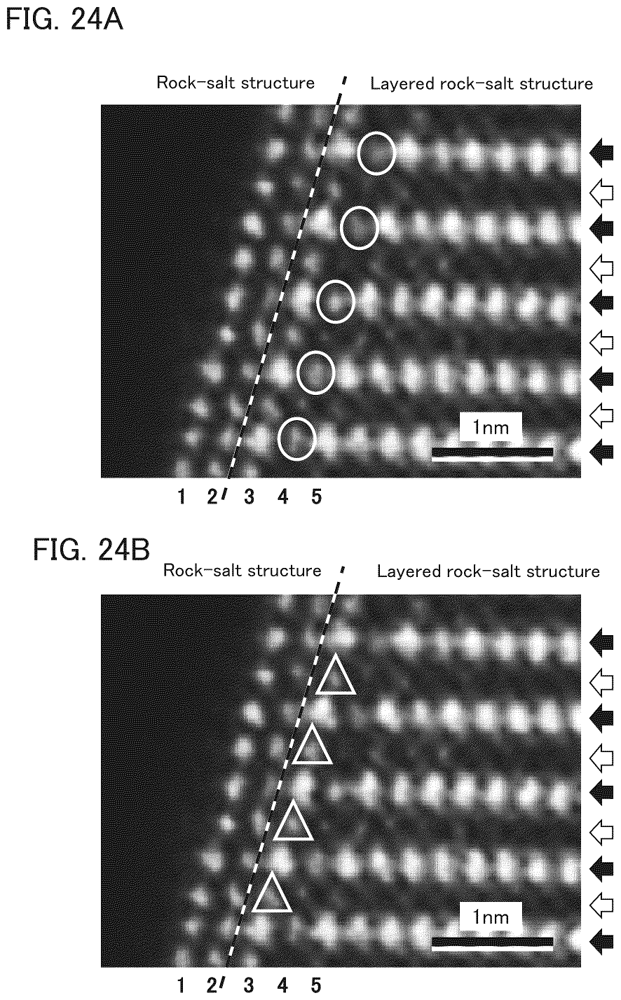

FIG. 23A is an enlarged image of the region surrounded by a square in FIG. 21B. FIG. 23B is an enlarged image of the region surrounded by a square in FIG. 22B. A significant difference was observed between the HAADF-STEM image of Sample 1 in FIG. 23A and the HAADF-STEM image of Sample 2 in FIG. 23B. This difference is described with reference to FIGS. 24A and 24B.

FIGS. 24A and 24B are images obtained by adjusting the brightness and contrast of the HAADF-STEM image of Sample 2 in FIG. 23B. A dashed line in the drawing is an auxiliary line drawn along a portion regarded as a boundary between portions having different crystal structures positioned on the left and right sides of the dashed line. It can be considered that the portion on the left side of the dashed line mainly has a rock-salt crystal structure (and can also be said that rock-salt crystal structures dispersively exist), and the portion on the right side thereof mainly has a layered rock-salt crystal structure. That is, it is presumed that the first layer and the second layer which are the closest to the outside mainly have a rock-salt crystal structure, and the third layer and subsequent layers which are close to the inner portion mainly have the layered rock-salt crystal structure. These layers are observed in the HAADF-STEM image. In FIGS. 24A and 24B, the first layer to the fifth layer are denoted by 1 to 5. The black arrow on the right side of the image indicates a portion considered to correspond to the Co sites of lithium cobalt oxide having the layered rock-salt crystal structure, and the white arrow on the right side of the image indicates a portion considered to correspond to the Li sites of lithium cobalt oxide having the layered rock-salt crystal structure.

Here, with a focus on the portion indicated by the white circle in FIG. 24A, it can be found that the luminance is low even though the portion corresponds to the Co site. From the STEM-EDX results in FIGS. 18A to 18C, FIGS. 19A to 19C, and FIGS. 20A to 20C, it can be found that in the surface portion of Sample 2, cobalt and magnesium are detected but another metal whose atomic number is close to that of magnesium is not detected. Accordingly, it can be considered that Mg whose atomic weight is smaller than that of Co exists in the Co site in the white circle position. Note that the white circle position, i.e., the position where Mg probably exists in the Co site, corresponds to the position of the fourth layer in the HAADF-STEM image of Sample 2.

Next, with a focus on the portion indicated by the white triangle in FIG. 24B, it can be found that the luminance is high at a position corresponding to the Li site. It is probably because an element having a larger atomic weight than Li exists in the Li site in the white triangle position. In consideration of the STEM-EDX results, it can be assumed that Mg or Co exists therein. The position where Mg or Co probably exists in the Li site was the third layer in the HAADF-STEM image of Sample 2.

### <Fabrication of Positive Electrode>

Sample 1 and Sample 2 described above, acetylene black (AB, Li-400 produced by Denka), and polyvinylidene fluoride (PVDF, GE51305 produced by Solvay) were prepared as a positive electrode active material, a conductive material, and a binding agent, respectively. The PVDF prepared was one dissolved in N-methyl-2-pyrrolidone (NMP) at a weight ratio of 5%. Then, the positive electrode active material, AB, and PVDF were mixed at a weight ratio of 95:3:2 to form a slurry, and the slurry was applied on an aluminum positive electrode current collector. As a solvent of the slurry, NMP was used. After the slurry was applied on the 20-μm-thick aluminum current collector, the solvent was volatilized in a circulation drying furnace at 80° C. for one hour.

After that, pressing was performed with a roller press machine to increase the density of a positive electrode active material layer over the positive electrode current collector. The pressing was performed with a linear pressure of 210 kN/m. Note that the temperature of each of an upper roll and a lower roll of the roller press machine was 120° C.

Through the above steps, the positive electrode was obtained. The loading amount of the positive electrode active material per area of the positive electrode was approximately 7 mg/cm². Through such a formation method, the positive electrode including Sample 1 and the positive electrode including Sample 2 were fabricated.

### <Fabrication of Half Cell>

Coin-type half cells (also referred to as coin cells) each including one of the above-described positive electrodes, lithium metal foil, a separator, an electrolyte solution, a coin cell positive electrode can, and a coin cell negative electrode can were fabricated. The shape of the coin-type half cell was CR2032 type (with a diameter of 20 mm and a height of 3.2 mm).

As the electrolyte solution, a solution obtained in the following manner was used: ethylene carbonate (EC) and diethyl carbonate (DEC) were mixed at a volume ratio of EC:DEC=3:7; 1 mol/L lithium hexafluorophosphate (LiPF₆) was dissolved in the mixed solution; and 2 wt % of vinylene carbonate (VC) was added thereto as an additive.

As the separator, a porous polypropylene film was used.

In this manner, a coin cell including Sample 1 and a coin cell including Sample 2 were fabricated.

### <Charge and Discharge Cycle Test>

A charge and discharge cycle test was performed on the above-described coin-type half cells.

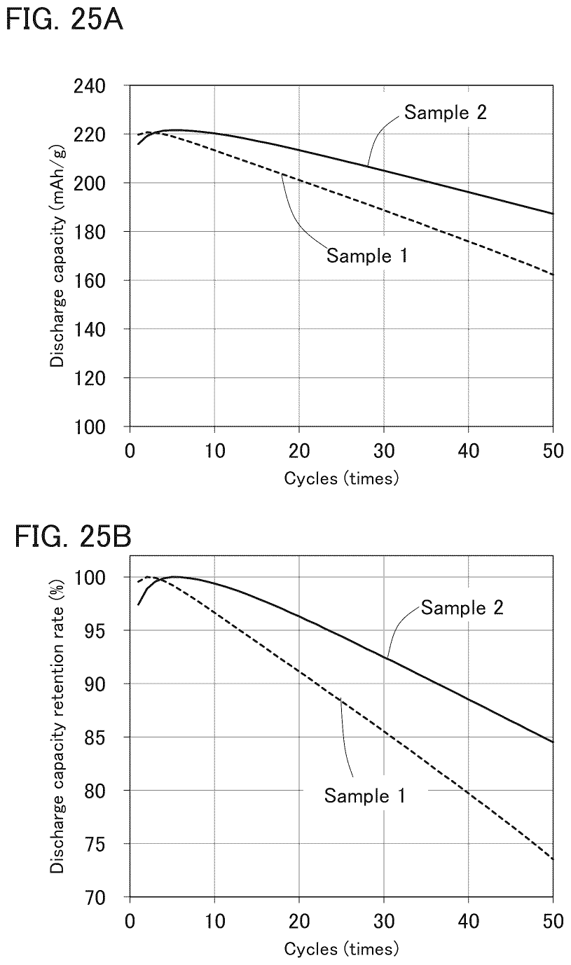

The conditions of the charge and discharge cycle tests were as follows. In the charging, constant current charging at 0.5 C was performed up to 4.60 V and then, constant voltage charging was performed until the current value reached 0.05 C. As the discharging, constant current discharging at 0.5 C was performed up to 2.50 V. Note that here, 1 C was set to 200 mA/g. The environmental temperature of the measurement was 25° C. The charge and discharge were repeated 50 times. FIGS. 25A and 25B show the results of the charge and discharge cycle test.

FIG. 25A is a graph showing the discharge capacities and the number of cycles of the half cell including Sample 1 (dashed line) and the half cell including Sample 2 (solid line). FIG. 25B is a graph showing the discharge capacity retention rate instead of the discharge capacity of FIG. 25A. Note that the discharge capacity retention rate was calculated on the assumption that the discharge capacity value at the time when the maximum discharge capacity was obtained in discharge in the charge and discharge cycle test is 100%.

The measurement results thereof are shown in Table 5. In Table 5, the maximum discharge capacities of Sample 1 and Sample 2 and the discharge capacities and the discharge capacity retention rates thereof in the 1st cycle, the 2nd cycle, the 5th cycle, the 10th cycle, the 20th cycle, the 25th cycle, the 30th cycle, the 40th cycle, and the 50th cycle are shown. Note that the discharge capacity is a value per weight of the positive electrode active material included in the half cell.

TABLE 5

| | | Sample 1 | | Sample 2 | |
|---|---|---|---|---|---|
| | | | Discharge | | Discharge |
| | | | capacity | | capacity |
| | | Discharge | retention | Discharge | retention |
| | | capacity | rate | capacity | rate |
| Maximum value | | 220.6 mAh/g | 100.0% | 221.5 mAh/g | 100.0% |
| 1st | cycle | 219.7 mAh/g | 99.6% | 215.8 mAh/g | 97.4% |
| 2nd | cycle | 220.6 mAh/g | 100.0% | 219.1 mAh/g | 98.9% |
| 5th | cycle | 219.0 mAh/g | 99.2% | 221.5 mAh/g | 100.0% |
| 10th | cycle | 213.3 mAh/g | 96.7% | 220.2 mAh/g | 99.4% |
| 20th | cycle | 201.1 mAh/g | 91.2% | 213.4 mAh/g | 96.3% |
| 25th | cycle | 194.9 mAh/g | 88.3% | 209.2 mAh/g | 94.4% |
| 30th | cycle | 188.7 mAh/g | 85.5% | 204.9 mAh/g | 92.5% |
| 40th | cycle | 175.9 mAh/g | 79.7% | 196.1 mAh/g | 88.5% |
| 50th | cycle | 162.2 mAh/g | 73.5% | 187.2 mAh/g | 84.5% |

As shown in FIG. 25A, FIG. 25B, and Table 5, the cycle performance of the half cell including Sample 2 was better than that of the half cell including Sample 1.

### <XRD Analysis in High-Voltage Charged State>

An experiment for examining crystal structures of Sample 1 and Sample 2 in a high-voltage charged state was conducted.

First, charge, discharge, disassembly of the half cells, and XRD measurement were performed with the half cell including Sample 1 and the half cell including Sample 2. The half cells were fabricated as described in <Fabrication of half cell> above except that the pressing was not performed. In the charging, constant current charging at 0.5 C was performed up to 4.60 V and then, constant voltage charging was performed until the current value reached 0.01 C. As the discharging, constant current discharging at 0.5 C was performed up to 2.5 V. Note that 1 C was set to 137 mA/g in the XRD analysis in the charged state. A 30-minute pause was given between charge and discharge and between discharge and charge.

Next, charging before the XRD analysis in a high-voltage charged state was performed. In the charging, constant current charging at 0.5 C was performed up to 4.60 V and then, constant voltage charging was performed until the current value reached 0.01 C. After that, a 30-minute pause was given.

After that, the half cell was disassembled within an hour after the above charge was ended. Specifically, the half cell in the charged state was disassembled carefully; the positive electrode was extracted as it is in the high-voltage charged state, by using an insulating tool to avoid a short circuit. For the disassembly, an argon-filled glove box in which the dew point and the oxygen concentration were controlled was used. Note that the dew point of the glove box is preferably lower than or equal to −70° C., and the oxygen concentration is preferably lower than or equal to 5 vol ppm. Since the crystal structure of the positive electrode active material might be changed after a long time elapses from the above charging, disassembly and analysis are preferably performed as early as possible.

The above-described positive electrode obtained by disassembling the half cell was bonded to a 0.7-mm-thick glass in the glove box and set to a sample holder for XRD measurement (Part No: A100B33 produced by Bruker Corporation) which is capable of making inside thereof hermetic, whereby the positive electrode which was hermetically sealed with argon on the XRD measurement stage was obtained.

After that, the XRD measurement was started within 15 minutes. The XRD apparatus and conditions are as follows.
XRD apparatus: D8 ADVANCE by Bruker AXS
X-ray: Cu Kα₁ radiation
Output: 40 kV, 40 mA
Divergence slit: 0.6 mm
Detector: LYNXEYE XE-T
Scanning method: 2θ/θ continuous scan
Measurement range (2θ): from 15° to 75°
Step width (2θ): 0.01°
Counting time: one sec/step
Rotation of sample stage: 15 rpm

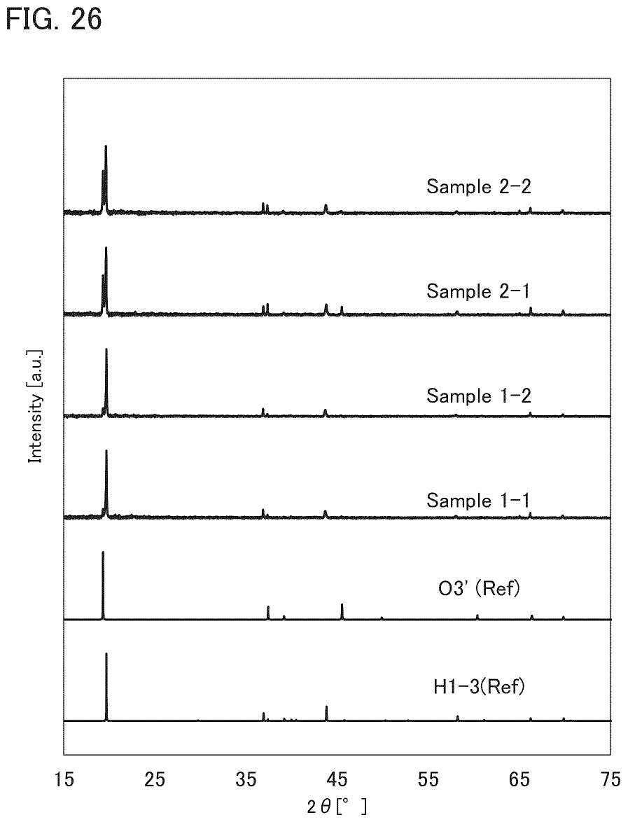

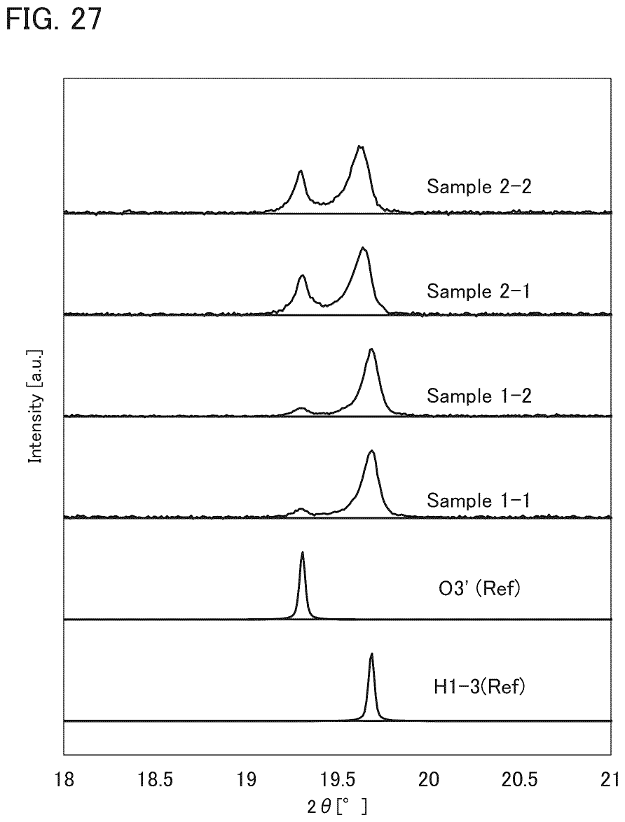

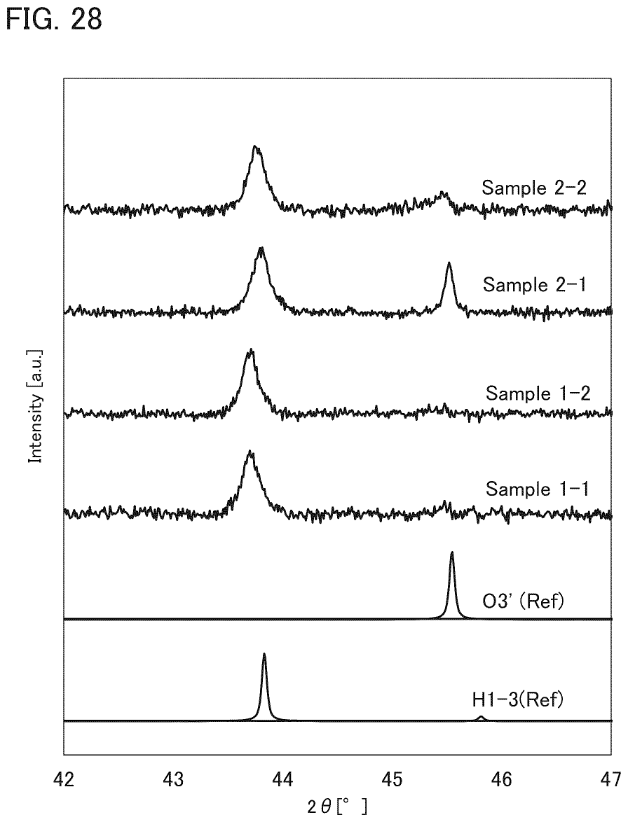

FIG. 26, FIG. 27, and FIG. 28 show XRD patterns obtained from the above XRD measurement data of the positive electrodes (Sample 1 and Sample 2) in the high-voltage charged state by removing the peak derived from CuKα₂ and the background derived from the sample holder under the following conditions with the use of a data analysis tool DIFFRAC. EVA.

### <<Kα₂ Removal Condition>>

Maximum: 1
Intensity ratio: 0.5
Minimum: 0

### <<Background Removal Condition>>

Curvature: 25
Threshold: 0.001

In these graphs, a reference pattern of the O3′ structure (O3′) and a reference pattern of the H1-3 structure (H1-3) are also shown. Since the measurement above was performed using two half cells for each sample, the measurement data of Sample 1 are denoted by Sample 1-1 and Sample 1-2, and the measurement data of Sample 2 are denoted by Sample 2-1 and Sample 2-2.

FIG. 27 shows the range where 2θ is greater than or equal to 18° and less than or equal to 21° in the XRD measurement. FIG. 28 shows the range where 2θ is greater than or equal to 42° and less than or equal to 47°.

As shown in FIG. 26 to FIG. 28, peaks corresponding to that of the reference pattern of the O3′ structure (O3′) were hardly observed in Sample 1 in a high-voltage charged state. Meanwhile, peaks corresponding to that of the reference pattern of the O3′ structure (O3′) was clearly observed in Sample 2 in a high-voltage charged state.

This application is based on Japanese Patent Application Serial No. 2024-101530 filed with Japan Patent Office on Jun. 24, 2024 and Japanese Patent Application Serial No. 2024-101531 filed with Japan Patent Office on Jun. 24, 2024, the entire contents of which are hereby incorporated by reference.

What is claimed is:

1. A lithium-ion secondary battery comprising:
a positive electrode; and
a negative electrode,
wherein the positive electrode comprises a positive electrode active material particle comprising magnesium, fluorine, and lithium cobalt oxide, and
wherein when a surface of the positive electrode active material particle observed in a cross-sectional STEM image of a plane where lithium is inserted and extracted is a first layer, the positive electrode active material particle comprises a region where magnesium is substituted for part of cobalt sites in a second layer, a third layer, a fourth layer, a fifth layer, and a sixth layer of the positive electrode active material particle, and
wherein the fluorine exists closer to the surface than the region does.

2. The lithium-ion secondary battery according to claim 1,
wherein the positive electrode active material particle comprises a region where part of the cobalt sites in the fourth layer observed in the cross-sectional STEM image of the plane where lithium is inserted and extracted is substituted with magnesium.

3. The lithium-ion secondary battery according to claim 1,
wherein, in STEM-EDX line analysis on a surface portion of the positive electrode active material particle, a position of a maximum concentration (atomic %) of magnesium is closer to an inner portion than a position of a maximum concentration (atomic %) of fluorine is.

4. The lithium-ion secondary battery according to claim 1,
wherein an atomic ratio of magnesium to cobalt (Mg/Co) in an inner portion is greater than or equal to 0.01 in electron probe microanalysis of the positive electrode active material particle.

5. A lithium-ion secondary battery comprising:
a positive electrode; and
a negative electrode,
wherein the positive electrode comprises a positive electrode active material particle comprising magnesium, fluorine, aluminum, nickel, and lithium cobalt oxide,
wherein the positive electrode active material particle comprises a layered rock-salt crystal structure in an inner portion and comprises a rock-salt crystal structure in a surface portion, and
wherein when a surface of the positive electrode active material particle observed in a cross-sectional STEM image of a plane where lithium is inserted and extracted is a first layer, the positive electrode active material particle comprises a region where magnesium is substituted for part of cobalt sites in a second layer, a third layer, a fourth layer, a fifth layer, and a sixth layer of the positive electrode active material particle, and
wherein the fluorine exists closer to the surface than the region does,
wherein the aluminum exists in the inner portion of the positive electrode active material particle, and
wherein the nickel exists in the surface portion of the positive electrode active material particle.

6. The lithium-ion secondary battery according to claim 5,
wherein the positive electrode active material particle comprises a region where part of the cobalt sites in the fourth layer observed in the cross-sectional STEM image of the plane where lithium is inserted and extracted is substituted with magnesium.

7. The lithium-ion secondary battery according to claim 5,
wherein, in STEM-EDX line analysis on a surface portion of the positive electrode active material particle, a position of a maximum concentration (atomic %) of magnesium is closer to an inner portion than a position of a maximum concentration (atomic %) of fluorine is.

8. The lithium-ion secondary battery according to claim 5,
wherein an atomic ratio of magnesium to cobalt (Mg/Co) in an inner portion is greater than or equal to 0.01 in electron probe microanalysis of the positive electrode active material particle.

9. A method for forming a positive electrode active material particle, the method comprising:
mixing lithium cobalt oxide, a magnesium source, a fluorine source, and a lithium source to form a mixture; and
heating the mixture at higher than or equal to 650° C. and lower than or equal to 950° C. for longer than 100 hours.

10. The method for forming a positive electrode active material particle according to claim 9,
wherein the heating is performed at higher than or equal to 826° C. and lower than or equal to 920° C. for longer than 100 hours and shorter than or equal to 150 hours.
